(19) United States
(12) Patent Application Publication
(10) Pub. No.: US 2021/0185066 A1
(43) Pub. Date: Jun. 17, 2021

(54) DETECTING ANOMALOUS APPLICATION MESSAGES IN TELECOMMUNICATION NETWORKS

(71) Applicant: SPHERICAL DEFENCE LABS LIMITED, London (GB)

(72) Inventors: Dishant Shah, London (GB); Jack Hopkins, Somerset (GB); Akbir Khan, London (GB); Javid Lakha, London (GB)

(73) Assignee: SPHERICAL DEFENCE LABS LIMITED, London (GB)

(21) Appl. No.: 16/647,166

(22) PCT Filed: Sep. 14, 2018
(86) PCT No.: PCT/EP2018/074976

§ 371 Date: Mar. 13, 2020

(30) Foreign Application Priority Data
Sep. 15, 2017 (GB) 1714917.0

(51) Int. Cl. H04L 29/06; G06K 9/62; G06F 16/901; G06N 3/04; G06N 3/08

(52) U.S. Cl. CPC H04L 63/1425; H04L 63/168; G06N 3/08; G06F 16/9024; G06N 3/0445; G06K 9/6215

(57) ABSTRACT

Method(s) and apparatus are provided for detecting anomalous application message sequences in an application communication session between a user device and a network node. The application communication session associated with an application executing on the user device. This involves receiving an application message sent between the user device and the network node, where the received application message is associated with a received application message sequence comprising application messages that have been received so far. An estimate of the next application message to be received is generated using traffic analysis based on techniques in the field of deep learning on the received application message sequence. The estimated next application message forms part of a predicted application message sequence. The received application message sequence is classified as normal or anomalous based the received application message sequence and a corresponding predicted application message sequence. An indication of an anomalous received application message sequence is sent in response to classifying the received application message sequence as anomalous.

The present application relates to a system, apparatus and method of detecting anomalous application messages in telecommunication networks.

### BACKGROUND

When applications that are accessed through web browsers (henceforth known as web applications), Hypertext Transfer Protocol (HTTP) requests and responses are the only interface between the user and the underlying business logic. The semantics of an incoming request are highly dependent on both the current state of the application and the design of an application itself. In effect, an application communication session is created by the application between a device and a node in the network (e.g. the Internet) in which application messages are passed between the device and the node. In many cases, vulnerabilities are introduced into web applications through poor design and configuration, and can be exploited by an attacker solely through tailored HTTP requests. It is estimated that a large majority of all cyber attacks are a result of these vulnerabilities, and that as many as two thirds of all web applications contain these vulnerabilities.

Current approaches to web application protection apply Web Application Firewalls (WAFs), which are systems that filter incoming HTTP traffic based on predefined rules. These rules are curated from commonly known threats and attack vectors. A WAF exists in between the application and the Internet, and all HTTP traffic going to the application passes through it. Incoming requests are cross-referenced against the curated ruleset, and are blocked if they match any rule within a ruleset. This is known as a blacklist approach, a technique commonly used when creating security systems. However, such a technique is inherently reactive, requiring constant curation to remain effective. This essentially creates an “arms race” between attackers and rule based security systems.

Although web applications using HTTP traffic are described, this is by way of example only, and it is to be appreciated by the skilled person that any application that generates application traffic at the application layer level that is sent between a device and a node in a network (e.g. the Internet) during an application communication session may be vulnerable to such attacks. There is a desire to improve upon the inefficiencies and ineffectiveness of WAF or any other rule-based security system for more efficiently and effectively protecting users of applications against such attacks.

The embodiments described below are not limited to implementations which solve any or all of the disadvantages of the known approaches described above.

### SUMMARY

This Summary is provided to introduce a selection of concepts in a simplified form that are further described below in the Detailed Description. This Summary is not intended to identify key features or essential features of the claimed subject matter, nor is it intended to be used to determine the scope of the claimed subject matter.

The present disclosure provides a way for a detection system or method to determine whether an application communication session associated with an application executing on a user device has been maliciously modified or intruded upon by intercepting and analysing the application messages sent between the user device and a network node. The system or method determines whether an intercepted application message is malicious or anomalous based on predicting subsequent application messages expected to be received and whether the predicted sequence of messages tallies or are close enough to the actual messages received. If not, then an anomalous application message is determined to have been received. Depending on the closeness of the predicted messages to the actual messages or severity of the difference therebetween, the system or method takes measures to prevent the detected anomalous message from substantially harming or affecting the application communication session, user device, network node, execution of the application at the user device and/or execution of the corresponding reciprocal application at the network node.

In a first aspect, the present disclosure provides a computer implemented method for detecting an anomalous application message sequence in an application communication session between a user device and a network node, the application communication session associated with an application executing on the user device, the method comprising: receiving an application message sent between the user device and the network node, wherein the received application message is associated with a received application message sequence comprising application messages that have been received so far; generating an estimate of the next application message to be received using traffic analysis based on techniques in the field of deep learning on the received application message sequence, wherein the estimated next application message forms part of a predicted application message sequence; classifying the received application message sequence as normal or anomalous based the received application message sequence and a corresponding predicted application message sequence; and sending an indication of an anomalous received application message sequence in response to classifying the received application message sequence as anomalous.

As an option, generating the estimate of the next application message expected to be received further comprises: converting the received application message to a received application message vector, wherein the received application message vector represents the information content of the received application message; and processing the received application message vector to estimate the next application message expected to be received during the application communication session using a neural network for estimating the next application message and trained on a set of application message sequences associated with normal operation of the application, wherein the estimated next application message expected to be received is represented as a prediction application message vector.

As an option, converting the received application message to a received application message vector further comprises generating the received application message vector as a lower dimensional representation or an informationally dense representation of the received application message based on using neural network techniques and a tree graph representation of the received application message.

As another option, each application message comprises a textual representation, the method further comprising: encoding and compressing the textual representation into a plurality of symbols; and embedding the plurality of symbols of the application message as an application message vector in a vector space of real values. Optionally, each application message comprises a textual representation of one or more reserved words and data fields, each reserved word associated with one of the data fields in the application message, the converting further comprising: encoding and compressing the reserved words and associated data fields of the application message into symbols corresponding to key value pairs; and embedding the application message as a message vector based on the key value pairs associated with the application message.

As an option, the reserved words are associated with a set of globally unique labels, each unique label corresponding to a reserved word, the encoding further comprising: forming symbols corresponding to key value pairs by mapping each reserved word to a corresponding unique label to form a key for a key value pair; and compressing each of the data fields associated with each reserved word to form a key value associated with the key for the key value pair.

As another option, the converting or embedding further comprising generating an application message vector associated with the application message by passing symbol data representative of the encoded and compressed application message through a neural network for embedding an application message as a message vector, the neural network for embedding having been trained to embed a set of application messages into corresponding application message vectors, wherein the neural network outputs an application message vector representing the informational content of the received application message.

Optionally, the neural network for embedding an application message as an application message vector is based on a skip gram model, wherein the neural network maintains a message matrix and a field matrix, wherein each column of the message matrix represents an application message vector associated with an application message and each column of the field matrix represents a field vector associated with the plurality of symbols associated application messages. As an option, the neural network for embedding an application message as an application message vector comprises a feed-forward neural network structure.

Optionally, the embedding further comprises generating a message vector associated with the application message by passing the symbol data representative of the application message through a neural network comprising an encoding and decoding neural network structure with corresponding weights trained to embed a set of application messages as application message vectors, and wherein the encoding neural network structure processes the symbol data associated with the application message to output an application message vector representing the informational content of the received application message.

Optionally, converting the received application message to a received application message vector further comprises: generating a tree graph associated with the application message; encoding and embedding the tree graph as a message vector associated with the application message by passing data representative of the tree graph through a neural network comprising an encoding and decoding neural network structure with corresponding weights trained to embed a set of application messages as application message vectors, and wherein the encoding neural network structure processes the tree graph associated with the application message to output an application message vector representing the informational content of the received application message. As an option, the neural network for embedding an application message as an application message vector comprises a variational autoencoder neural network structure.

As an option, the variational autoencoder neural network structure includes an encoding neural network structure and a decoding neural network structure, where: the encoding neural network structure is trained and configured to generate an N-dimensional vector by parsing the tree graph associated with the application message by accumulating one or more context vectors associated with nodes of the tree graph, wherein a context vector for a parent node of the tree graph is based on values representative of information content of the parent's child node(s); and the decoding neural network structure is trained and configured to generate a tree graph based on an N-dimensional vector associated with the application message in a recursive approach based on generating nodes of the tree graph and context information from the N-dimensional vector for each of the generated nodes of the tree graph based on modelling relationships between parent nodes and child node(s) and relationships between child node(s) of the same parent node of the tree graph.

Optionally, generating the nodes of the tree graph further includes terminating node generation for a portion of the tree graph based on calculating the probability of no further nodes being generate for the portion of tree graph. As an option, the generated tree graph is input to a sequence Long Short Term Memory (LSTM) neural network decoder configured for predicting the content of each node of the generated tree graph as a portion of information or sequence of characters associated with the application message.

As another option, the decoding neural network structure is force trained.

As an option, the neural network for estimating the next application message expected to be received further comprises a recurrent neural network structure, the method step of processing the received application message vector based on the neural network for estimating the next application message expected to be received further comprising: inputting the received application message vector associated with the received application message to the recurrent neural network, wherein the application message vector represents an embedding of the received application message; and outputting from the recurrent neural network an estimate of the next application comprising a prediction vector representing an embedding of the estimated next application message expected to be received.

As another option, classifying the received application message sequence as normal or anomalous based the received application message sequence and corresponding application messages of the predicted application message sequence further comprises: calculating an error vector associated with the similarity between the received application message sequence and corresponding predicted application message sequence; determining the error vector to be either normal or anomalous based on a classifier trained and adapted on a training set of error vectors for labelling an error vector as normal or abnormal.

As a further option, determining whether the received application message sequence is anomalous further comprises determining whether the error vector corresponding to the received application message sequence is within an error region, the error region having being defined based on a set of error vectors determined from training the neural network for estimating the next application message with a training set of application message sequences. As another option, the error region defines an error threshold surface in the vector space associated with the error vectors, the threshold surface for separating error vectors determined to be normal error vectors and error vectors determined to be abnormal error vectors.

Optionally, the training set of error vectors is based on a training set of application message vectors associated with a set of application message sequences and corresponding prediction application message vectors, wherein the training set of application messages vector sequences are labelled as normal, and the classifier is based on a one-class support vector machine that defines the error region to separate error vectors labelled as normal and error vectors labelled a anomalous.

As an option, the training set of error vectors is based on a training set of application message vectors associated with a set of application message sequences and corresponding prediction application message vectors, wherein the training set of application messages vector sequences includes a first set of application message vector sequences that are labelled as normal and a second set of application message vector sequences that are labelled as anomalous, and the classifier is based on a two-class support vector machine that defines the error region to separate error vectors labelled as normal and error vectors labelled a anomalous.

Optionally, classifying the received application message sequence as normal or anomalous further comprises: generating an error vector representing the similarity between a first and a second sequence of application message vectors associated with a received application message sequence and a corresponding sequence of prediction vectors associated with the predicted application message sequence, wherein each application message vector is an embedding of the corresponding application message and each prediction application message vector is an embedding of the corresponding predicted application message; and determining whether the received application message sequence is an anomalous application message sequence based on the error vector.

As an option, storing each prediction vector as part of a sequence of prediction application message vectors associated with the application message sequence received so far in the application communications session; storing each application message vector as part of a sequence of application message vectors associated with the application message sequence received so far in the application communications session; and generating the error vector further comprises calculating the error vector based on a similarity function between a sequence of stored application message vectors and a corresponding sequence of stored prediction application message vectors.

Optionally, the application message vector is the i-th application message vector xᵢ in a sequence of application message vectors denoted (xₖ) for 1<=k<=i, the prediction application message vector is the (i+1)-th prediction application message vector pᵢ₊₁ in a sequence of prediction application message vectors (pₖ₊₁) for 1<=k<=i and the error vector associated with the j-th sequence of application message vectors and corresponding prediction application message vectors is denoted eᵢ, wherein the step of generating the error vector further comprises calculating the error vector based on eᵢ={eₖ=similarity (pᵢ₋ₖ₋₁,xᵢ₋ₖ₋₁)}ₖ₌₁^{D}, 1<=D<=i where similarity(pᵢ, xᵢ), is a similarity function representing the similarity between vector pᵢ and xᵢ and 1<=D<=i representing the D most recent message vectors of a D sized sliding window on the application message vector sequence.

As an option, the similarity comprises at least one similarity function from the group of: a similarity function including a Log-Euclidean distance; a similarity function including a cosine similarity function; and any other real-valued function that quantifies the similarity between an application message vector sequence and a corresponding prediction application message vector sequence.

Optionally, generating the error vector further comprises: calculating a first error vector based on the difference between the received application message vector and a previous prediction application message vector estimating the received application message that corresponds with the received application message vector; and calculating the error vector for the received application message sequence by combining a previous error vector corresponding to the received application message sequence excluding the received application message and the calculated first error vector.

As an option, the error vector is an error vector in an L-dimensional vector space, wherein L is less than or equal to the length of the received application message sequence. As another option, the error vector and the application message vector are vectors in an N-dimensional vector space, where N>>1. Optionally, the application messages received during the application communication session between the user device and the network node are application messages based on an application layer protocol. As an option, the application layer protocol is based on one or more from the group of: Hypertext Transfer Protocol (HTTP); Simple Mail Transfer Protocol (SMTP); File Transfer Protocol (FTP); Domain Name System Protocol (DNS); any application-layer protocol and/or messaging structure that can be described by a domain specific language that convey application message semantics through a specific syntax; and/or any other suitable application level communication protocol used by the application and reciprocal application for communicating between user device and network node. As an option, an application message includes an application request message or an application response message based on an application layer protocol.

Optionally, the user device and network node exchange application messages during the application communication session, when each application message sequence comprises a sequence of one or more application messages communicated between a user device and a node in the network during the application communication session, wherein each application message sequence comprises one or more from the group of: an application message sequence comprising one or more application request messages sent from the user device to the network node; an application message sequence comprising one or more application response messages sent from the network node to the user device; an application message sequence comprising a sequence of one or more application request messages and one or more application response messages exchanged between the user device and network node; an application message sequence comprising a sequence of alternating application request messages and corresponding application response messages exchanged between the user device and network node; and an application message sequence comprising any other sequence of application request messages and/or application response messages.

As an option, each received application message is embedded as an application message vector in an N-dimensional vector space of real values, where N is greater than 1 or, for example, N>>1.

As an option, the method where the application message vector is a dense low-dimensional representation of the information content of the application message.

In a second aspect of the invention, the present disclosure provides an apparatus for detection of anomalous application message sequences associated with a user device communicating with a network node in an application communication session, the apparatus comprising a processor, a communication interface, and a storage unit, the processor coupled to the communication interface and the storage unit, wherein the storage unit comprises instructions stored thereon, which when executed on the processor unit, causes the apparatus to perform one or more computer implemented methods and/or process(es) according to the first, fifth, sixth and/or seventh aspects, combinations thereof, modifications thereof, and/or as herein described.

In a third aspect, the present disclosure provides an apparatus for detection of anomalous application message sequences associated with a user device communicating with a network node in an application communication session, the apparatus comprising a processor, a communication interface, and a storage unit, the processor coupled to the communication interface and the storage unit, wherein: the communication interface is configured to receive an application message sent between the user device and the network node, wherein the received application message forms part of a received application message sequence comprising application messages that have been received so far; the processor and storage unit are configured to: generate an estimate of the next application message to be received using traffic analysis based on techniques in the field of deep learning on the received application message sequence, wherein the estimated next application message forms part of a predicted application message sequence; and classify the received application message sequence as normal or anomalous based the received application message sequence and corresponding application messages of the predicted application message sequence; and the communication interface is further configured to send an indication of an anomalous received application message sequence in response to classifying the received application message sequence as anomalous.

In a fourth aspect, the present disclosure provides an apparatus for detection of anomalous application message sequences associated with a user device communicating with a network node in an application communication session, the apparatus comprising a processor, a communication interface, and a storage unit, the processor coupled to the communication interface and the storage unit, wherein: the communication interface is configured to receive an application message sent from the user device during the application communication session, wherein the received application message is associated with a sequence of received application messages sent during the application communication session; the processor and storage unit are configured to: convert the received application message to a current message vector, wherein the current message vector represents the information content of the received application message; predict the next application message expected to be received in the application message sequence based on the current message vector and a neural network trained on a set of application message sequences associated with the application, wherein the predicted next application message expected to be received is represented as a prediction vector; generate an error vector representing the similarity between a sequence of message vectors associated with the received application message sequence and a corresponding sequence of prediction vectors; determine whether the received application message sequence is an anomalous application message sequence based on the error vector; and the communication interface further configured to send an indication of an anomalous received application message sequence in response to determining the received application message sequence is anomalous.

In a fifth aspect, the present disclosure provides a computer implemented method for detecting an anomalous application message sequence associated with an application executing an application communication session between a client device and a node in a network, the method comprising: receiving an application message sent from the client device during the application communication session, wherein the received application message is associated with a sequence of received application messages; converting the received application message to a current message vector, wherein the current message vector represents the information content of the received application message; predicting the next application message expected to be received in the application message sequence based on the current message vector and a neural network trained on a set of application message sequences associated with the application, wherein the predicted next application message expected to be received is represented as a prediction vector; generating an error vector representing the similarity between a sequence of message vectors associated with the received application message sequence and a corresponding sequence of prediction vectors; determining whether the received application message sequence is an anomalous application message sequence based on the error vector; and sending an indication of an anomalous received application message sequence in response to determining the received application message sequence is anomalous.

In a sixth aspect, the present disclosure provides a computer implemented method for detecting anomalous application messages sent between a user device and a network node, the method comprising: receiving an application message associated with a sequence of application messages sent between the user device and the network node; encoding and embedding the received application message as an application message vector in a vector space of real values, the application message vector representing the informational content of the received application message; calculating a prediction application message vector representing the next application message expected to be received in the sequence of application messages based on the application message vector; determining an error vector between a sequence of application message vectors associated with a sequence of received application messages and a corresponding sequence of prediction application message vectors; and classifying the error vector as anomalous or normal based on a threshold surface separating error vectors labelled as normal and anomalous from each other.

In a seventh aspect, the present disclosure provides a method for detecting anomalous application messages sent between a user device and a network node, the method comprising: receiving a plurality of application messages in a sequence of application messages sent between the user device and the network node; embedding the received application messages as application message vectors; predicting the next application message in the sequence of application messages to be received for forming a sequence of predicted application messages; determining an error vector between the predicted sequence of application messages and received sequence of application messages; and classifying the error vector as anomalous or normal based on a threshold surface separating error vectors labelled as normal error vectors.

In a eighth aspect, the present disclosure provides a network node comprising a memory unit, a processor unit, a communication interface, the processor unit coupled to the memory unit, and the communication interface, wherein the memory unit comprises instructions stored thereon, which when executed on the processor unit, causes the network node to perform a computer implemented method(s) and/or process(es) as disclosed herein.

In a ninth aspect, the present disclosure provides a system comprising a plurality of user devices and a plurality of network nodes in communication with the plurality of user devices, wherein a network node of the plurality of network nodes comprises an intrusion detection apparatus according to the second, third, fourth and/or eighth aspects of the invention, combinations thereof, modifications thereof, and/or as described herein and/or an intrusion detection apparatus configured for implementing one or more of the method(s) and/or process(es) according to the first, fifth, sixth and/or seventh aspects, combinations thereof, modifications thereof, and/or as herein described.

The methods and/or processes described herein may be performed by software in machine readable form on a tangible storage medium or tangible computer readable medium e.g. in the form of a computer program comprising computer program code means adapted to perform all the steps of any of the methods described herein when the program is run on a computer and where the computer program may be embodied on a computer readable medium. Examples of tangible (or non-transitory) storage media include disks, thumb drives, memory cards etc. and do not include propagated signals. The software can be suitable for execution on a parallel processor or a serial processor such that the method steps may be carried out in any suitable order, or simultaneously.

This application acknowledges that firmware and software can be valuable, separately tradable commodities. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

The preferred features may be combined as appropriate, as would be apparent to a skilled person, and may be combined with any of the aspects of the invention.

### BRIEF DESCRIPTION OF THE DRAWINGS

Embodiments of the invention will be described, by way of example, with reference to the following drawings, in which:

FIG. 1a is an schematic diagram of a telecommunications network;

FIGS. 1b-1d are schematic diagrams illustrating examples of where detection mechanisms according to the present invention may be implemented in the telecommunications network of FIG. 1a;

FIG. 2a is an flow diagram illustrating a method of detecting anomalous application messages in a telecommunications network according to the invention;

FIG. 2b is an schematic diagram illustrating an apparatus for implementing the method of FIG. 2a;

FIG. 3 is a diagram illustrating an example application message in the form of an HTTP 1.1 application message;

FIG. 4a is a schematic diagram illustrating an example modified Skip-Gram model according to the invention;

FIGS. 4b and 4c is a flow diagram illustrating an example process for generating a set of training application message vectors based on the modified Skip-Gram model of FIG. 4a;

FIG. 4d is another flow diagram illustrating an example process for generating an application message vector embedding of a received application message based on the modified Skip-Gram model of FIG. 4a;

FIG. 5a is a schematic diagram illustrating an example apparatus for generating an application message vector embedding of a received application message based on Variational Autoencoding (VAE) techniques;

FIGS. 5b-5c is a flow diagram illustrating an example process for training the apparatus of FIG. 5a for generating said application message vector embedding;

FIG. 5d is a schematic diagram illustrating an example apparatus for generating an application message vector based on VAE and tree graph techniques;

FIGS. 5e-5n illustrate schematic diagrams of example encoding and decoding processes based on the tree graph VAE of FIG. 5d;

FIG. 5o is a schematic diagram illustrating another example apparatus for generating an application message vector based on VAE and tree graph techniques;

FIGS. 5p and 5q illustrate schematic diagrams of example encoding and decoding neural network processes based on the tree graph VAE of FIG. 5o;

FIG. 6a is a schematic diagram illustrating an example neural network apparatus for predicting an next application message vector given a current application message vector as input;

FIG. 6b is a schematic diagram illustrating the unfolding of a recurrent neural network structure for use with the neural network apparatus of FIG. 6a;

FIG. 6c is a flow diagram illustrating a process for training the neural network apparatus of FIG. 6a;

FIG. 6d is a flow diagram illustrating a process for operating the neural network apparatus of FIG. 6a when the neural network apparatus has been trained;

FIG. 7 is a flow diagram illustrating a process for adapting the weights of a classifier based on error vectors of prediction application message vector(s) and corresponding actual application message vector(s) according to the invention; and

FIG. 8 is a schematic diagram of a computing device according to the invention.

Common reference numerals are used throughout the figures to indicate similar features.

### DETAILED DESCRIPTION

Embodiments of the present invention are described below by way of example only. These examples represent the best ways of putting the invention into practice that are currently known to the Applicant although they are not the only ways in which this could be achieved. The description sets forth the functions of the example and the sequence of steps for constructing and operating the example. However, the same or equivalent functions and sequences may be accomplished by different examples.

The inventors have found that it is possible to improve upon the detection of anomalous application messages (e.g. web requests) transmitted over a telecommunication networks between a client/user device executing an application (e.g. a web application or client/server application) and a network node (e.g. server node) in the telecommunications network (e.g. the Internet). An intrusion detection mechanism, process, apparatus or system receives application messages and detects whether these are anomalous application messages sent over the network during an application communication session between the client/user device and a network node. A received application message forms part of a received application message sequence comprising application messages that have been received so far during the application communication session. An estimate or prediction of the next application message that is expected to be received is generated using traffic analysis based on techniques developed in the field of deep learning on the received sequence of application messages that have been received so far. The traffic analysis further includes classification of contiguous or sequential sequences of the application messages as anomalous or normal as they are received during the application communication session based on and the sequences of estimated/predicted application messages and the received application message sequence received so far. This is used to determine or output a classification or an indication of whether the received sequence or one of more subsequences are either normal or anomalous.

When the classification/indication result is anomalous the system may send the indication to the client device, network node (e.g. server) or other network node responsible for maintaining the application communication session to action the receipt of the anomalous application message. For example, an action may include, by way of example only but is not limited to, blocking the application communication session and/or application message(s) from being used during execution of the application; warning the user of the application on the client device of the anomalous application message, warning the corresponding or reciprocal components of the application performed on a server or node during the application communication session of the anomalous application message (e.g. the application communication session has been attacked by a malicious user); warning an administrator associated with the application or application components responsible for execution of the application and/or maintaining the application communication session that an anomalous message has been sent between client device and a node of the network.

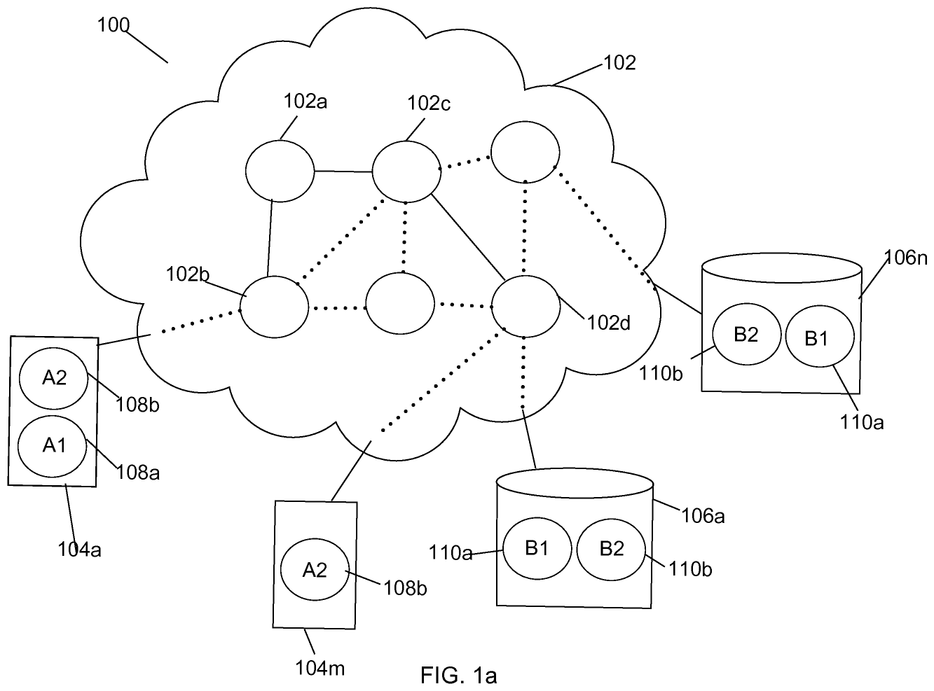

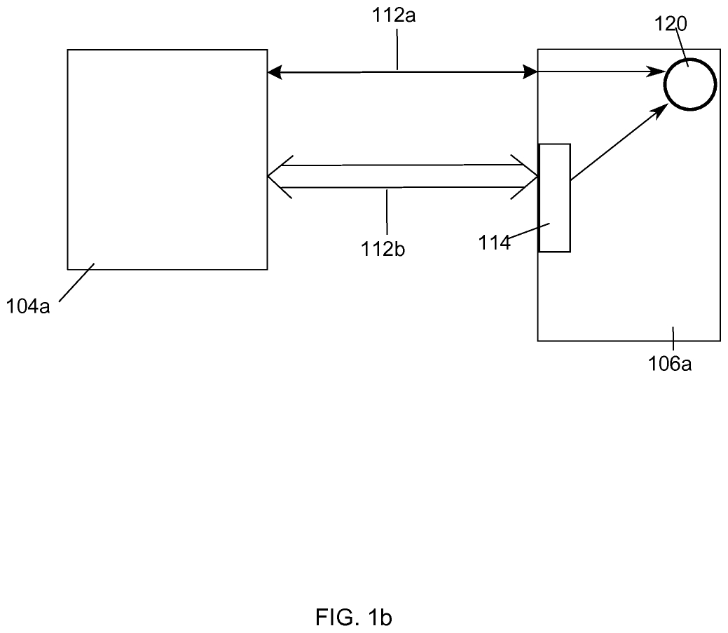

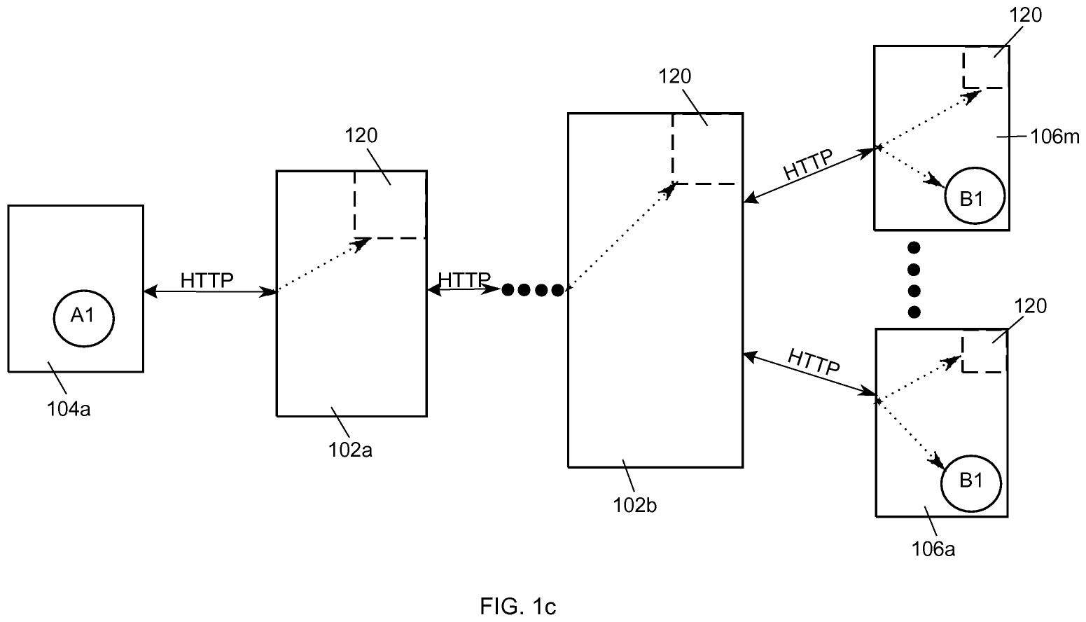

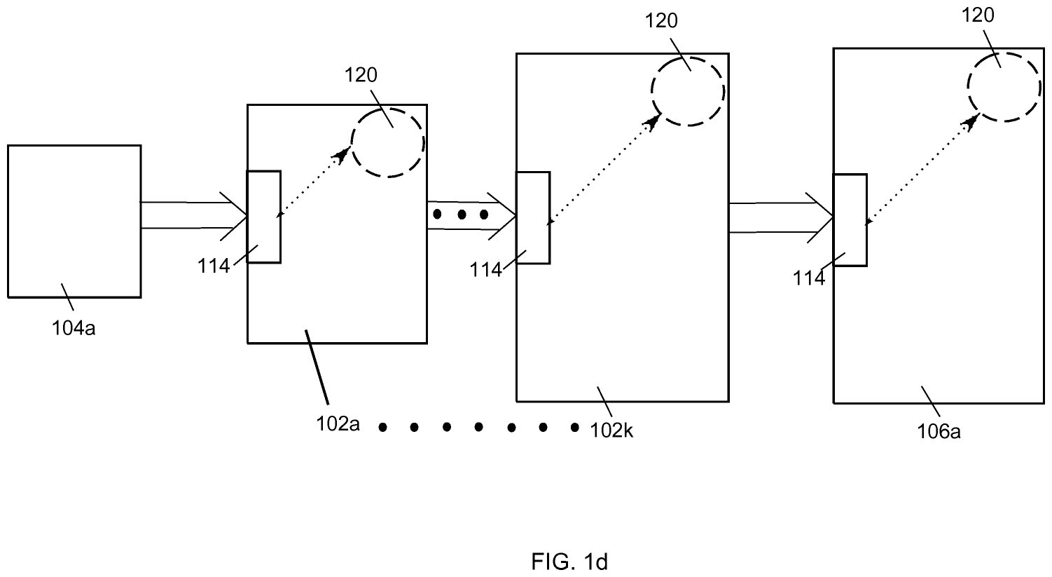

FIG. 1a is a schematic diagram of a telecommunications network 100 comprising telecommunications infrastructure 102 including a plurality of core nodes 102a-1021, one or more client devices (or devices) 104a-104m, and one or more server nodes 106a-106n that communicate with one or more client devices 104a-104m. The plurality of client devices 104a-104m and one or more server nodes 106a-106n are connected by links to one or more of the plurality of core nodes 102a-1021 of the telecommunications infrastructure 102. The links may be wired or wireless (for example, radio communications links, optical fibre, etc.).

A client device 104a-104m may comprise or represent any computing device capable of executing one or more application(s) 108a-108m and communicating over telecommunications network 100. Examples of client devices 104a-104m that may be used in certain embodiments of the described apparatus, methods and systems may be wired or wireless devices such as mobile devices, mobile phones, terminals, smart phones, portable computing devices such as laptops, handheld devices, tablets, tablet computers, netbooks, phablets, personal digital assistants, music players, and other computing devices capable of wired or wireless communications.

A server node 106a-106n may comprise or represent any computing device capable of providing services (e.g. web services, email services or any other type of service required by/provided to a client device) to client devices 104a-104m by executing one or more server application(s) 110a-110n that corresponding to one or more applications 108a-108m communicating over telecommunications network 100 with the one or more client devices 104a-104m. Examples of server devices 106a-106n that may be used in certain embodiments of the described apparatus, methods and systems may be wired or wireless devices such as one or more servers, cloud computing systems, and/or any other wired or wireless computing device capable of providing services and communicating with client devices 104a-104m over telecommunication network 100.

Telecommunications network 100 may comprise or represent any one or more communication network(s) used for communications between client devices 104a-104m and core nodes 102a-1021 and/or server nodes 106a-106n that connect to and/or make up the telecommunications network 100. The telecommunication infrastructure 102 may also comprise or represent any one or more communication network(s) represented by one or more cores nodes 102a-1021 that may comprise, by way of example only but is not limited to, one or more network entities, elements, application servers, servers, base stations or other network devices that are linked, coupled or connected to form telecommunications infrastructure 102. The telecommunication network 100 and telecommunication infrastructure 102 may include any suitable combination of core network(s) and radio access network(s) including network nodes or entities, base stations, access points, etc. that enable communications between the client devices 104a-104m, core nodes 102a-1021 and/or server nodes 106a-106m of the telecommunication network 100.

Examples of telecommunication network 100 that may be used in certain embodiments of the described apparatus, methods and systems may be at least one communication network or combination thereof including, but not limited to, one or more wired and/or wireless telecommunication network(s), one or more core network(s), one or more radio access network(s), one or more computer networks, one or more data communication network(s), the Internet, the telephone network, wireless network(s) such as the WiMAX, WLAN(s) based on, by way of example only, the IEEE 802.11 standards and/or Wi-Fi networks, or Internet Protocol (IP) networks, packet-switched networks or enhanced packet switched networks, IP Multimedia Subsystem (IMS) networks, or communications networks based on wireless, cellular or satellite technologies such as mobile networks, Global System for Mobile Communications (GSM), GPRS networks, Wideband Code Division Multiple Access (W-CDMA), CDMA2000 or Long Term Evolution (LTE)/LTE Advanced networks or any 2nd, 3^{rd}, 4^{th} or 5^{th} Generation and beyond type communication networks and the like.

FIG. 1b-1d are schematic diagrams illustrating placement of an intrusion detection mechanism 120 according to the invention within telecommunications network 100. The intrusion detection mechanism 120 is configured to detect anomalous application messages that may be sent by a malicious user or attacker over network 100 in place of expected one or more application message(s) during an application communication session. An application communication session may comprise or represent a communication session in which a device 104a and/or server node 106a may communicate one or more sequential application messages (e.g. HTTP requests/responses) between each other in which the application messages are associated with the same application executing on the device 104a. The application messages may be based on high level application protocols such as, by way of example only but not limited to, HTTP, Simple Mail Transfer Protocol, File Transfer Protocol and Domain Name System or any other suitable high level application protocol. The following description refers to HTTP for simplicity and by way of example only and it is appreciated that the skilled person would envisage that the invention is not so limited to using only HTTP but that any other suitable high level application protocol may be used.

For example, HTTP is an application layer protocol in which the application on the client device 104a may be a web application (e.g. an Internet banking application/website or online shopping application/website) and the server node 106a may provide corresponding web services (e.g. Internet banking or online shopping etc.). HTTP is used and described herein, by way of example only, as an exemplary application layer protocol, but it is to be appreciated by the skilled person that the invention as described herein is not limited only to the use of HTTP but that the invention encompasses any application-layer protocol and/or messaging structure that can be described by a domain specific language that convey application semantics through a specific syntax such as, by way of example only but not limited to, HTTP, Simple Mail Transfer Protocol, File Transfer Protocol and Domain Name System or any other suitable high level application protocol.

FIG. 1b illustrates a device 104a in communication with a server node 106a over telecommunications network 100. The device 104a is executing an application and is in communication with server node 106a, which provides the user of the device 104 with one or more services associated with the application. The device 104a creates an application communication session associated with the application for communicating with server node 106a. During the application communication session one or more application messages 112a or 112b may be sent between the device 104a and server node 106a. In this example, the application message(s) 112a are unencrypted application messages (e.g. HTTP request and/or response messages), whereas the application message(s) 112b are encrypted application messages (e.g. HTTPS request and/or response messages).

The intrusion detection mechanism 120 may be implemented within one or more core node(s) 102a-1021 and/or server node(s) 106a-106n of the telecommunication network 100 at a location suitable for intercepting the application messages sent to and/or from the device 104a and server node 106a. In this example, the intrusion detection mechanism 120 is located at the server node 106a. The intrusion detection mechanism 120 is also configured to operate on application messages associated with an application layer protocol. For example, the application layer protocol may be, by way of example only but is not limited to, HTTP and the application layer messages may be, by way of example only but are not limited to, HTTP requests and/or HTTP responses. Thus, the intrusion detection mechanism 120 is also configured to operate on unencrypted application messages 112a.

Should the device 104a and/or server node 106a have an application communication session in which encrypted application messages 112b are exchanged (e.g. HTTPS request and/or response messages), then the intrusion detection mechanism 120 may be implemented or located at a point in the network that is capable of and/or authorised to access the unencrypted application messages from the encrypted application messages 112b. For example, FIG. 1b illustrates that the intrusion detection mechanism 120 is implemented at the server node 106a and connected to the output of a decryption module 114. Thus, the intrusion detection mechanism has access to the unencrypted content/information of the application messages during the application communication session between device 104a and server node 106a.

FIG. 1c illustrates a device 104a in an application communication session communication with a server node 106a. The application messages are unencrypted application messages (e.g. HTTP request and/or responses), which are sent between the device 104a and server node 106a over a communication path in the telecommunications network 100. The communication path includes core nodes 102a, 102k and possibly one or more of server nodes 106a to 106m. In any event, the intrusion detection mechanism 120 may be implemented in any of the one or more communication nodes 102a-102k and/or server nodes 106a-106m in the communication path. This ensures the application messages are intercepted for application layer level traffic analysis by the intrusion detection mechanism 120.

FIG. 1d illustrates a device 104a in an application communication session communication with a server node 106a when the application messages are encrypted (e.g. HTTPS requests and/or responses). These are sent between the device 104a and server node 106a over a communication path comprising core nodes 102a, 102k and possibly one or more of server nodes 106a to 106m. In any event, the intrusion detection mechanism 120 may be implemented in any of the one or more communication nodes 102a-102k and/or server nodes 106a-106m in the communication path. However, those one or more nodes 102a-102k and/or 106a-106m in which the intrusion mechanism is implemented requires those nodes to have authorised access to the unencrypted application messages. Thus, a decryption module 114 may be required to decrypt the encrypted application message traffic for input to the intrusion detection mechanism. This ensures that the full information content of the encrypted application messages are intercepted by the intrusion detection mechanism 120 for application layer level traffic analysis by the intrusion detection mechanism 120.

The intrusion detection mechanism or apparatus 120, and/or method(s) and process(es) as described herein operate on application messages and/or application message sequences associated with an application layer protocol that are sent between a user device executing an application and a node in the network (e.g. a server node or other suitable node) that may provide a service corresponding to the application. An application message may be an application request message or an application response message. For example, a user device executing an application associated with a service provided by a node may transmit an application request message to the node over the network for requesting access to the service associated with the application (e.g. a web application may contact a server that provides web services). The node in the network may respond to the application request message by sending an application response message. This may lead to an exchange of application request and response messages being transmitted between the user device and node during an application communication session.

This exchange of application messages may result in an application message sequence that may comprise or represent a sequence of one or more application messages that are communicated between a user device and a node in the network during an application communication session. There are many ways to form an application message sequence. For example, an application message sequence may comprise or represent one or more application request messages that are sent from the user device to the node in the network. In another example, an application message sequence may comprise or represent one or more application response messages that may be sent from the node in the network to the user device. In a further example, an application message sequence may include a sequence of one or more application request and/or response messages that may be sent between the user device and node. Although several application message sequences have been described, by way of example only, it is to be appreciated by the skilled person that any application message sequence may be received and analysed by the intrusion detection mechanism. Effectively an application message sequence may comprise or represent one or more application messages in which the sequence includes one or more application request messages, one or more application response messages, or one or more application request messages and one or more application response messages.

Each application message sequence of an application communication session may typically be an ordered application message sequence in which the ordering is determined by when each application message is received by the intrusion detection mechanism or the user device and/or node implementing an intrusion detection method. Each application message in the application message sequence may be designated a time step i for 1<=i<=L, where L is the total length of the application message sequence for an application communication session, when it is received by the intrusion detection mechanism. The intrusion detection mechanism may be located at the user device, or an intermediate node in the network, or at a server node in the network, or any other entity in the network capable of accessing application messages. For example, time step i=1 is an index that indicates the first application message to be received by the intrusion detection mechanism/method, time step i−1 is an index indicating the (i−1)-th application message that is received, time step i is an index indicating the i-th application message that is received after the (i−1)-th application message has been received, time step (1+1) is an index indicating the (i+1)-th application message that is received, and so on until time step i=L, which is an index indicating the last application message to be received by the intrusion detection mechanism/method for that application communication session.

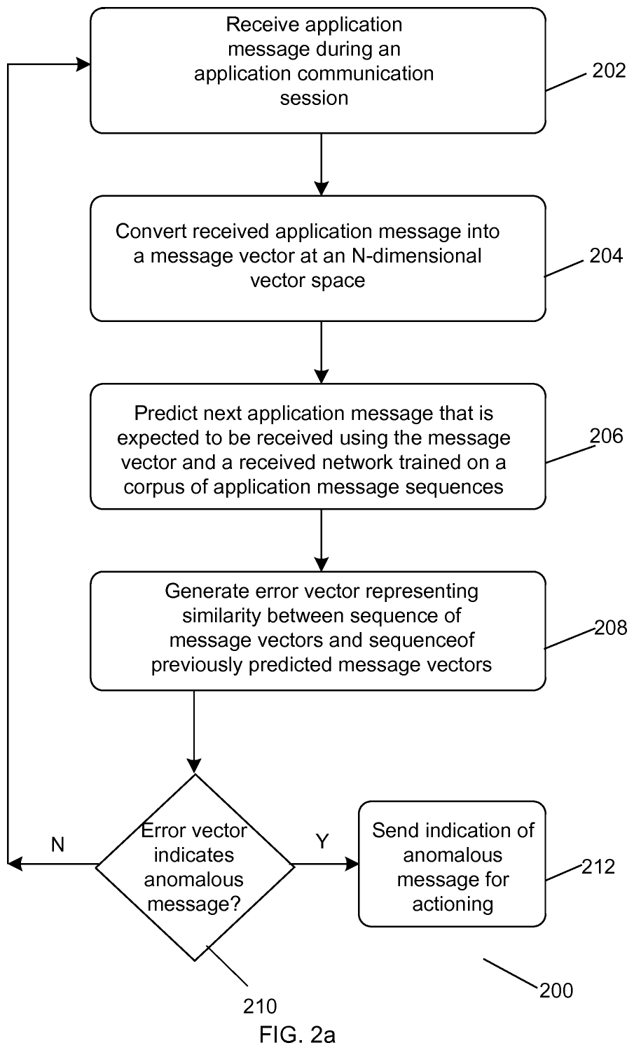

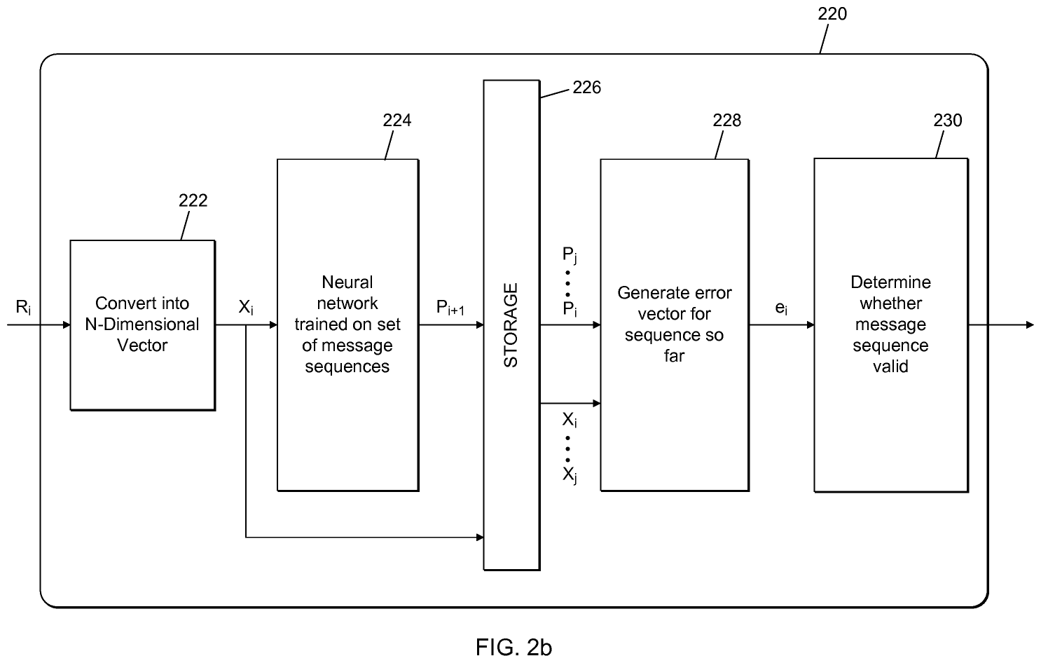

FIG. 2a is a flow diagram illustrating an example method for detecting an anomalous application message sequence associated with an application executing an application communication session between a client device and a node in a network. The method may include the following steps:

In step 202, a node in the network receives an application message sent from the client device during the application communication session. The received application message is associated with a sequence of previously received application messages. These were previously sent during the application communication session.

In step 204, the received application message is converted into a current message vector in an N-dimensional vector space. N is an integer greater than 1. The current message vector represents the information content of the received application message.

In step 206, the current message vector (and one or more previous message vectors) can be used to predict the next application message expected to be received in the application message sequence by inputting the current message vector into a neural network trained on a set of application message sequences associated with the application. The neural network has been trained to predict the next application message that is expected to be received given the current message vector and the previous message vectors received before it for an application message sequence. The predicted next application message expected to be received is represented as a prediction vector in the N-dimensional vector space. The predicted next application message represents the predicted information content of the next application message that is expected to be received.

The training set of application messages or application message sequences include a plurality of normal application messages or normal application message sequences. A normal application message or a normal application message sequence is an application message or application message sequence that is considered to be based on the normal operation or communications of the application between, by way of example only, a user device and a node during an application communication session. An abnormal application message or an abnormal application message sequence is considered to be an application message or message sequence that has one or more application messages that differ from the normal operation of the application. Typically, these messages or message sequences have been maliciously changed. For example, a normal application message may be been generated by the application under normal operation of the application during an application communication session, but before or after transmission of the application message an unauthorised user or entity or malicious attacker/entity has changed the application message. Such an application message is considered to be an abnormal application message, and the message sequence that contains this abnormal application message is considered to be an abnormal application message sequence.

Essentially, a neural network may be trained by performing multiple passes of a selected i-th application message vector associated with an application message sequence from the training set of application message sequences, where 1<=i<=L and L is the length of the application message sequence, through hidden layer(s) of the neural network to an output layer and, on each pass, adjusting or adapting the weights based on optimising a cost function. For example, for each pass, the weights of the hidden layer(s) may be adjusted to minimise a cost function that determines an error term or similarity between the output layer, i.e. an output prediction vector representing the predicted next application message, and the actual next application message vector in the sequence. This is performed over all the application message sequences in the training set of application message sequences in which the cost function is minimised for each one. There are numerous techniques or methods for training a neural network, determining a cost function and for adjusting the weights of the hidden layer(s) of a neural network, and it is to be appreciated that the skilled person may use any suitable cost function or technique for training a neural network such as, by way of example but not limited to, stochastic gradient descent and backpropagation techniques, Levenberg-Marquardt algorithm, Particle swarms, Simulated Annealing, Evolutionary algorithms, or any other suitable algorithm or technique for training a neural network or any combination, equivalents or variations thereof.

In step 206, the current message vector (and one or more previous message vectors) can be used to predict the next application message expected to be received in the application message sequence by inputting and passing the current message vector into and through the trained neural network, which outputs an estimate of the predicted next application message expected to be received represented as a prediction vector in the N-dimensional vector space. The predicted next application message represents the predicted information content of the next application message that is expected to be received.

In step 208, an error vector is generated that represents the similarity between two vector sequences; a sequence of message vectors associated with the received application message sequence, and a corresponding sequence of prediction vectors. The prediction vector corresponding to the next application message expected to be received is excluded as this will be used in the generation of the error vector associated with the next received application message.

In step 210, the error vector is used to determine whether the received application message sequence is an anomalous application message sequence. This may be achieved by a classifier trained on a set of error vectors derived from normal application messages or normal application message sequences and corresponding vector space analysis of the error vectors resulting from the classifiers training. For example, a threshold region, or manifold, or a threshold surface associated with error vectors of normal application messages or message sequences may be determined. From this, the generated error vector may be determined or classified to be normal if it lies within the threshold region, manifold or surface, otherwise the generated error vector may be determined to be outside this region or manifold and classified as anomalous. If the generated error vector is determined to be normal, then the method proceeds back to step 202 for receiving the next application message. If the generated error vector is determined to be anomalous, then one or more of the received application message(s) may be anomalous indicating a malicious user and/or attacker is attempting to hack into the application communication session, and the method proceeds to step 212.

In step 212, an indication of an anomalous received application message or message sequence is sent for actioning in response to determining that the received application message sequence is anomalous. As described above, this may include warning the application executing on the client device and/or the corresponding reciprocal application executing on a server node of the anomalous application message sequence in which a suitable level of response is made (e.g. blocking of the application communication session or blocking the client device from the application communication session). Some applications may be legacy applications, which may not have the necessary functions for receiving warnings of anomalous application messages, in which case the indication of anomalous message or message sequence may be sent to a system administrator and/or a security application for actioning.

The intrusion detection method 200 may be implemented as an intrusion detection mechanism or apparatus 120 on a node 102a-1021 and/or 106a-106m in the telecommunications network 100. The intrusion detection mechanism 120 may be configured to intercept application messages during an application communication session between a client device and a server node. The intrusion detection mechanism 120 and method 200 are configured to operate on application-layer traffic and apply deep neural networks to model the syntax of application messages during an application communication session. If the application messages generated by an application can be described by a domain specific language, this then conveys application semantics through a specific syntax. By learning the baseline syntax, the probability that any string, sequence or stream of application messages sent from the client device 104a to the server node 106a that diverges from the expected syntax of the application messages can be calculated and thus classified as normal or anomalous. The intrusion detection mechanism 120 and intrusion detection method 200 as described comprises several components that are configured to classify sequences of incoming application messages as either anomalous or normal.

FIG. 2b is a schematic diagram illustrating an intrusion detection apparatus or mechanism 220 for implementing the method of FIG. 2a. The intrusion detection apparatus 220 includes a conversion module 222 for converting the i-th received application message, denoted Rᵢ, into a N-dimensional application message vector xᵢ corresponding to the i-th currently received application message Rᵢ, for 1<i<=L, where L is the length of the message sequence generated during the application communication session between the user device 104a and server node 106a. The j-th application message sequence can be denoted (Rᵢ)ⱼ for 1<=i<=Lⱼ, where Lⱼ is the length of the j-th application message sequence. The message vector xᵢ represents the informational content of the i-th received application message Rᵢ. The j-th application message vector sequence may be denoted (xᵢ)ⱼ for 1<=i<=Lⱼ.

The i-th N-dimensional message vector xᵢ is passed to a neural network module 224 and also, in this example, to storage 226. In this example, the neural network module 224 has been trained on a training set of “normal” application message sequences {(Rᵢ)ⱼ}ⱼ₌₁^{T} and processes the message vector xᵢ to generate a prediction application message vector pᵢ₊₁ that represents a prediction of the next application message, Rᵢ₊₁ that is expected to be received in the application message sequence of the application communication session. The neural network module 224 outputs prediction application message vector pᵢ₊₁ representing the informational content of the predicted next application message expected to be received in the application communication session.

The conversion module 222 and neural network module 224 are both coupled to storage 226, which is used for storing sequences of message vectors (xᵢ) for 1<=i<=L, where L is the length of the message sequence during the communication session and also sequences of prediction message vectors (pᵢ) for 1<=i<=L. The i-th prediction message vector pᵢ is a prediction of the i-th application message vector xᵢ conditioned on (xⱼ) for 1<j<=i−1, where p₁ is a prediction message vector for predicting x₁ conditioned on nothing. In other words, p₁ is a prediction message vector for predicting x₁ given no input, p₂ is a prediction message vector for predicting x₂ given x₁ as input, p₃ is a prediction message vector for predicting x₃ given the sequence (x₁, x₂) as input, and pᵢ is the i-th prediction message vector for predicting the i-th application message vector, xᵢ, given the sequence (xⱼ) for 1<j<=i−1, and so on, in which p_{L} is the L-th prediction message vector for predicting the L-th application message vector given the sequence (xⱼ) for 1<j<=L−1. Storing message vectors associated with the previous and currently received application messages and corresponding prediction vectors allows further processing of the message vector sequence associated with the received application messages Rᵢ for determining whether the sequence of application messages are normal or anomalous.

Error vector module 228 is configured to generate error vectors describing the similarity between a sequence of message vectors received so far and a sequence of corresponding prediction vectors. For example, a sequence of message vectors may be sent one after the other during an application communication session. The sequence of message vectors that are so far received at time step i may be denoted (xₖ)ₖ₌₁ⁱ=(x₁, . . . , xₖ . . . , xᵢ) for 1<=k<=i<=L, where L is the total length of the sequence of message vectors, and the sequence of corresponding prediction vectors that have been predicted so far at time step i may be denoted (pₖ)ₖ₌₁ⁱ=(p₁, . . . , pₖ . . . , pᵢ) for 1<=k<=i<=L. Thus, the error vector module 228 may take as input these two sequences of application message vectors and prediction vectors that have been so far received at time step i and calculate the similarity between them to generate an error vector for the received message sequence that has been received so far at time step i, which may be denoted, eᵢ. The similarity may be determined based on the pairwise Euclidean/cosine distance between the sequences, or calculating the cosine similarity between the sequences, or using any other method or function that expresses the difference or similarity between these sequences.

The error vector eᵢ for the i-th received message sequence is passed to a classification module 230 that determines whether the received application message sequence (Rₖ)ₖ₌₁ⁱ is normal or anomalous. Essentially, the classification module 230 is trained and configured to define a threshold region, threshold surface or hyperplane that separates the error vectors eᵢ of normal application message sequences received so far at time step i from the error vectors eᵢ of anomalous application message sequences. Thus, should the error vector eᵢ at time step i be found to be on the “normal” side of the threshold region or within the threshold region, then the application message sequence at time step i is determined to be “normal” or nominal and no action is required. However, should the error vector eᵢ at time step i be found to be on the “anomalous” side of the threshold region or outside the threshold region defining the error vector eᵢ as normal, then the application message sequence at time step i is determined to be anomalous and an action is taken to mitigate or prevent the anomalous application message sequence from prejudicing the application communication session. As described above, such an action may be to send an indication of an anomalous received application message or message sequence for actioning in response to determining that the received application message sequence is anomalous.

Although a sequence of message vectors received at time step i may be denoted (xₖ)ₖ₌₁ⁱ=(x₁, . . . , xₖ . . . , xᵢ) for 1<=k<=i<=L, and a sequence of corresponding prediction vectors that have been predicted may be denoted (pₖ)ₖ₌₁ⁱ=(p₁, . . . , pₖ . . . , pᵢ) for 1<=k<=i<=L, it is to be appreciated by the skilled person that other sequences of message vectors and corresponding prediction vectors up to time step i may be used to generate an error vector for the i-th received message sequence denoted eᵢ. For example, the above sequence of messages may be rewritten as (xₖ)ₖ₌ₐⁱ=(xₐ, . . . , xₖ . . . , xᵢ) for 1<a=k<=i<=L, and the corresponding sequence of prediction vectors that have been predicted may be denoted (pₖ)ₖ₌ₐⁱ=(pₐ, . . . , pₖ . . . , pᵢ) for 1<=a<=k<=i<=L. Thus, the variable a may be used to select other subsequences of the sequence of message vectors received up until time step i. For example, a=2 gives the subsequence (x₂, . . . , xₖ . . . , xᵢ) and the corresponding prediction vector subsequence of (pₖ)ₖ₌₂ⁱ=(p₂, . . . , pₖ . . . , pᵢ). Another example of generating subsequences of the sequence (xₖ)ₖ₌₁ⁱ received so far at time step i may be to “window” the sequence of message vectors received so far at time step i to a length b or to the b most recent message vectors up to and including time step i. For example, the sequence of messages may be defined as (xₖ)_{k=i-b+1}ⁱ=(x_{i=b+1}, . . . , xₖ . . . , xᵢ) for (i−b+1)<=k<=i<=L and b>=1 and the corresponding sequence of prediction vectors that have been predicted may be denoted (pₖ)_{k=i-b+1}ⁱ=(p_{i-b+1}, . . . , pₖ . . . , pᵢ). Any of these sequences or subsequences (or variations thereof) may be used in generating an error vector eᵢ for time step i of the received message sequence so far. In order to do this, the classification module 230 may need to be trained and configured to define a corresponding threshold region or manifold (or hyperplane etc.) based on how the error vectors eᵢ where generated. The threshold region or hyperplane is used to identify error vectors eᵢ associated with normal application message sequences and error vectors eᵢ associated with anomalous application message sequences, and thus detect whether the application message sequence is “normal” or “anomalous”.

As described above, the intrusion detection mechanism 120, apparatus 220 and/or method 200 operates on application messages and/or application message sequences associated with an application layer protocol. An application message may be application request message or an application response message. The application message sequence may comprise one or more application messages that are communicated between a user device and a node in the network during an application communication session. The application message sequence may comprise one or more application request messages that are sent from the user device to the node in the network. The application message sequence may include one or more application response messages that may be sent from the node in the network to the user device. The application message sequence may include a sequence of one or more application request messages and one or more application response messages.

Each application message sequence of an application communication session may typically be an ordered application message sequence in which the ordering is given by when each application message is transmitted or received by the user device and/or node. Each application message in the application message sequence may be designated a time step i for 1<=i<=L, where L is the total length of the application message sequence for an application communication session, when it is received by the intrusion detection mechanism. The intrusion detection mechanism may be located at the user device, or an intermediate node in the network, and/or at a server node in the network. Time step i=1 designates the first application message to be received by the intrusion detection mechanism, and time step i=L defines the last application message in an application message sequence to be received by the intrusion detection mechanism during the application communication session.

For example, HTTP is an application layer protocol in which the application on the client device 104a is a web application and the server node 106a provides web services (e.g. Internet banking or online shopping etc.). HTTP may be used and described herein, by way of example only, as an exemplary application layer protocol, but it is to be appreciated by the skilled person that the invention as described herein is not limited only to the use of HTTP but that the invention encompasses any application-layer protocol and/or messaging structure that can be described by a domain specific language that conveys application semantics through a specific syntax. In HTTP, the application layer messages or application messages include HTTP requests and/or HTTP responses. HTTP application messages (e.g. HTTP requests and/or responses) may be transmitted between a client device 104a and a server node 106a during an HTTP application communication session. The HTTP describes how the content of HTTP application messages are formed and structured and is one of the many application layer protocols that uses a domain specific language that conveys application semantics through a specific syntax.

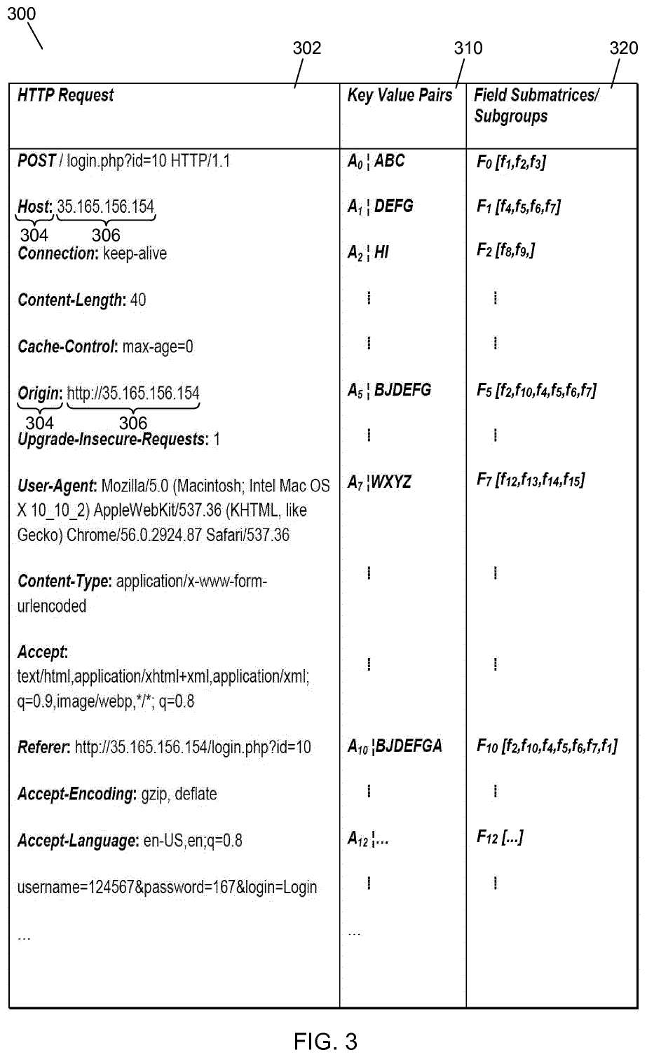

FIG. 3 illustrates a table 300 describing the structure of an example application message using HTTP. The application message is an HTTP 1.1 request 302 and is shown in column 1 of table 300 in which the text highlighted in bold are field headings 304 (e.g. keywords or reserved words) associated with the HTTP 1.1. protocol and the text after the colon are data fields 306 associated with the field headings (e.g. keywords or reserved words). HTTP is an application layer protocol on the network stack, and is responsible for almost all transfer of files and data over the world wide web. HTTP communication uses the network level Transmission Control Protocol and Internet Protocols (TCP/IP), and is most commonly used between a client device and a server node.

It can be seen that an HTTP request 302 is described by a domain specific language that conveys application semantics through a specific syntax, e.g. field headings 304 (e.g. keywords or reserved words) and corresponding data fields 306. The example HTTP request 302 may be transmitted as an application message from a client device to a server node during an HTTP application communication session.

As illustrated in FIG. 3, the textual representation of application messages such as the HTTP request 302 usually contain a large number of characters that do not contribute to its semantics, these are characters of low informational entropy. For example, this includes the text highlighted in bold, which are field headings 304 (e.g. POST, Host, Connection, . . . , Accept, Referer, etc.) Thus, inputting such raw textual representation with a lot of redundancy or low informational entropy will may decrease the performance of the intrusion detection mechanism or apparatus.

Instead, each application message such as HTTP request 302 can be converted into a message vector of an N-dimensional vector space in which the message vector contains substantially the same informational content as that represented by the application message (e.g. HTTP request 302). The size of N depends on the application and application layer protocol used for defining the application messages for the communication session. For example, the size of N may be, by way of example only but is not limited to, 64, 128, 256, 512 or 1024 including values less than 64 and other values between 64 to 1024 or higher than 1024 depending on the application and application layer protocol used for defining and generating the application messages.

For example, the textual representation of a plurality of HTTP requests may be analysed and an encoder determined such that characters or one or more groups of text or characters of the HTTP message(s) may be mapped to a compressed textual representation. The compressed textual representation may comprise or be represented by a plurality of labels and/or symbols. This mapping may be represented as a message matrix M of dimension A×B, where A is the number of different characters and B is the number of symbols representing the textual representations. For example, in a very simple example, the American Standard Code for Information Interchange (ASCII) may be used to encode 128 specified characters into seven-bit integers, thus a message matrix M may be formed in which A=128 and B=7. The position of each row of the message matrix M may represent a character or subgroup of text and the corresponding row is a vector representing the compressed textual representation or symbol. So, an HTTP request may be encoded into a more compressed textual representation.

The encoding of an HTTP request may then be processed to generate an N-dimensional message vector with elements or values that represent the information content of the application message. This conversion as described with reference to FIGS. 2a and 2b in step 202 and conversion module 222 may include encoding the application message, in this case an HTTP request, and embedding the encoded HTTP request as a message vector in an N-dimensional vector space. The size of N may selected to provide an informationally dense application message vector that is a suitable representation of the original application message. Typically the larger the size of N, the better the N-dimensional application message vector represents the original application message. A person skilled in the art would appreciate that there is a trade off between computational complexity of processing an application message vector sequence using neural network techniques and the size of the N-dimensional application message vector.

For example, since each HTTP request (e.g. application message) includes one or more field headings (e.g. reserved words) and each field heading is associated with a data field, the conversion may include encoding the field headings and associated data fields of the HTTP request into corresponding key value pairs. Thereafter, the encoded HTTP request may be embedded as a message vector of an N-dimensional vector space based on the key value pairs associated with the HTTP request. One example way to determine a suitable size of N may be to base Non the number of possible HTTP field headings. Another method may be to select an N that minimises the reconstruction loss of converting and embedding an application message to an application message vector and vice versa. For example, as described hereinafter, the conversion process may include the use of a neural network based on, by way of example only but not limited to, a variation autoencoder or neural network based on a Skip Gram model for embedding an application message as an application vector, thus N may be chosen to minimise the reconstruction loss of such a neural network. The upper bound of an N that may be chosen can be a function of the number of data-points or application message vectors in the training set of application message vectors, where the number of parameters/weights of the neural network should not exceed the number of data-points/application messages.

Encoding the application message into key value pairs may include forming key value pairs by mapping each reserved or key word (e.g. field heading) in the application message to a corresponding unique label to form a key for a key value pair. For example, table 300 in FIG. 3 includes example key-value pairs 310 in column 2 that are mapped to corresponding field headings 304 and corresponding field data 306 of HTTP request 302. As illustrated in FIG. 3, the field heading POST may be mapped to the unique label A₀, HOST may be mapped to the unique label A₁, CONNECTION may be mapped to A₂, . . . , Origin may be mapped to A₅, . . . , User-Agent may be mapped to A₇, Referer may be mapped to A₁₀, . . . , Accept-Language may be mapped to A₁₂ and so on. These unique labels form keys A₀, A₁, A₂, . . . , A₅, . . . , A₇, . . . , A₁₀, . . . , A₁₂, . . . and so on for the key value pairs and correspond to the field headings of HTTP request 302. The HTTP 1.1 protocol has a limited number, N, of field headings that may be used in each HTTP request, thus these field headings may be mapped to a number of N unique labels, e.g. A₀, A₁, A₂, . . . , A_{N-1}. Using these labels, codebooks, look-up tables or hash tables may be defined for each key-value pair.

In the application message, each of the data fields (e.g. data fields 306) associated with each reserved word or keyword (e.g. field headings 304) may be further encoded into a compressed form (e.g. using lossless compression, which reduces the number of bits using statistical redundancy) to form a key value for that key value pair. Although lossless compression is described herein, this is by way of example only and is not limiting, the skilled person would appreciate that other compression schemes may be used such as, by way of example only but not limited to, lossy compression schemes (lossy compression reduces bits by removing unnecessary or less important information) may be used at a cost of a possible degradation in the quality of the embeddings but at a possible improvement in computational complexity or use of computational resources.

For the HTTP request 302, each of the data fields 306 associated with each field heading 302 may be compressed to form a key value associated with the key for that key value pair. It is noted that this examples uses an arbitrary compression scheme for illustrative purposes only. In the following description alphabetical characters are used to illustrate compression symbols that may be output from a compression scheme, algorithm and the like. For example, for the HTTP request 302, the data field for key A₀ may be compressed from “/login.php?id=10 HTTP/1.1” to be represented as compression symbols “ABC” (e.g. “/login.php?id=10->A; HTTP->B; C->/1.1, where the “->” represents the compression scheme mapping the data field to a compression symbol). The data field for key A₁ may be compressed from “35.165.156.154” to be represented as compression symbols “DEFG” (e.g. 35.->D; 165.->E; 156.->F; 154->G), the data field for key A₅ may be compressed from “http://35.165.156.154” to be represented as compression symbols “BJDEFG” (e.g. http->B; ://->J; 35.->D, 165.->E; 156.->F; 154->G), the data field for key A₇ may be compressed from “Mozilla/5.0 (Macintosh; Intel Mac OS X 10_10_2) AppleWebKit/537.36 (KHTML, like Gecko) Chrome/56.0.2924.87 Safari/537.36” to be represented as compression symbols “WXYZ”, the data field for key A₁₀ may be compressed from “http://35.165.156.154/login.php?id=10” to be represented as compression symbols “BJDEFGA” (e.g. http B; ://->J; 35.->D, 165.->E; 156.->F; 154->G;/login.php?id=10->A), and so on for all key-value pairs in the application message. Thus, for the HTTP request 300, the key-value pairs that are formed may be A₀¦ABC, A₁¦EFGH, . . . , A₅¦DEFGH, . . . , A₇¦WXYZ, . . . , A₁₀¦BJDEFGA and so on as illustrated, by way of example only, in the Key Value Pairs column 310 of FIG. 3. Each HTTP request, and for that matter each application message, will likely have different key-value pairs due to the differences in information content from one HTTP request (or application message) to the next.

Lossless compression based on Huffman encoding or coding may be used to compress the field data. Typically Huffman encoding embeds the codebook in the encoding itself. So a modified Huffman encoding may be used in which the codebook is represented externally to the encoding itself. For example, a code book cipher or look-up code table may be formed based on Huffman encoding or any other encoding/compression scheme. That is, variable length codes may be assigned to input characters, words or text in which the lengths of the assigned codes are based on the frequencies of the corresponding characters, words or text. The most frequent character, word or text, is assigned the smallest code and the least frequent is assigned the largest code. This may be stored in a code book or code look-up table rather than embedding this information into the encoding. It is possible to produce an encoding that maximises the entropy of an given application message associated with an application-layer protocol. For example, for HTTP and HTTP requests for a given a code book of finite size of 8 bits, or 128 different labels, and exploiting the known structure within the HTTP request, an application-specific modified Huffman encoding may be constructed in which encoded field names are mapped to the corresponding set of globally unique labels. By using these labels as markers, codebooks of equal size for each field data may be defined, which means the total codebook size is (2⁸−N)² where N is the number of field headings. This enables the compression of an HTTP request of approximately 1000 characters down to approximately 150 with high informational entropy.

Even though a set of key-value pairs may represent each application message (e.g. each HTTP request and/or response), neural networks typically require continuous input so the key-value pairs for each application message need to be embedded as an application message vector, x, in an N-dimensional vector space of continuous real values (e.g. x∈ [symbol] ^{N}). The application message vector, x, may be processed by a neural network as described herein, by way of example, in FIG. 2a on step 202 of method 200 and/or in FIG. 2b by the neural network module 224 (or step 204 of method 200) or hereinafter.

One method for achieving this embedding is to create a distributional semantic model for application messages associated with an application-layer protocol. For example, a distributional semantic model may be created for application messages (e.g. HTTP requests) such that, at time step i, the i-th application message can be represented by a single i-th application message vector xᵢ∈ [symbol] ^{N}. For example, as previously described, the data fields of HTTP requests can be textually represented by strings of characters, as is typically the case for most application-layer protocols. HTTP requests contain a limited number of parts or key-value pairs and are commutative, which means that the semantics of an HTTP request is invariant to the ordering of its parts or key-value pairs. This means that it is possible to encode all information of a single request as a vector in a fixed number of dimensions, which can be achieved after encoding the application message into a set of key-value pairs (e.g. key value pairs 310 in column 2 of FIG. 3) that maximises the entropy of the information content of the application message.

Thus, the conversion module 222 or step 202 of method 200 may be further configured to generate a message vector associated with the application message by passing data representative of the application message and corresponding key value pairs through a neural network based on the Skip-Gram model. That is each application message is embedded as a message vector suitable for input into a neural network for training and/or trained for determining whether a message sequence during an application communication session is normal or anomalous.

Firstly, the application message must be embedded as a message vector. The neural network based on the Skip-Gram Model may be trained on a set of application messages, which have themselves been encoded appropriately as described above into key value pairs. The training of the Skip-Gram neural network may be achieved by the neural network maintaining a message vector matrix and a field vector matrix (a.k.a message matrix and field matrix). For example, each column or row of the message matrix represents a message vector associated with an application message. Each column or row of the field matrix represents a field vector associated with one or more key value pairs of corresponding application messages.

The message matrix may be randomly initialised. A column or row of the message matrix represents an application message and a corresponding group of field vectors in the field matrix represents the key-value pairs associated with the application message. The group of field vectors further includes subgroups of field vectors, in which each subgroup of field vectors corresponds to each of the compression symbols of a key value pair of the application message. This means that each key is represented by a subgroup of field vectors, and that each of the different compression symbols used for compressing the data field is represented by a field vector. Each field vector may be represented as a one-hot vector representing each compression symbol.

Compressing the field data of key-value pairs derived from a set of application messages (e.g. a set of HTTP requests including the HTTP request 300) based on compression principles such as Huffman encoding or other lossless compression allows an efficient representation of the field data in the form of compression symbols. Each unique compression symbol that results from encoding a set of application messages (e.g. a plurality of application messages) may be used to form a vocabulary. If there is a number of K unique compression symbols that can be used to represent the set of application messages, then the size of the vocabulary would be K. K is greater than 1 or K>>1. The size of K may be selected to ensure the application message may be suitably encoded in an efficient manner. A person skilled in the art would also appreciate that there is a trade off between the size of K and the computational complexity of the encoding technique used to encode and process an application message and/or application message sequence using encoding techniques such as, by way of example only but not limited to, encoding techniques based on lossless encoding or lossy encoding, or encoding techniques using neural network techniques (e.g. Skip Gram model or Variational Autoencoder). These unique compression symbols may then be mapped into unique field vectors that form the vocabulary used to represent each application message as input to the Skip-Gram model. The size of N may selected to provide an informationally dense application message vector that is a suitable representation of the original application message.

The vocabulary may also include alphanumeric characters, symbols or any other character or symbol that is likely to appear in an application message associated with an application layer protocol. These characters or symbols may be used as separate unique compression symbols for those characters or strings that cannot be compressed. These alphanumeric characters and symbols etc., can also be mapped to unique field vectors in the vocabulary. This ensures the vocabulary is able to handle future received application messages that have different alphanumeric characters, strings or text compared to the set of application messages. This means these future received application messages may also be encoded and represented by the vocabulary and corresponding field vectors for embedding as message vectors.

Thus, the compression symbols allows a limited vocabulary to be formed in which each of the different compression symbols may be used for encoding a set of application messages. Each unique compression symbol can be represented by a unique field vector of a K-dimensional vector space. For example, one of the simplest ways to generate unique field vectors is by using one-hot vectors in the K-dimensional vector space. One-hot vectors are vectors that will have K components (or elements), one component for every unique compression symbol in the vocabulary, in which a “1” is placed in a position corresponding to the unique compression symbol and Os in all of the other positions. Each unique compression symbol has a “1” placed in a different position of the one-hot vector. Given this, each compression symbol may be mapped to a unique field vector. The K unique field vectors may thus be represented by a field vector matrix F[f₁, f₂, . . . , fₖ] comprising field vectors f₁, f₂, . . . , fₖ, which may be either column or row vectors. For the sake of simplicity, it is assumed that these vectors are column vectors or columns of the field matrix F, but the skilled person would appreciate that each of these vectors may be row vectors or rows of field matrix F.

For example, FIG. 3 illustrates a mapping from the informational content of an application message (HTTP request 302) to corresponding key-value pairs 310 (e.g. see columns 1 and 2) in which the field data 306 is compressed as previously described. Furthermore, each key-value pair can be mapped to a corresponding subgroup of field vectors 320. For example, the first key value pair, A₀¦ABC is mapped to a first subgroup of field vectors (or submatrix) F₀[f₁, f₂, f₃], where f₁, f₂, and f₃ are field vectors in which each compression symbol has been mapped to a field vector, i.e. A is mapped to f₁, B is mapped to f₂ and C is mapped to f₃. Although f₁, f₂, and f₃ may be column vectors each comprising a column of submatrix F₀, it is to be appreciated by the skilled person that they may also be row vectors comprising a row of submatrix F₀.

If the vocabulary of the compression symbols of HTTP 1.1 protocol (or for that matter any application-layer protocol) is of size K, then there would be a number of K unique field vectors in a K-dimensional vector space that may be used to represent the vocabulary. Each field vector may be a K-dimensional one-hot vector. For example, the first subgroup of field vectors (or submatrix) F₀[f₁, f₂, f₃], each of the field vectors f₁, f₂, and f₃ are K-dimensional one-hot vectors with a ‘1’ placed in a different position and K−1 zeros in all other positions. These vectors may be represented, by way of example only but are not limited to: f₁=f₂=[0, 1, 0, . . . , 0]^{T}, and f₃=[0, 0, 1, . . . , 0]^{T}, where T is the transpose operator (these are column vectors).

Similarly, the key-value pair A₁¦DEFG is mapped to a second subgroup of field vectors F₁ [f₄, f₅, f₆, f₇] in which D is mapped to f₄, E is mapped to f₅, F is mapped to f₆, and G is mapped to f₇. These vectors may be represented, by way of example only but are not limited to, as: f₄=[0, . . . , 0, 0, 1]^{T}, f₅=[0, . . . , 0, 1, 0]^{T}, f₆=[0, . . . , 1, 0, 0]^{T}, and f₇=[0, . . . , 1, 0, 0, 0]^{T}. Key-value pair A₅¦BJDEFG is mapped to a subgroup of field vectors F₅ [f₂, f₁₀, f₄, f₅, f₆, f₇] in which B is mapped to f₂, J is mapped to f₁₀, D is mapped to f₄, E is mapped to f₅, F is mapped to f₆, G is mapped to f₇. These vectors may be represented, by way of example only but are not limited to, as: f₂=[0, 1, 0, . . . , 0]^{T}, f₁₀=[0, . . . 0, 1, 0, . . . , 0, 0, 0, 0]^{T}, f₄=[0, . . . , 0, 0, 1]^{T}, f₅=[0, . . . , 0, 1, 0]^{T}, f₀=[0, . . . , 1, 0, 0]^{T}, and f₇=[0, . . . , 1, 0, 0, 0]^{T}. It is noted that the field submatrices F₀, . . . , F₁₂, . . . that describe HTTP request 302 are subgroups/submatrices of field vectors. As can be seen, each application message may be described by a number of submatrix/ices or subgroup(s) of field vectors from the field vector matrix F in which the field vectors f₁, f₂, . . . , fₖ may be shared between subgroups of field vectors.

As described above, the Skip-Gram Model of Mikolov is based on word vectors contributing to a prediction task regarding the next word in a sequence. This Skip-Gram Model has been modified to indirectly predict a vector representation of an application message by predicting missing field headings/data fields (e.g. key-value pairs) represented by field submatrices/subgroups of the application message (e.g. F₀, . . . , F₁₂, . . . are field submatrices/subgroups that describe the field headings and field data (e.g. key-value pairs) of HTTP request 302). As can be seen, a fixed number of selected field submatrices/subgroups describe the context of an application message (e.g. F₀, . . . , F₁₂, . . . are field subgroups of vectors describing the context of HTTP request 302). In addition to these selected field subgroups, a message vector also contributes to the prediction task.

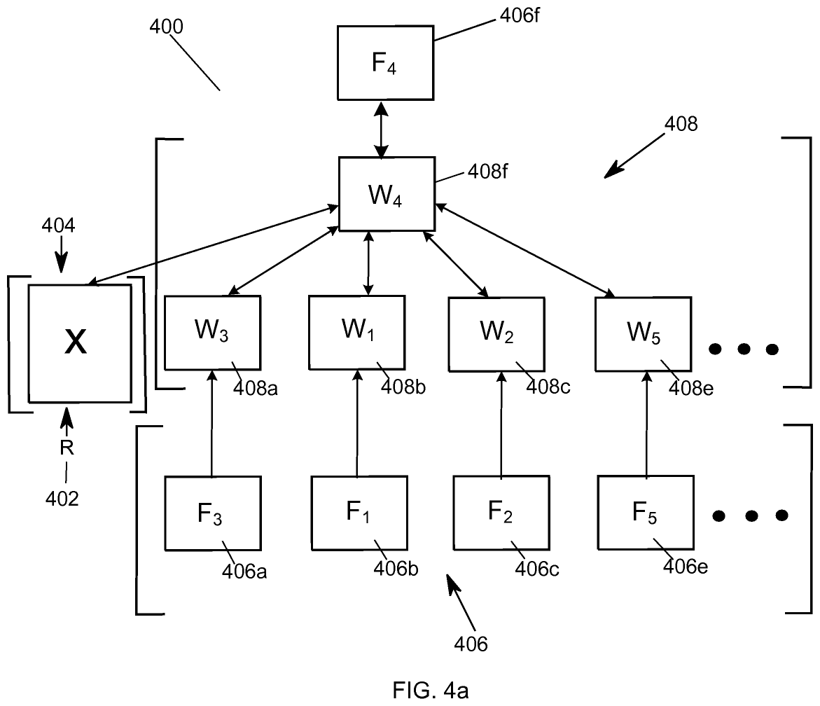

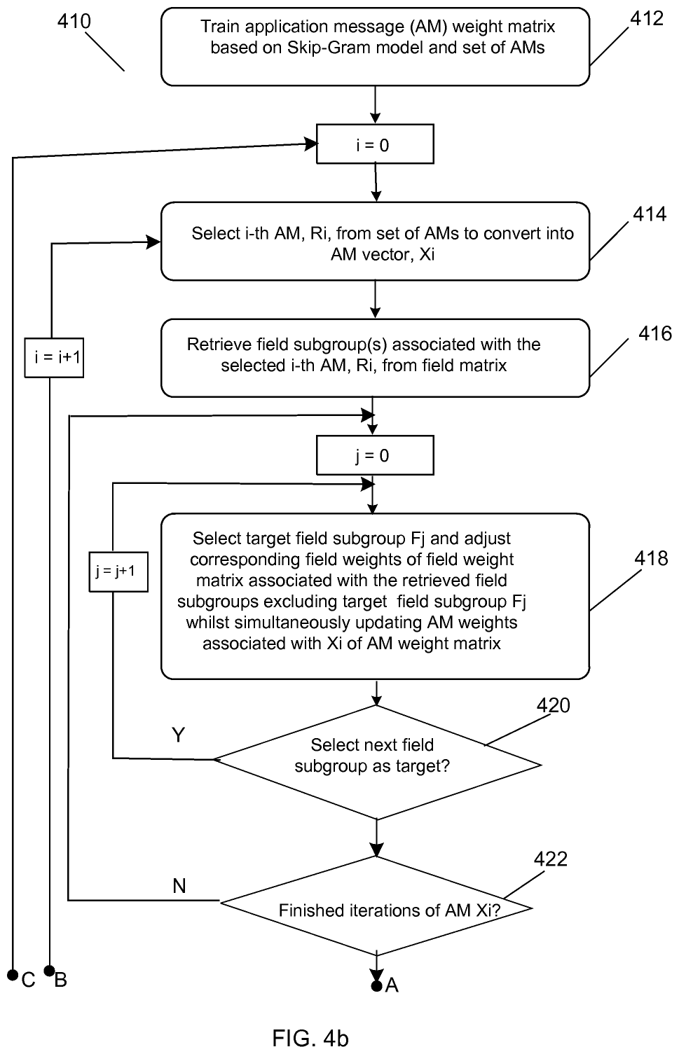

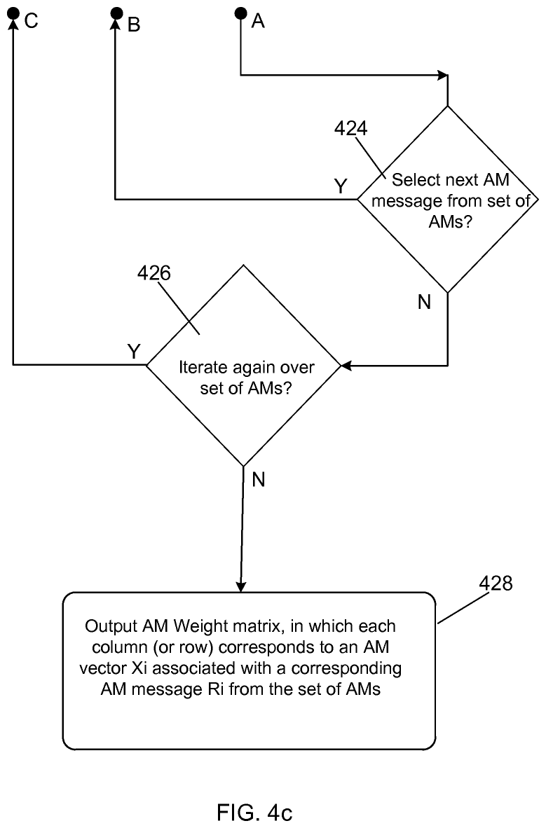

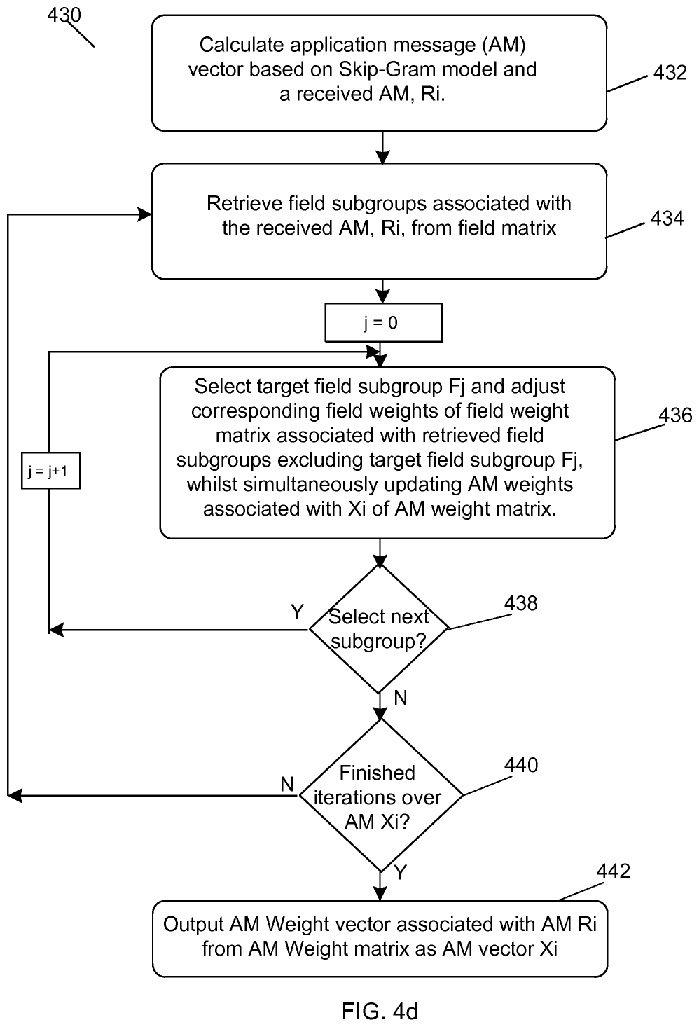

FIG. 4a is a schematic illustration of an example modified Skip-Gram model 400 according to the invention in which a set of application messages, R={Rᵢ}ᵢ₌₁^{Q}, 402 can be embedded as a set of application message vectors X={xᵢ}ᵢ₌₁^{Q}, for 1<=i<=Q, where Q is the number of application messages in the set of application messages, {Rᵢ}ᵢ₌₁^{Q}, 402. A field vector matrix F 406 includes field vectors f₁, f₂, . . . , fₖ that may be shared between subgroups of field vectors 406a-406f (or subgroups of field matrices) that represent each application message (e.g. F₀, . . . , F₁₂, . . . are subgroups of field vectors that described field headings and field data of HTTP request 302). Each field subgroup is also associated with a corresponding subgroup of weights 408a-408f that is maintained in a field weight matrix 408. The field subgroup(s) 406a-406f represent the context of an application message 402 and are used as inputs to a neural network associated with the Skip-Gram model 400 for adapting the corresponding subgroups of field weights 408a-408f. An application message weight matrix X[x₁, . . . , x_{Q}] 404 is also maintained and adapted over the neural network, where x₁, . . . , x_{Q}) may be column (or row) vectors of the N-dimensional vector space.

The aim is to adapt the application message weight matrix X[x₁, . . . , x_{Q}] 404 and the field weight matrix 408 until the neural network predicts the target field subgroup 406f of the application message when the remaining field subgroups 408a-408e are used as inputs to the neural network. This adaptation is repeated for the remaining field subgroups 408a-408e of the application message by selecting, one-by-one, one of the remaining field subgroups 408a-408e of the application message as the next target field subgroup 408e with the other field subgroups 408a-408d and 408f being used as inputs to the neural network. At the end of this process, the columns (or rows) of the application message weight matrix X 404 represent message vectors, xᵢ, each of which are associated with an application message 402. As can be seen, two weight matrices 408 and 404 are maintained for the prediction of the target field subgroup, namely a field weight matrix 408 and a message weight matrix 404. The field matrix 406 and field weight matrix 408 are shared across all application messages. However, each message weight vector of the message weight matrix X 404 is only shared for each context of the corresponding application message; it is not shared across different application messages.

For example, for each i-th application message (e.g. HTTP request 302) the message vector, xᵢ, associated with the application message is randomly initialised, and a target field subgroup (e.g. F₄) 406f (or target field) of the i-th application message is randomly selected from the field subgroups (e.g. F₁, F₂, F₃, F₄, F₅, . . . , F₁₂, . . . of HTTP request 302) representing the i-th application message. The remaining field subgroups 406a-406e of the i-th application message are selected as inputs to the neural network of the modified Skip-Gram model 400. The goal is to adapt the corresponding weight subgroups 408a-408f of the field weight matrix 408 and the corresponding message weights, xᵢ of the message weight matrix X[x₁, . . . , x_{Q}] 404 until the neural network converges to predict the target field subgroup 408f. The i-th column (or row) of the message weight matrix X 404 is output as the i-th message vector, xᵢ representing the application message as an embedding as a message vector in K dimensional vector space.

For example, for HTTP the HTTP request semantics are invariant to field subgroup ordering, which can be reflected in the output vector by randomising the ordering of the field subgroups when they are input to the neural network. Each HTTP request is mapped to a unique HTTP request vector, represented by a column in matrix X. Every field vector in each of the field subgroups 406a-406e is also mapped to a unique vector with corresponding weight vectors in weight subgroups 408a-408e. Each field vector in a field subgroup has a corresponding weight vector in a weight subgroup that is represented by a column (or row) in the field weight matrix W 408. The request vector and field weight vectors are concatenated to predict the next field, e.g. target field subgroup 408f, in a context.

FIGS. 4b and 4c are flow diagrams illustrating an example modified Skip-Gram process 410 for generating message vectors from a set of application messages {Rᵢ}ᵢ₌₁^{Q}, which may form one or more application message sequences, that can be used for training a neural network for predicting the next application message in a sequence of application messages during an application communication session between a user device 404a and a server node 406a. For example, the neural network as described in step 206 of method 200 or associated with neural network module 224 with reference to FIGS. 2a and 2b may be trained based sequences of message vectors corresponding to sequences of application messages in order to predict the next application message in an application message sequence given a current received application message during an application communication session.

The example modified Skip-Gram process 410 also trains a neural network that is used to predict a target field subgroup associated with an application message represented by one or more subgroup(s) of field vectors 406a-406f whilst indirectly determining an application message vector corresponding to the application message. The application message is represented by one or more subgroups of field vectors 406a-406f of a field matrix 406. The field matrix 406 is a vocabulary of field vectors such that each application message can be represented by one or more subgroups of field vectors, where the subgroups of field vectors between application messages are not necessarily the same. Each application message is embedded as an application message vector.

The neural network of the Skip-Gram model may be based on, by way of example only but is not limited to, a feed-forward neural network structure with one or more hidden layers (e.g. typically a feed-forward neural network has a single hidden layer, but more than one may be used) in which the corresponding weights of an application weight matrix 404 and a field weight matrix 408 are adjusted (e.g. trained) by a stochastic gradient descent method using backpropagation techniques. Although the stochastic gradient descent method using backpropagation is described, this is by way of example only, the skilled person would appreciate that there are other optimisation algorithms such as by way of example only but not limited to, stochastic gradient descent algorithm(s), Levenberg-Marquardt algorithm, Particle swarms, Simulated Annealing, Evolutionary algorithms, or any other suitable algorithm for training a feed-forward neural network or any combination, equivalents or variations of these.

Referring to FIG. 4b, the output of the process 410 is a set of application message vectors {xᵢ}ᵢ₌₁^{Q} associated with the set of application messages, R={R₁}ᵢ₌₁^{Q}. The application messages have been embedded as corresponding application message vectors in an N-dimensional vector space. The set of application message vectors X={xᵢ}ᵢ₌₁^{Q} can be used for training another neural network as described in FIGS. 2a and 2b in step 210 of method 200 or neural network module 224 of apparatus 220 that are configured to predict the next application message in a sequence of application messages received during an application communication session. The modified Skip-Gram process 410 is described with reference to FIG. 4a, by way of example only but is not limited to, the following steps:

In step 412 the application message weight matrix 404 and the field weight matrix 408 are trained based on the Skip-Gram model from a set of application messages or application message sequences associated with an application. It is assumed that the set of application messages or application message sequences are based on application messages that are representative of the normal behaviour or operation of the application during an application communication session between a user device and a server node. In this example, an application message counter (or time step) is initialised, e.g. i=0, and the process begins by training the neural network of the Skip-Gram model by adjusting a plurality of weights of the two weight matrices 404 and 408 associated with the i-th application message.

In step 414, the i-th application message that is to be embedded as the i-th application message vector, xᵢ, is selected from the set of application messages. It is assumed that the i-th application message can be represented by one or more subgroups of field vectors 406a-406f in which each field vector for each subgroup is taken from field matrix 406. This representation has been described, by way of example only but is not limited to, with reference to FIG. 3. It is assumed that each of the application messages in the set of application messages can be represented by one or more subgroups of field vectors, in which each field vector may be a unique one-hot vector. Although any orthogonal set of vectors may be used to describe the field vectors, this is typically more computationally more expensive than using one-hot vectors. A neural network can more efficiently and simply convert the sparse one-hot vector representations into dense representations, and hence output an informationally dense N-dimensional application message vector.

In step 416, the one or more subgroups of field vectors (e.g. F₁ to F₅ . . . as illustrated in FIG. 4a) representing the i-th selected application message are retrieved for input to the neural network of the modified Skip-Gram model 400. The number of field vector subgroups that are used to represent the i-th selected application message may be denoted as V. A field subgroup counter is initialised, e.g. j=0, which is used to select a target subgroup of field vectors.

In step 418, a j-th target field subgroup, F₁, from the number V of field subgroups representing the i-th selected application message is selected for 0<=j<=(V−1). The feedforward neural network is trained to predict the target field subgroup based on inputting all of the other field subgroups representing the i-th selected application message excluding the j-th target field subgroup. The neural network adjusts the corresponding field weights of the field weight matrix, W, and the corresponding application message weights, xᵢ, of the application weight matrix, X, using backpropagation. The field weights of the field weight matrix W that are adjusted are those associated with the field subgroups that represent the i-th selected application message excluding the j-th target field subgroup. As the j-th target field subgroup is not input or passed through the feed forward neural network, the weights associated with the j-th target field subgroup are not adjusted. However, all of the field weights of the field weight matrix W that are associated with the with the field subgroups representing the i-th selected application message (apart from the j-th field subgroup) are used to predict the j-th target field subgroup.

In step 420, it is determined whether all subgroups of field vectors representing the i-th selected application message have been used as a target field subgroup (e.g. is p(V−1)). If all subgroups of the field vectors representing the i-th application message have been selected as a target field subgroup, then there are no more field subgroups to iterate over and the process proceeds to step 422. However, if there are any remaining field subgroups representing the i-th selected application message that have not been selected as a target field subgroup, then the target field subgroup counter, j, is incremented (e.g. j=j+1) and the process proceeds to step 418 for selecting another target field subgroup, Fⱼ.

One or more of the following steps 422, 424 and 426 related to finishing or terminating the training of neural network and the associated field weight matrix 408 and application message weight matrix W 404 are optional. In step 422, it is determined whether the neural network requires any more iterations over the field groups for adjusting the field weights and application message weights associated with the i-th selected application message. If no more iterations are required, then the process proceeds to step 424, otherwise the target field subgroup counter is initialised (e.g. j=0) and the process proceeds to step 418 for further adjusting the corresponding field weights and application message weights of the field weight matrix, W, and the application weight matrix, X in relation to the i-th selected application message.

In step 424, it is determined whether the next application message in the set of application messages should be selected. If a next application message is to be selected from the set of application messages, R={Rᵢ}ᵢ₌₁^{Q}, then the application message counter, i, is incremented (e.g. i=i+1) and the process proceeds to step 414 for selecting the i-th application message. If no more application messages are to be selected from the set of application message, then the process proceeds to step 426.

In step 426, it is determined whether it is necessary to perform another iteration over the set of application messages in order to further adjust the field weights and application message weights associated with each application message in the set of application messages. If it is necessary to further adjust the field and application message weights, then the application message counter, i, is initialised (e.g. i=0) and the process proceeds to step 414 for selecting the i-th application message from the set of application messages. If it is not necessary to further adjust the field and application message weights associated with each application message in the set of application messages, then the process proceeds to step 428.

In step 428, the modified Skip-Gram model can output the columns (or rows) of application message weight matrix, X, in which each column (or row) corresponds to an application message vector, xᵢ, for 1<=i<=Q, where there are a number of Q application messages in the set of application messages {Rᵢ}ᵢ₌₁^{Q}. The application messages of the set of application messages {Rᵢ}ᵢ₌₁^{Q} have been embedded as a set of application message vectors, {xᵢ}ᵢ₌₁^{Q} in the form of application message weight matrix, X. The application message vectors, xᵢ, may be associated with a set of application message sequences, {(Rᵢ)ⱼ}ⱼ₌₁^{T} for 1<=i<=Lⱼ where T<=Q is the number of application message sequences in the set and Lⱼ is the length of the j-th application message sequence (Rᵢ)ⱼ that represents a “normal” application message sequence that is typically transmitted during an application communication session. The application message vectors, xᵢ, can be formed into a set of application message vector sequences {(xᵢ)ⱼ}ⱼ₌₁^{T} that corresponds to the set of application message sequences {(Rᵢ)ⱼ}ⱼ₌₁^{T}. The set of application message vector sequences {(xᵢ)ⱼ}ⱼ₌₁^{T} can be used as training data for training another neural network to predict the next application message in a sequence of application messages during an application communication session. For example, each j-th application message vector sequence (xᵢ)ⱼ of the set of application message vector sequences {(x₁)ⱼ}ⱼ₌₁^{T} may be input for training the neural network associated with step 206 and/or the neural network module 224 as described with reference to FIGS. 2a and 2b.

The example modified Skip-Gram model of FIGS. 4b and 4c has been described with reference to generating a training set of application message vectors (or sequence of application message vectors {(xᵢ)ⱼ}ⱼ₌₁^{T}) for input as training data to another neural network that is configured for predicting the next application message in a sequence of application messages during an application communication session. This modified Skip-Gram model may be further modified for when the intrusion detection system or apparatus 120 switches from a training mode to a real-time operation mode during a application communication session in which it then generates an embedding of a received application message as an application message vector. This received application message vector may be input to a neural network (which has been trained) for predicting the next application message expected to be received in the application communication session. This received application message vector can also be used to determine whether the received application message vector sequence relates to a normal application message sequence or an anomalous application message sequence.

One example of using the modified Skip-Gram model as described with reference to FIGS. 4b and 4c is that once trained, it then possible to infer an application message vector of a newly received application message by representing the received application message as one or more field vector subgroups of the field matrix F (e.g. converting or breaking down the input application message into its field vectors components/subgroups). The corresponding weights of the field weight matrix and softmax weights are fixed to their trained values and the field vector subgroups representing the received application message are passed forward through the neural network, which generates, as part of the final layer's output neurons, an application message vector corresponding to the N-dimensions of the application message space. The application message vector may be read from an output layer corresponding to the request vector output.

FIG. 4d is a further flow diagram illustrating another example modified Skip-Gram process 430 for generating or calculating the i-th application message vector from an i-th received application message that is received during an application communication session between, by way of example only, a user device 104a and a server node 106a. The i-th received application message is the current application message received in a sequence of application messages that are transmitted during the application communication session.

The resulting application message vector is used as input to an already trained neural network for predicting the next application message, i.e. the (i+1)-th application message, in the sequence of application messages that is expected to be received during the application communication session. Note, the (i+1)-th application message is assumed not to have been received yet, and may not have been generated for transmission because the i-th application message may require a response that will affect what data or fields will be required in the (i+1)-th application message. For example, the neural network as described in step 206 of method 200 or associated with neural network module 224 with reference to FIGS. 2a and 2b is used, once trained, to predict the next application message expected to be received in the application message sequence. The modified Skip-Gram process 430 is described with reference to FIGS. 4a and 4d, by way of example only but is not limited to, the following steps:

In step 432 the application message weight matrix 404, X, and the field weight matrix 408, W, are adjusted based on the Skip-Gram model in relation to the i-th received application message during the application communication session. The process begins by adjusting a plurality of field weights of the field weight matrix, W, 408 associated with the i-th received application message whilst also adjusting corresponding application message weights, xᵢ, of the application message weight matrix, X, 404. At the end of the process, the application message weights, xᵢ, are read out or output as the i-th application message vector, xᵢ, representing the i-th received application message. The i-th application message vector is an embedding of the i-th received application message in an N-dimensional vector space. It is assumed that the i-th received application message can be represented by one or more subgroups of field vectors 406a-406f in which each field vector for each subgroup is taken from field matrix 406. This representation has been described, by way of example only but is not limited to, with reference to FIG. 3. It is assumed that the i-th received application message can be represented as a function of one or more subgroups of field vectors 406a-406f in which each field vector for each subgroup is taken from field matrix 406. This representation has been described, by way of example only but is not limited to, with reference to FIG. 3. In essence, each i-th received application message can be represented by a function of one or more subgroups of field vectors, in which each field vector may be a unique one-hot vector. The function is represented by the corresponding field vector weights and activation functions of the hidden layer(s) of the neural network.

In step 434, the one or more subgroups of field vectors (e.g. F₁ to F₅ . . . as illustrated in FIG. 4a) representing the i-th received application message are retrieved for input to the neural network of the modified Skip-Gram model 400. The number of field vector subgroups that are used to represent the i-th received application message may be denoted as V. A field subgroup counter is initialised, e.g. j=0, which is used to select a target subgroup of field vectors.

In step 436, a j-th target field subgroup, Fⱼ, from the number V of field subgroups representing the i-th received application message is selected for 0<=j<=(V−1). The feedforward neural network of the modified Skip-Gram model is trained to predict the j-th target field subgroup based on inputting the all of the other field subgroups representing the i-th received application message excluding the j-th target field subgroup. The neural network adjusts the corresponding field weights of the field weight matrix, W, and the corresponding application message weights, xᵢ, using backpropagation techniques. The field weights of the field weight matrix W that are adjusted are those associated with the field subgroups that represent the i-th received application message.

In step 438, it is determined whether all subgroups of field vectors representing the i-th received application message have been used as a target field subgroup (e.g. is p(V−1)). If all subgroups of the field vectors representing the i-th received application message have been selected as a target field subgroup, then there are no more field subgroups to iterate over and the process proceeds to step 440. However, if there are any remaining field subgroups representing the i-th received application message that have not been selected as a target field subgroup, then the target field subgroup counter, j, is incremented (e.g. j=j+1) and the process proceeds to step 436 for selecting another target field subgroup, Fⱼ.

In step 440, it is determined whether the neural network requires any more iterations for adjusting the field weights and application message weights associated with the i-th received application message. That is, does the neural network require any more iterations over the field subgroups representing the i-th received application message? If no more iterations are required, then the process proceeds to step 442, otherwise the target field subgroup counter is initialised (e.g. j=0) and the process proceeds to step 434 for further adjusting the corresponding field weights and application message weights of the field weight matrix, W, and the application weight matrix, X in relation to the i-th received application message.

In step 442, the modified Skip-Gram model when operating in “real-time” mode or operating on newly received application messages outputs the column (or row) of the application message weight matrix, X, associated with the i-th received application message. That is an i-th application message vector, xᵢ, associated with the i-th received application message is output from the application weight matrix, X. The i-th application message vector, xᵢ, that is output is associated with the sequence of received application message vectors (xₖ)ₖ₌₁ⁱ for 1<=k<=j that have been received so far in the application communication session between, by way of example only but it is not limited to, user device 104a and server node 106a. The i-th received application message is embedded as application message vector, xᵢ.

Thus, the i-th application message vector is input data for the neural network responsible for predicting the next application message in a sequence of application messages during an application communication session. For example, the i-th received application message vector, xᵢ, may be input to the neural network associated with step 206 and/or the neural network module 224 as described with reference to FIGS. 2a and 2b for predicting the next application message to be expected to be received in the sequence of application messages during the application communication session.

FIG. 3 describes an example of encoding an application message using a vocabulary of vectors in a K-dimensional vector space represented by a field vector matrix F[f₁, f₂, . . . , f_{K}] comprising field vectors f₁, f₂, . . . , fₖ. FIGS. 4a-4d described further example apparatus and method(s) 400, 410, 430 in which an application message represented by subgroups of field vectors can be embedded as an application message vector in an N-dimensional vector space. The application message vector representing the information content of the application message and which is used as input to a neural network for predicting the next application message in a sequence of application messages during an application communication session. This method of converting the received application message to a current message vector in an N-dimensional vector space assumes that lossless coding is employed.

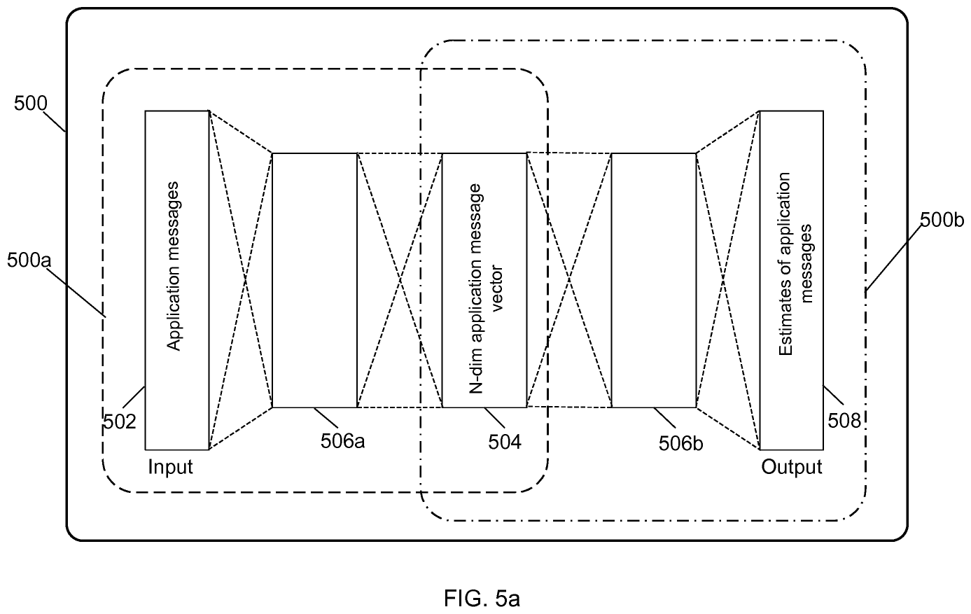

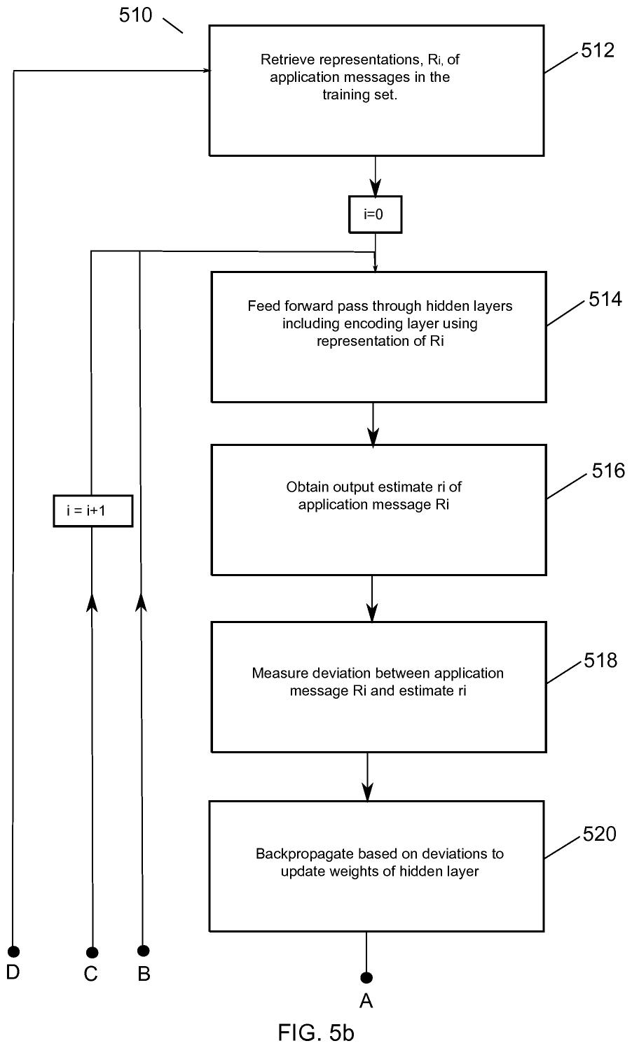

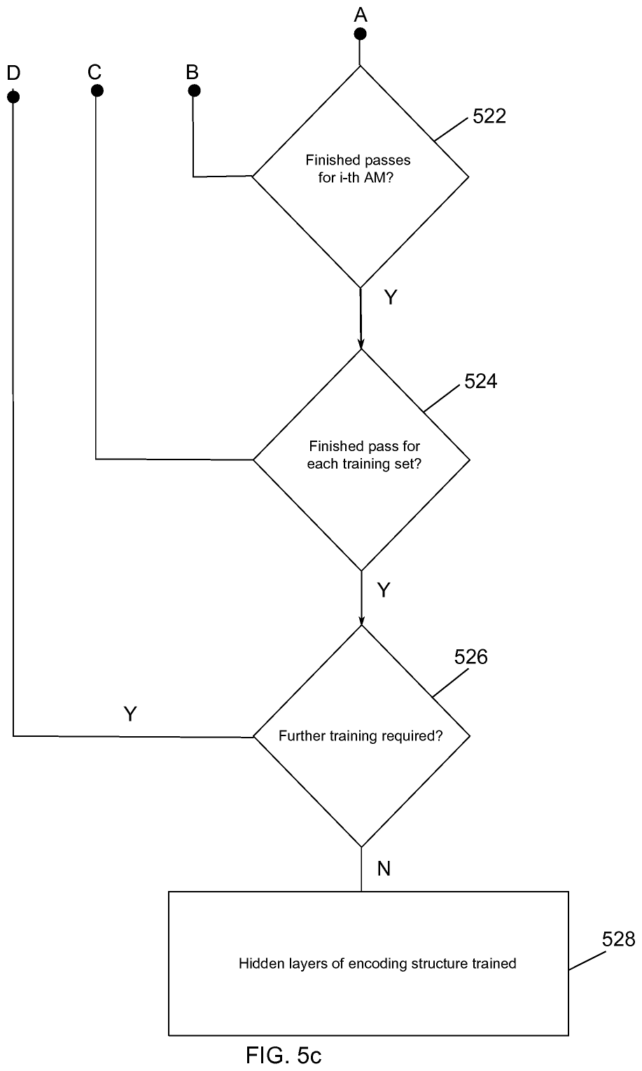

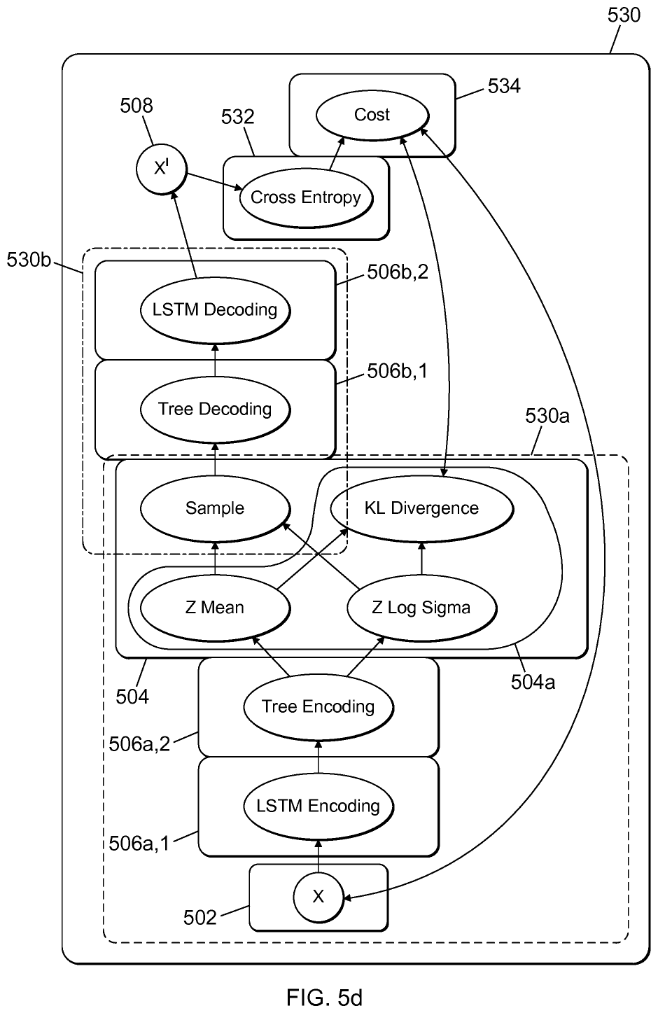

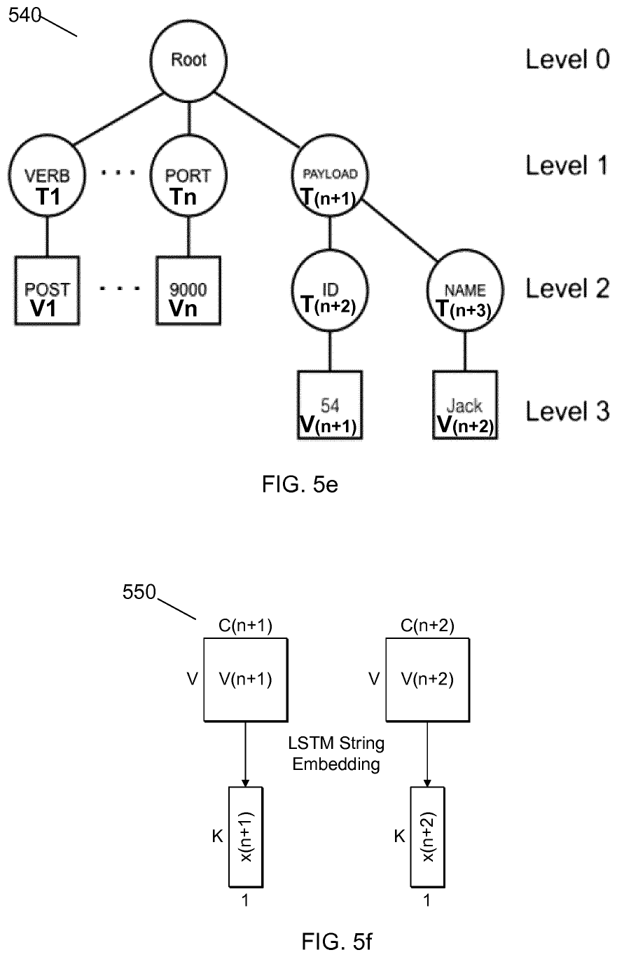

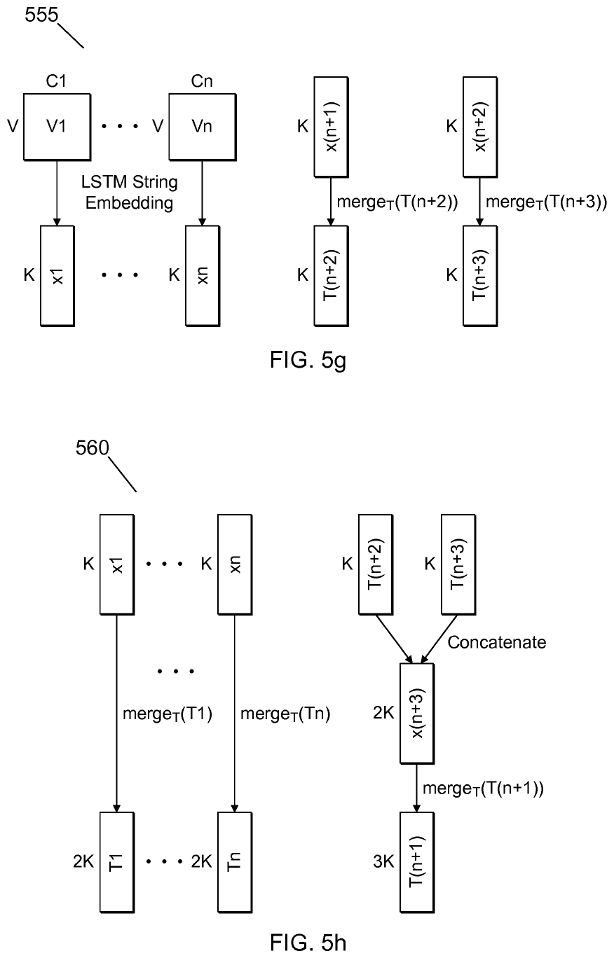

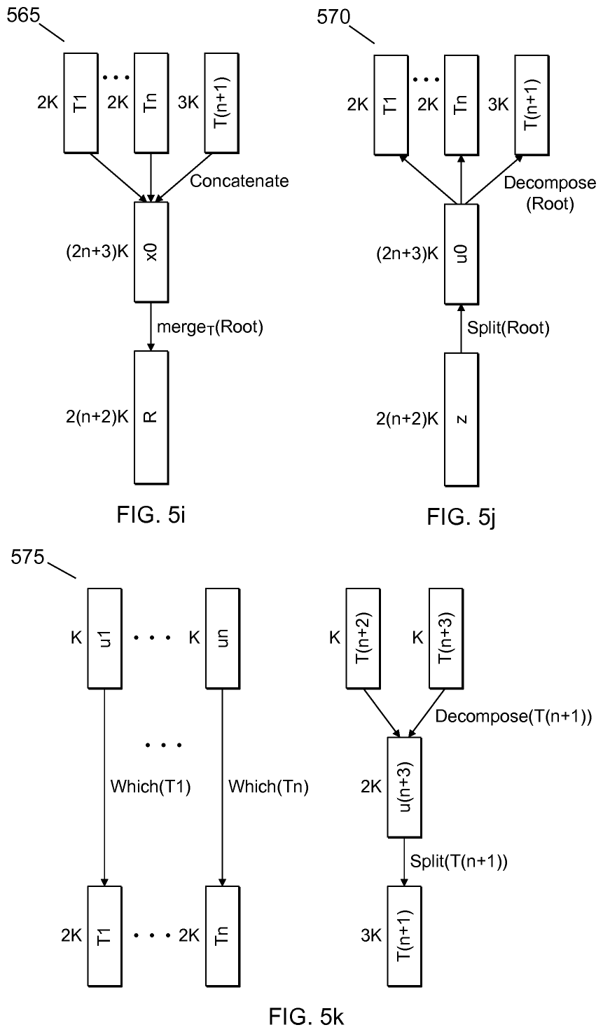

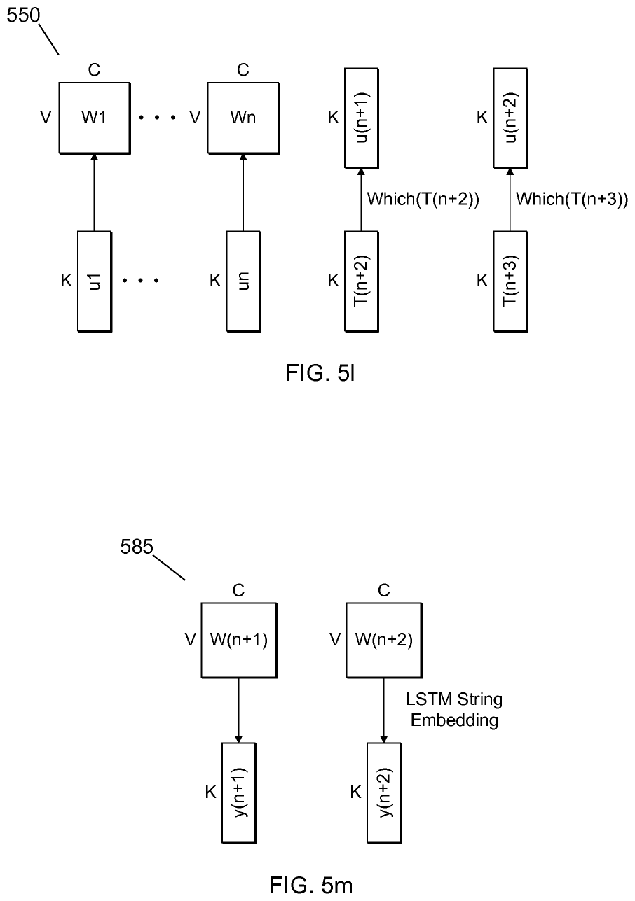

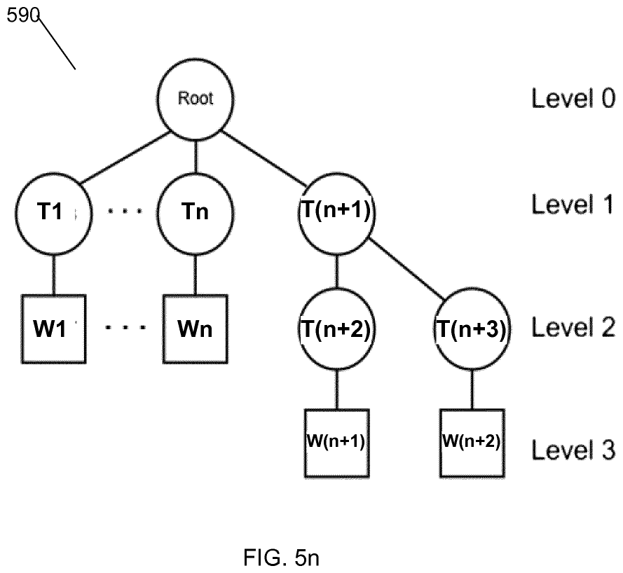

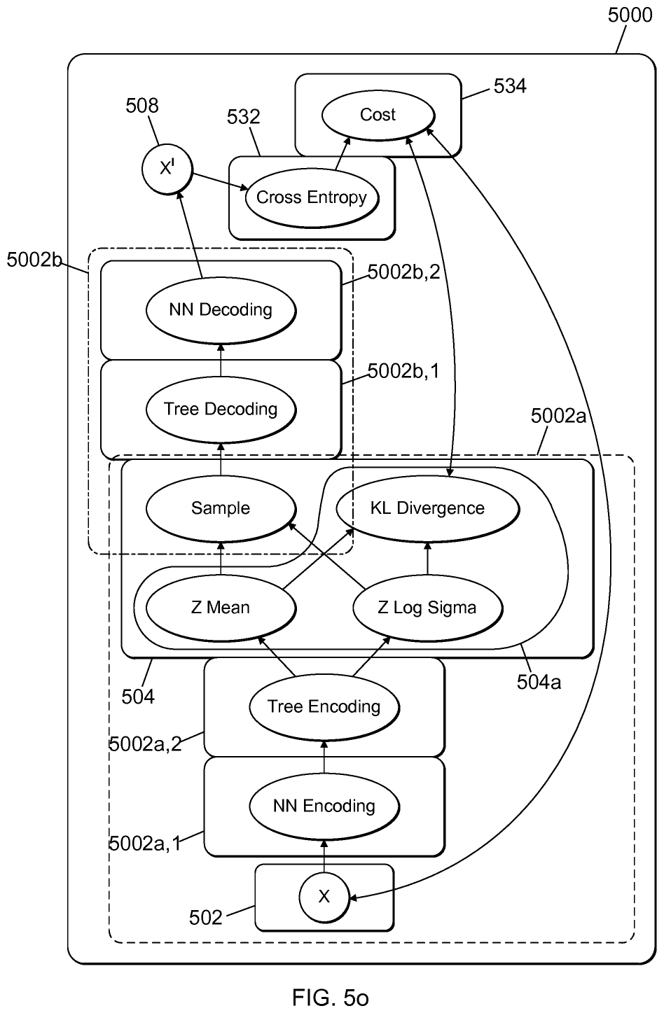

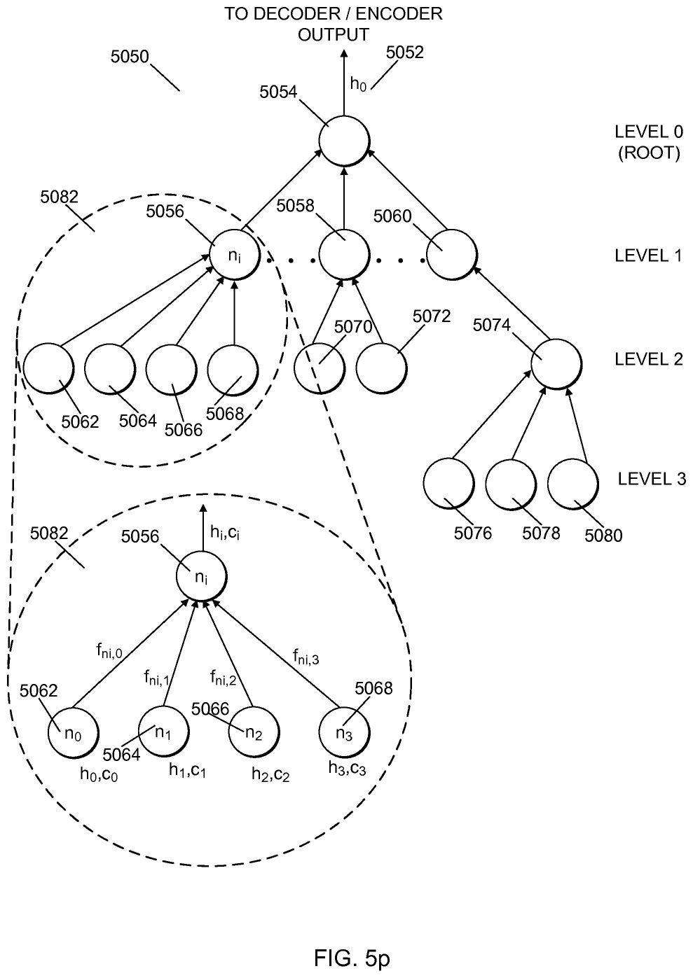

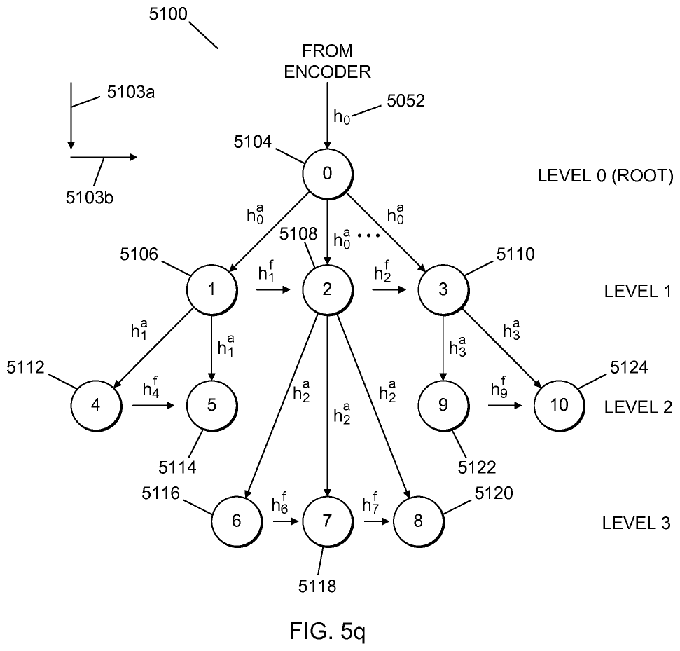

FIG. 5a is a schematic diagram illustrating a variational autoencoder neural network (VAE) structure 500 for converting application message(s) into application message vector(s) of an N-dimensional vector space. In this example, the VAE 500 comprises an encoding neural network structure 500a and a decoding neural network structure 500b. The encoding neural network structure 500a (or encoding structure 500a) includes an input layer 502 connected to one or more hidden layers 506a that are connected to an encoding layer 504. The input layer 502 for receives data representative of an application message. The decoding neural network structure 500b (or decoding structure 500b) includes encoding layer 504 connected to one or more further hidden layers 506b that are connected to an decoding output layer 508. The neural network structure of the hidden layers 506a and 506b of the VAE 500 may include, by way of example only but is not limited to, a Long Short Term Memory (LSTM) neural network structure for encoding data representing the application message received at the input layer 502 into a form suitable for the VAE 500 to further process and output a dense embedding of the application message as an application message vector. The VAE 500 has been found to produce a continuous and dense embedding of application messages as application message vectors (e.g. embedding an HTTP web request and/or response as an HTTP application message vector).

In the encoding structure 500a, the input layer 502 includes a plurality of nodes that receive a representation of one or more application message(s) 502, which when passed through the one or more hidden layers 506a of the encoding structure 500a outputs an encoded result in encoding layer 504. Essentially, the encoder structure 500a can be configured, via training weights of the hidden layer(s) 506a and 506b, to take a representation of the application message and map this representation to an N-dimensional application message vector at the encoding layer 504. There are many ways of representing an application message for input to the input layer 502. For example, as described with reference to FIGS. 3 to 4c the application message may be represented as one or more subgroups of field vectors in a K-dimensional vector space as described with reference to FIG. 3. In another example, the application message may be represented by a tree graph based on a predetermined tree archetype or schema derived from an existing training set of application messages. Each application message in the training set of application messages may be represented by a parse tree, thus a set of parse trees is formed. The tree archetype or schema may be determined by merging the parse trees in the set of parse trees to form a tree graph archetype. The hidden layer(s) 506a and encoding layer 504 of the encoder structure 500a process the input representation of the application message and maps it or embeds it as an application message vector (e.g. also known as code, latent variables, latent representation/vector) in an N-dimensional vector space (e.g. a latent space), which is output by encoder layer 504.

The decoding neural network structure 500b (or decoder structure 500b) uses the output of the encoding layer 504 as an input, where the encoding layer 502 includes a plurality of N nodes each representing one of the N values of the application message vector in the N-dimensional vector space. This application message vector is passed through the one or more further hidden layer(s) 506b of the decoding structure 500b to output an estimate of the representation of the original application message in the decoding output layer 508. For example, when the application message is represented as one or more subgroups of field vectors in a K-dimensional vector space as described with reference to FIG. 3, then the decoding structure 500b essentially maps the application message vector in N-dimensional vector space (output from the encoding layer 502) to an estimate of the application message represented by field vectors in the K-dimensional vector space. The further hidden layer(s) 506b of the decoder structure 500b process the N-dimensional application message vector and maps it to an estimate of the original application message represented as field vectors. In another example, when the application message is represented as a tree graph, then the decoding structure 500b essentially maps the application message vector in N-dimensional vector space (output from the encoding layer 502) to an estimate of the application message represented as a tree graph.

In order for the VAE 500 to perform the encoding/decoding and/or mapping/embedding operations required to embed application messages as application message vectors requires training of the hidden layer(s) 506a and 506b of the VAE neural network structure. The hidden layer(s) 506a and 506b are trained on a training set of application messages that are assumed to be normal and represent the normal communication messages sent during an application communication session of an application. For example, for HTTP based web applications, the HTTP DATASET CSIC 2010, provided by the Spanish National Research Council (CSIC), may be used as a training set of application messages because it contains thousands of HTTP web requests including 36,000 normal web requests and 25,000 anomalous web requests that may be used for testing web application firewalls. The 36,000 normal web requests may be processed into a training set of application messages representing normal web requests. Other ways of generating datasets of application messages or training datasets of application messages representing the communications of an application may be to intercept application messages transmitted and/or received by the application and store them. For example, an HTTP request dataset may be generated using web security tools such as, by way of example only but not limited to, ModSecurity®, which can listen or intercept HTTP requests aimed at or generated by a web application and can output and store these to a log file. The set of training application messages may be used by the VAE 500 to learn an encoding such that application messages may be encoded/embedded by the encoder structure 500a as application message vectors in an N-dimensional vector space.

Although a training set of application messages for an application layer protocol is described, by way of example only but is not limited to, HTTP DATASET CSIC 2010 for HTTP, it is to be appreciated by the skilled person that a training set of application messages may also include application messages generated by an application that communicates using the application layer protocol in which these application messages represent normal or nominal communications between a user device and server node, and may depend on one or more variables or constraints such as, by way of example only but is not limited to, the type of application or web application, the application layer protocol used by the application, how the application is programmed to operate, generate application messages and communicate during an application communication session, and any other suitable variations or combinations thereof.

A representation of each of these application messages may be input to the encoder structure 500a for training the VAE 500. The representation of each application message in the training set of application messages may be based on various tokenisation and/or parameterisation techniques. For example, as described in FIG. 3, each application message may be converted to and represented by one or more subgroups of vectors in a K-dimensional vector space, in which each of the vectors is a unique one-hot vector. In another example, each application message may be converted to and represented by a parse tree derived from an predetermined archetype tree graph or schema. Training the VAE 500 requires the use of both the encoding and decoding structures 500a and 500b. Once trained, only the encoding structure 500a of the VAE 500 is used in which received application messages, which may be normal or anomalous, are fed into the input layer 502 for processing by the hidden layer 506a and the encoding layer 504 outputs corresponding application message vectors in the N-dimensional vector space representing the application message that is input. The informational content of the application message is represented by the values of the elements of the application message vector. The N-dimensional application message vector for each application message can be used as input to a neural network that is configured to be trained to predict the next application message that is expected to be received during an application communication session.

FIG. 5b is a flow diagram illustrating an example process 510 for training the VAE 500, where once trained, the encoder structure 500a is used to encode application messages as application message vectors in an N-dimensional vector space. The example process 510 for training the VAE 500 is based on, by way of example only but not limited to, the following steps:

In step 512, the training set of application messages is retrieved and converted into a suitable format or representation for input into the VAE 500 (e.g. field vector subgroups or parse tree graph/tree graph structure). The application message counter is initialised (e.g. i=0). In step 514, a feedforward pass through the VAE 500 including the encoder structure 500a and decoder structure 500b is performed using a representation of the i-th application message from the training set of application messages. The i-th application message is applied to the input layer 502 of the VAE 500. In step 514, the feedforward pass is used to compute activation functions (e.g. arctan or other suitable activation functions) of nodes of the hidden layer(s) of 506a and 506b. The encoding layer 504 contains the result of the feedforward pass of hidden layer(s) 506a and the decoding layer 508 contains the result of the feedforward pass of the hidden layer(s) of 506a and 506b and represents an estimate of the input representation of the i-th application message.

In step 516, an estimate of the i-th application message is output from output decoding layer 508, the representation of the estimated i-th application message may be the same as that of the i-th application message that is applied to the input layer 502. In step 518, the deviation between the i-th application message applied to the input layer 502 and the estimated i-th application message output from the output decoding layer 508 is measured. This deviation may be based on a cost or loss function such as, by way of example only but not limited to, a cross entropy function, a similarity function, Euclidean distance function (e.g. square of Euclidean distance), cosine function etc., or other suitable functions for quantifying the deviation or loss between input and output that may be used to optimise the weights of the hidden layer(s) 506a and 506b and variations and/or combinations thereof. Typically, two loss functions are used such as, by way of example only but not limited to, the Kullback-Leibler (KL) divergence between the output and a normal distribution and the expected negative-log likelihood of the i-th data point, and the cost or loss function may be represented by:

− [symbol] ᵥₐₑ(θ,ϕ; x⁽ⁱ⁾)= [symbol] q_{ϕ}(z|x)[p_{θ}(x⁽ⁱ⁾|z)]−D_{KL}(q_{ϕ}(z|x⁽ⁱ⁾)∥p_{θ}(z)).

where q_{ϕ}(z¦x) is the output distribution of z given x, and p_{θ}(x) is the normal distribution between 0 and 1, D_{KL}(·) is the Kullback-Leibler divergence function and [symbol] _{q}_{_{ϕ}}_{(z¦x)}[·] is the expected negative-log likelihood.

In step 520, the measured deviation is used in a backpropagation algorithm for updating weights and/or parameters associated with nodes of the hidden layers 506a and 506b and/or encoding layer 504. This calculates the deviation or error contribution each node or neuron in the hidden layers 506a and 506b after each application message from the training set of application messages or a batch of application messages from the training set are processed by the VAE 500. The error contribution may be used in adjusting weights associated with the hidden layers 506a and 506b and/or any parameters of the encoding layer 504. For example, the weight of each node or neuron may be adjusted based on a gradient descent optimisation algorithm. The backpropagation algorithm may be used with gradient-based optimisers such as, by way of example only but not limited to, stochastic gradient descent, Limited-memory Broyden-Fletcher-Goldfarb-Shanno (BFGS) or variations thereof, congugate gradient, quasi-Newton methods or variations thereof that approximate BFGS algorithms, truncated Newton methods or Hessian-free optimisation and/or variations thereof, or combinations of such algorithms and variations thereof.

One or more of steps 522, 524 and 526 may be optional, these are described by way of example only, and it is to be appreciated by the skilled person that any suitable stopping criteria may be used for determining when training for each application message and/or set of application messages can be terminated. In step 522, it is determined whether the number of passes through the VAE for the i-th application message has been enough. For example, the number of passes may be considered to be enough once the cost function is minimised or reached a convergent state. If further passes through the VAE 500, e.g. feedforward and backpropagation passes, are determined to be needed (e.g. ‘N’ or No), then the process proceeds to step 514 for further adjustment of the weights and/or parameters of the hidden layer(s) etc., otherwise the training pass associated with the i-th application message may be determined to be finished (e.g. ‘Y’ or yes) and the process proceeds to step 524. In step 524, it is determined whether all application messages in the training set have been used to train the VAE 500, if there are any remaining application messages in the training set that are to be used to train the VAE 500 (e.g. ‘N’ or no), then the process increments the application message counter (e.g. i=i+1) and proceeds to step 514 for selecting the i-th application message (e.g. the next application message) from the training set. If all the application messages in the training set have been used in training the VAE 500 (e.g. ‘Y’ or yes), then the process proceeds to step 526. In step 526, which may be optional, it is determined whether further training based on the training set (or another training set of application messages) is required. If further training of the VAE 500 is required (e.g. Y), then the process proceeds to step 512 for retrieving the required training set of application messages. If further training of the VAE 500 is not required (e.g. ‘N’ or no), then the process proceeds to step 528.

Once at step 528, it is assumed that the VAE 500 and in particular the hidden layers 506a and other parameters associated with the encoding structure 500a have been suitably trained and adapted to reliably encode application messages into N-dimensional application message vectors that are output from the encoding layer 504. Thus, the encoding structure 500a of the VAE 500 is used as a generative model for feeding representations of application messages (e.g. normal and/or anomalous application messages) and returning the corresponding application message vector representations in N-dimensional vector space.

Thus, once the VAE 500 has been trained on a training set of application messages, the encoder structure 500a may then be switched to a “using” or “real-time” mode and used, by way of example only but not limited to, by conversion module 222 of the intrusion detection mechanism 220 or in method step 204 of method 200 for generating an embedding for the i-th application message received during an application communication session. The i-th received application message is embedded as an N-dimensional i-th application message vector. The resulting N-dimensional i-th application message vector that is output may be associated with a sequence of received application message vectors corresponding to a sequence of application messages that have been received so far in the application communication session between, by way of example only but it is not limited to, user device 104a and server node 106a.

Thus, training a VAE 500 on a training set of application messages allows the encoder structure 500a to output the i-th application message vector corresponding to the i-th application message for input to a neural network responsible for predicting the next application message in a sequence of application messages during the application communication session. For example, the i-th received application message vector may be input to the neural network associated with step 206 and/or the neural network module 224 as described with reference to FIGS. 2a and 2b for predicting the next application message that is expected to be received in the sequence of application messages received during the application communication session.

FIG. 5d is a schematic illustration of another example VAE 530 for embedding application messages as low dimensional informationally dense application message vectors in an N-dimensional vector space in which the application messages are represented as parse trees or tree graphs. Common reference numerals from FIG. 5a are used for simplicity to indicate similar features. The VAE 530 includes an encoding structure 530a and a decoding structure 530b. Each application message is input to an input layer 502 as a parse tree or tree graph X. The encoding structure 530a includes several hidden layers 506a,1 and 506a,2 and encoding layer 504, which process the tree graph X into an application message vector in an N-dimensional latent or vector space based on an estimated intermediate N-dimensional normal distribution. The N-dimensional vector is output from the encoding layer 504. The decoding layer 530b takes the N-dimensional application message vector from the encoding layer 504 and uses several further hidden layers 506b,1 and 506b,2 to estimate a tree graph X′, which is a reconstruction of the original tree graph X. The estimated tree graph X′ is passed through a cross-entropy and cost functions 534 and 536, which are used to determine how well the VAE 530 reconstructed the input tree graph X and how well the intermediate latent space distribution or N-dimensional normal distribution fits the normal distribution using KL divergence. These values are used to optimised the weights of the neural networks used in the hidden layers 506a,1, 506a,2, 506b,1, and 506b,2 and encoding layer 504 using back propagation techniques.

Typically, encoding requests by representing each as a sequence of characters relies on the assumption that collocated characters or symbols have a logical dependency. However, application messages based on high level application protocols tend to have structure that may be represented as a tree graph or has a tree structure. For example, for HTTP the HTTP application messages such as, by way of example only but not limited to, POST/GET HTTP requests often contain tree structured payloads that can dwarf other components of the request. The highest quality embeddings will arise from exploiting this tree structure. In addition, the VAE 530 is configured to learn a normally distributed representation of the application messages, which provides the advantage of guaranteeing that the latent or vector space that is learnt is well formed. In addition, the VAE 530 enables natively encoding the tree structure of application messages in which the number of encoding steps scales with the depth of the tree graph rather than the number of fields vectors and field vector subgroups as used in the previously described modified Skip-Gram model.

For example, when the VAE 500 is configured to use field vector subgroups to represent an application message (e.g. an HTTP requests), the application message may be treated as an exceptionally long sequential sentence (e.g. for HTTP requests this may typically be ˜1000 tokens long). That is the application message is modelled as a sequential sentence, or a sequential model is used to encode the application message. Encoding such sequential sentences involves encoding the tokens (words) and implicitly their ordering. To store this sequential information, the encoder 500a attempts to learn the conditional probabilities over sequences of tokens or words. For example, in the sentence “The fox jumps over the fence”, the encoder attributes that the probability of the word “jumps” appearing immediately after “fox” is high. In short, semantic dependence is inferred from linear proximity.

However, most application messages such as, by way of example only but not limited to, HTTP requests are not sequential sentences. For example, in HTTP the above dependency assumption is only weakly correct for two reasons 1) fields in HTTP requests are commutative, and have no natural ordering; and 2) HTTP requests often contain payloads of data (which can comprise most of the informational content of a request) in hierarchical formats such as JavaScript Object Notation (JSON) and Extensible Markup Language (XML). An example JSON payload may be, by way of example only but is not limited to, {Id: {“token”: 54}, User: {“name”: Jack, “age”: 24}}. In this sequential (textual) representation of the JSON payload, the number 54 is close to the key User. If the abovementioned sequential model based on field vector subgroups were used to encode an application message, then there is a risk that the encoder 500a is taught to recognise that 54 and the key User are related. But, in actuality, the number 54 is more related to the key “token” than to the key User. This relationship can be easily seen by viewing the JSON as a tree (in the above diagram).

The VAE 530 employs an architecture that is designed to exploit latent tree structures in the input data (e.g. application messages). For example, for the above-mentioned HTTP request with JSON payload, the HTTP request is broken down in a hierarchical fashion, with each token represented both as its internal value, and its position in a tree-graph. Therefore values at different ends of the HTTP request can be placed on the same information level of the tree graph, and given the same importance in structure. Thus, when encoding the request, we firstly transform the request into a type-tree structure.

In order to convert an application message into a type-tree structure based on a tree graph or parse tree, a predetermined tree archetype or schema is derived from an existing training set of application messages. For example, for HTTP the training set of application messages may be based on HTTP DATASET CSIC 2010. Each application message in the training set of application messages may be represented as a type-tree structure such as parse tree, thus a set of tree graphs is formed. Each node in the tree graph may be terminal (i.e. have no children) or nonterminal (e.g. have a fixed number of children).

For example, for HTTP the specific drawing of a tree graph and definition of non-terminal types determines the tree structure. Several techniques may be employed for HTTP such as punctuation parsing and field parsing. For example, for the string “1+2”, punctuation parsing may result in a tree graph in which the entire string is the root or parent node, with three children of “1”, “+” and “2”. Punctuation parsing separates the string depending on the punctuation, which in this case consists of white spaces. When using field parsing on the string “1+2”, it may be identified that “+” is important because it is an assignment symbol, thus a tree graph may be derived that is separated into one root or parent node “+”, with two children “/” and “2”.

Thus, both techniques may be used in a hierarchical fashion by firstly identifying field parsing within the string for “strong symbols” such as “:” which assign key value pairs to split the single string in multiple smaller tokens. These tokens may then be broken into smaller tokens using other symbols or characters such as “?, +, −, & . . . ”, before applying punctuation parsing to remaining tokens. Using a combination of these techniques a rich type-tree representation for HTTP requests may be formed and used to generate tree graphs for HTTP messages.

The following example describes another method of constructing a tree-graph (as a JSON object) from an HTTP request. HTTP requests can be represented as key/value pairs. Keys may represent certain reserved parts or keywords of a request, including, by way of example only but not limited to, the Verbs such as GET, POST, PUT, DELETE; the Host e.g. http://google.com or the Port e.g. 9000 and the like. An example GET HTTP request may be, for illustrative purposes only, by way of example only but is not limited to, based the following text:

VERB: GET
HOST: http://google.com
USER-AGENT: Mozilla/5
Session-ID: 12l23n43qed0c9
...
PORT: 9000,
PAYLOAD: {...<JSON payload>}

The GET HTTP request has keys VERB, HOST, USER-AGENT, Session-ID, PORT, etc. and the majority of the corresponding values for these keys (e.g. VERB, HOST, PORT, . . . ) are typically terminal, which means that their values are either strings of characters or numerical values. For example, VERB has a string value “GET”, HOST has a string value “http://google.com”, USER-AGENT has a string value “Mozilla/5”, Session-ID has a string value “12123n43qed0c9” and PORT has a numerical value 9000 . . . ) In certain cases keys may correspond to non-terminal values, which are themselves one or more keys (e.g. PAYLOAD has value {<JSON payload>}, which may comprise one or more JSON and/or XML keys). These keys may or may not be terminal. This means that it is possible for HTTP requests to represent data that has arbitrary depth.

For example, for an HTTP request a key that has a non-terminal value may be the payload of a POST HTTP request (or other HTTP request). This non-terminal value is typically either transmitted in JSON or XML format, each of which encodes the payload data in a tree-like structure. In the above example, the GET HTTP request the key PAYLOAD has a value { . . . <JSON payload>}, which is a non-terminal value.

In order to efficiently embed an application message such as an HTTP request into an application message vector, these non-terminal values should be represented in a tree-like graph structure. This means that not only should this payload be represented by a tree graph structure, but that the whole HTTP request should be converted into the format of tree graph structure. The following example uses HTTP and JSON for simplicity and by way of example only, but it is to be appreciated by the skilled person in the art that in practice any suitable high level application protocol and any suitable tree-structured format or schema may be used to represent application messages as tree graph structures.

To convert an HTTP request into a JSON tree graph structure, an empty root node is first constructed that is a non terminal type. In JSON, this is may be represented as:
{ }

For every reserved key (or reserved word or keyword) in an HTTP request, a key with the corresponding value is added to the JSON root node. Non-reserved keys of an HTTP request must also be added, by extracting both header pairs, and parameter pairs from the query string. If the corresponding value is non-terminal, then another empty JSON node is added in that place.

For example, in the above HTTP GET request the JSON tree graph structure may take the form:

{

VERB : “GET”,
HOST: “http://google.com”,
...
PORT: 9000,
...
PAYLOAD: {...<JSON payload>}

}

For a non-terminal value (e.g. PAYLOAD has non-terminal value {< . . . JSON payload>}), the same operation as for the JSON root node is performed. That is, all the internal keys of the JSON payload are added to another empty JSON node within the JSON root node structure, in which each value for each of the internal keys being defined as either terminal or non-terminal. This is then repeated for each of the non-terminal nodes. For example, for the above HTTP GET request the JSON payload may be for illustrative purposes only, by way of example only but is not limited to, the following:

{

VALUE1: 5,
VALUE2: {VALUE1: “string...”}

}

The PAYLOAD key with non-terminal value may be converted into a JSON tree graph structure with in the JSON root node based on, by way of example only but not limited to:

PAYLOAD:

{

VALUE1: 5,
VALUE2:

{

VALUE1: “string...”

}

}

For example, a final JSON tree graph structure representing the above HTTP GET request may be illustrated as, by way of example only but is not limited to, the following JSON tree graph object of:

{

VERB : “GET”,
HOST: “http://google.com”,
USER-AGENT: “Mozilla/5”
Session-ID: “12l23n43qed0c9”
...
PORT: 9000,
PAYLOAD:
{

VALUE1: 5,
VALUE2:
{

VALUE1: “blah”

}

}

}

In practice, there is no guarantee that every application message (e.g. HTTP request) for a single web application will have the same structure, so a predetermined tree archetype (or schema) can be constructed from existing training examples of application messages that have each been converted or transformed into a tree graph structure. The schema or archetype can be computed by merging the set of tree graphs/parse trees of all known application messages (e.g. HTTP requests and/or responses). The set of tree graphs/parse trees are merged to form a tree graph with a single root node, from this merging a tree archetype or schema may be determined that defines how an application message may be converted to a tree graph structure.

For example, in the above described HTTP GET request and JSON schema/tree graph structure may need to be transformed into a global JSON schema because it is possible that running the above JSON tree graph algorithm on all HTTP requests in a training set will result in JSON tree graph objects that share no structure between them. Thus, a JSON schema or archetype is required in order to allow the construction of a robust vector representation for all such JSON objects. This is performed by normalising the structure of the JSON objects, which may be performed, by way of example only and not limited to, in a recursive fashion by the following example steps of: creating an empty JSON archetype node; adding all keys in the root nodes of all JSON objects into a set; for each key in this set, add a new key into the archetype node; for each non-terminal key in the above set, enumerate all keys within the non-terminal value of every JSON object that contains that key; and the above method is recursed on each non-terminal node.

Although HTTP, JSON tree graphs and JSON schema have been described, this is by way of example only and the invention is not limited to only using HTTP, JSON graphs or JSON schema, it is to be appreciated by the skilled person that other suitable high-level application protocols and other tree graph structures may be used for deriving appropriate schemas for representing application messages as tree graph structures and the like.

Referring back to FIG. 5d, once a tree archetype or schema is defined for applications messages based on a high level application protocol, application messages may be converted or transformed into a tree graph X and input to VAE 530 via the input layer 502 as tree graph X. The VAE 530 is trained and optimised by using, for each application message in a training set of application messages, multiple passes through the VAE 530 in which each pass uses backpropagation techniques to update the weights and/or parameters associated with the hidden layers of the VAE 530. Once the VAE 530 has been trained, the weights and parameters associated with the hidden layers of the encoding structure 530a are fixed and application messages represented as tree graphs may be passed through the encoding structure 530a to output corresponding N-dimensional application message vector.

In a single pass through the VAE 530, an application message represented as a tree graph X is input to the input layer 502 of the encoding structure 530a, which encodes the tree graph X into an N-dimensional application message vector. Encoding the tree graph X is performed from the bottom-up. A first hidden layer 506a,1, operates on the leaves (i.e. nodes without children) of the tree graph X, in which the leaves are transformed into a tensor (e.g. via a lookup table) and then passed through a neural network into a latent or vector space. Thus the textual information of the leaves are embedded into vectors of the latent or vector space. For example, the tree graph X of the application message may be passed through a first hidden layer 506a,1 that comprises a LSTM recurrent neural network that embeds the textual or sentence data of the leaf nodes of the non-terminal nodes of the tree graph X as dense vectors of unified size. This produces a rich embedding of the strings as a vector in a new dense space of constant dimensionality.

As described, the tree graph X with dense vectors is then passed through a second hidden layer 506a,2 that uses a tree encoding technique for encoding the tree graph X with dense vectors into a rich embedding of a higher dimensional vector using embedding via a neural network, merge function(s) and concatenation function(s). Each merge function comprises a simple feed forward hidden layer such as, by way of example only but not limited to, a feed forward neural network based on the McCulloch and Pitts model (e.g. y=f(Σⱼ₌₁ⁿ(wⱼxⱼ+b)), where f(·) is an activation function, b is a bias value, xⱼ are the inputs, and wⱼ are corresponding weights). This encodes the tree into a Euclidean vector. As the tree graph X is encoded from the bottom-up, the dimensionality of the latent or vector space is increased for each node. In this way, the dimensionality of the latent or vector space acts as a further degree to encode the tree graph X within, which may reduce the information encoded into the neural network weights whilst speeding up optimisation. The non-terminal nodes of the tree graph X may be of multiple types, and describe the relation between children nodes. As the encoding process moves up the tree graph X, tensors of the same parent nodes are concatenated together and merged/transformed through a neural network (e.g. a feedforward neural network conditioned on the parents' type) into a new richer/tensor, which is transformed into an ever growing latent or vector space. Each tree graph has a final root node and the encoding of the entire tree is held within the corresponding final tensor and its transformation in the latent or vector space.

The final tensor is passed to the encoding layer 504 which includes another hidden layer 504a comprising another feed forward hidden layer or feed forward neural network that is configured to calculate a vector of means (e.g. Z Mean) and a vector of log variances (e.g. Z Log Sigma) associated with the final tensor for representing a multidimensional normal distribution such as, by way of example only, an N-dimensional normal distribution. The estimated mean and log variance vectors are used to compute the Kullback-Leibler (KL) divergence between the N-dimensional normal distribution associated with the final tensor and a normal distribution. The KL divergence may be represented by:

$${D}_{K L} ( p ( x ) \vert \vert q ( x ) ) = {\sum }_{x ∈ X} p ( x ) ln \frac{p ( x )}{q ( x )} ,$$

where p(x) and q(x) are two discrete distributions of a single hidden variable. If the distributions are continuous, this may be reformulated as:

$${D}_{K L} ( p ( x ) \vert \vert q ( x ) ) = {\int }_{- ∞}^{∞} p ( x ) ln \frac{p ( x )}{q ( x )} dx .$$

Furthermore, a sample vector is calculated based on the N-dimensional normal distribution and the sample (e.g. Sample) can be output from the encoding layer 504 as an embedding of the application message as an N-dimensional application message vector in an N-dimensional latent space.

The encoding layer 504 acts as an input to the decoding structure 530b such that the N-dimensional application message vector is passed through a first decoding hidden layer 506b,1 that for decoding the N-dimensional application message vector as a tree graph X′. Decoding a tree graph from the N-dimensional latent space is performed from using a top down approach starting from the root node. The root node is split using a splitting neural network that performs a split function and decomposing the result to output one or more non-terminal nodes of different types and/or one or more terminal nodes. As the decoding process moves down the tree graph tensors of the same parent nodes are split/transformed via a splitting feed forward hidden layer (or feed forward neural network) and decomposed into one or more terminal or non-terminal nodes. Once all terminal nodes are reached, the resulting tree graph X′ is passed through a second decoding hidden layer 506b,2 that includes a LSTM neural network that processes the non-terminal nodes of the tree graph X′ into strings for to produce a tree graph which is a reconstruction of tree graph x′. This may be output to an output layer 508.

The VAE 530 is then optimised using backpropagation techniques by passing the estimated tree graph X′ through cross-entropy function 534, which is used to determine how well the VAE 530 reconstructs the input tree graph X. The cross entropy function may be represented, by way of example only but is not limited to:

$${v}^{( t )} = {arg max}_{u} \frac{1}{N} {\sum }_{i = 1}^{N} H ( {X}_{i} ) \frac{f ( {X}_{i} ; u )}{f ( {X}_{i} ; {v}^{( t - 1 )} )} log f ( {X}_{i} ; {v}^{( t - 1 )} ) ,$$

where v^{(t)} is the parameter vector and xᵢ for 1<=i<=N are generated samples. The cross entropy is solved for xᵢ. The cross entropy of the original tree graph X and the reconstructed tree graph X′ is estimated and input to the cost function 534. In addition, the KL divergence that is calculated in hidden layer 506a,3 is input to the cost function 534. The KL divergence is used to determine how well the intermediate latent space distribution or N-dimensional normal distribution fits the normal distribution. Thus, the cross-entropy and KL divergence are used to generate a cost function 536. For example, the cost function may have the form, by way of example only but is not limited to:

[symbol]

(ϕ,θ; x)= [symbol] _{z˜q}_{_{ϕ}}_{(z|x)}[log(p_{θ}(x|z))]− [symbol] _{KL}(q_{ϕ}(z|x)∥p_{θ}(z))

which is minimised for optimising the weights of the neural networks used in the hidden layers 506a,1, 506a,2, 506a,3, 506b,1, and 506b,2, which are adjusted using back propagation techniques passed through cross entropy and cost functions.

As described above, second hidden layer 506a,2 uses a tree encoding technique for encoding the tree graph X with dense vectors into a rich embedding of a higher dimensional vector using embedding via a neural network, merge function(s) and concatenation function(s). The tree graph X has nodes that are terminal (has no children) or are non-terminal (have a fixed number of children). Each terminal node has a terminal type, and the root node has a specific root type. Each tree graph X has a set of types {T}, and also a variable defining which types are associated with terminal nodes, and which types are associated with non-terminal nodes. A recursive function is used to encode a tree graph X into the latent space. The recursive function Encode(n) is called on the root node and the pseudo code for Encode(n) is defined as:

Encode(n)

Base case:
If the node (n) is a terminal type, return Embedding(n)
Induction:
If the node (n) is a non-terminal type T:

For every child gᵢ:

Encode(gᵢ);

Return Merge_{T} ( g₁ ,g₂ , g₃,...,gᵢ)

The function Embedding(n) is defined as:

Embedding(n):Returns a vector R^{K},

This is performed by a lookup of the contained value within a table. The function Merge_{T} is a feedforward neural network that is defined as:

Merge_{T}:=f(W[x₁ . . . xₘ]+b)=[y₁ . . . yₙ],

where m is defined by the number of children nodes, b is a bias vector, n is specified by the Type, xᵢ for 1<=i<=m are concatenated vectors, and yⱼ for 1<=j<=n are embedded vectors. The weights, W, used in the neural network are dependent on the type T, i.e. the neural network is conditioned on the type T. Gating and linear normalisation may also be implemented.

As described above, further hidden layer 506b,1 uses a tree decoding technique for decoding an N-dimensional application message vector from the latent space into a tree graph X′ using splitting via a neural network, and decomposition functions(s) to result in a tree graph X′. A top down approach is used for decoding starting at the root node. The N-dimensional application message vector from the latent space may be denoted z, which is already known to be a special type “ROOT” (e.g. T_{Root}). Thus a GenerateNode( ) function is called on the root node and the pseudo code for GenerateNode( ) is defined as:

We start with a value z from the latent space. We already know that this is a special type ‘ROOT’. We call

GenerateNode(T_{Root},z)

Base Case:

If z is a terminal node of type T, return WhichVal_{T}(z)

Induction Case:

If z is a non-terminal node of type T:

Split(z) = [g₁ ... gₘ]
For each child node, gᵢ

Sample Tᵢ-WhichChild_{T}(gᵢ) (WhichChild,

generates a probability distribution)

GenerateNode(Tᵢ, z).

The function Split is a feedforward neural network that is defined as:

Split:=f(W[x₁ . . . xₘ]+b)=[y₁ . . . yₙ],

where m is defined by the Type T, and n is the number of children nodes, b is a bias vector, the weights, W, used in the neural network are dependent on the type T i.e. the neural network is conditioned on type T.

The functions WhichVal/WhichChild are defined as:

WhichVal/WhichChild:=Softmax(f(W[x₁ . . . xₘ]+b))=Softmax([y₁ . . . y_{d}])

where WhichChild computes a probability distribution over d choices (specified by the node Type T). Essentially, WhichVal/WhichChild are the same functions in this instance, in which they convert a high dimensional continuous distribution into a multinomial distribution over Y, where Y is the children for the above node.

Various modifications may be made to the neural networks defined above. For example, gating may be used. Candidate values for yᵢ using the linear layers as defined above followed by calculation of multiplicative gates for each yᵢ and each (xᵢ, yᵢ) combination, or (m+1)n gate variables (recall m is in the number of inputs and n is the number of outputs).

$$[ {y}_{1} … {y}_{n} ] = f ( W [ {x}_{1} … {x}_{m} ] + b ) \\ [ {g}_{y 1} … {g}_{y n} ] = σ ( {W}_{gy} [ {x}_{1} … {x}_{m} ] + {b}_{y} ) \\ [ {g}_{( x 1 , y 1 )} … {g}_{( x 1 , y n )} ] = σ ( {W}_{g 1} [ {x}_{1} … {x}_{m} ] + {b}_{g 1} )$$

$$⋮ \\ [ {g}_{( xm , y1 ) } … {g}_{( xm , y n )} ] = σ ( {W}_{gm} [ {x}_{1} … {x}_{m} ] + {b}_{gm} )$$

The final outputs yᵢ may be computed by:

yᵢ=g_{yi}⊙yᵢ+g_{(x1,yi)}¦x₁+ . . . +g_{(xm,yi)}¦xₘ

where σ is the sigmond function σ(x)=1/(1+e^{-x}) and ⊙ is elementwise product

Another modification may be to use layer normalisation to stabilize the learning process. It is difficult to use batch normalisation because of the connections of each layer (the functions Merge, Split, Which) occur at variable points according the particular tree graph X that is being considered. Instead, instance of f(W[x₁ . . . xₘ]+b) may be replaced with f(LN(W₁x₁; α₁)+ . . . +LN ((Wₘxₘ; αₘ)+b) where Wᵢ are horizontal slices of W and αᵢ are learned constants, where LN(z; α)=α(z−μ)/σ.

As described above, to encode and decode arbitrary tree graphs X within an application, a set of permissible types is compiled for each node that will be seen. As the structure of each application message (e.g. application message requests) is likely to differ within a single application, the tree schema (or archetype) is computed and encompasses every application message request that will be seen by the application or during an application communication session. This can be performed by computing the union of all application message requests (in tree format) based on a training set of application messages, and recording the possible types in each node.

FIG. 5e is a schematic illustration of an example tree graph 540 derived from an HTTP request, which for illustrative purposes is represented as, by way of example only but is not limited to, the following POST HTTP text:

VERB: POST
...
PORT: 9000
PAYLOAD: {ID:54, NAME:“Jack”}

The POST HTTP request has keys VERB, . . . , PORT, and PAYLOAD in which the majority of the corresponding values for these keys are typically terminal, which means that their values are either strings of characters or numerical values. For example, VERB has a string value “POST”, PORT has a numerical value 9000. The PAYLOAD key is a non-terminal node that includes further keys ID and NAME, which are terminal having values 54 and “Jack”, respectively. As previously described, the above-mentioned HTTP request may be converted to a JSON tree graph structure that may be represented as:

{

VERB: “POST”,
...
PORT:9000,
PAYLOAD:

{ ID: 54,

NAME: “Jack″

}

}

In FIG. 5e, the tree graph 540 is illustrated in which the keys are represented by non-terminal type nodes and will be computed to be represented as types T1 . . . Tn, T(n+1), T(n+2), and T(n+3), which are vectors. In this example, the key VERB will be computed to be represented by type T1 vector, the key PORT will be computed to be represented by type Tn vector, the key PAYLOAD will be computed to be represented by type T(n+1) vector, the key ID will be computed to be represented by type T(n+2) vector and the key NAME will be computed to be represented by type T(n+3) vector. The leaves V1, . . . Vn, V(n+1) and V(n+2) are matrices that represent the strings of text or numerical values and are terminal nodes. In this example, string “POST” is represented by leaf matrix V1, the string or numerical value “9000” is represented by leaf matrix Vn, the string or numerical value “54” is represented by leaf matrix V(n+1) and the string “Jack” is represented by leaf matrix V(n+2). Type nodes have a preassigned number of children. The structure of the tree graph 540 will be encoded as a tensor using a bottom up approach, which starts by searching for terminal nodes at the lowest level, which in this case is level 3.

In the first iteration of the encoding process, only terminal nodes that have Terminal Types are expected. FIG. 5f illustrates the LSTM string embedding 550 of terminal nodes in level 3 of tree graph 540 into dense vectors of a latent space. Firstly, the strings of text are represented by V1, . . . , Vn, V(n+1) and V(n+2), which are matrices of size V×Cq, for 1<=q<=(n+2), where V is the vocabulary size (however many characters are in the alphabet) and Cq for 1<=q<=(n+2) is the length of the string or character count or the number of characters in each corresponding string represented by V1, . . . , Vn, V(n+1) and V(n+2). For example, in these matrices the first column corresponds to the first character of a string associated with that matrix, which may be a one hot encoding such that every dimension in a column vector is either 1 or 0, depending on whether that row character is the character represented by the column. Each column only has one 1 and the remaining elements are zeros. Thus, V is the dimensionality of these one hot vectors and Cq is the number of vectors required to represent a string represented by Vq. As seen in FIGS. 5e and 5f, starting from the lowest layer (e.g. level 3) of tree graph 540, there are only two terminal type nodes V(n+1) and V(n+2). V(n+1) is represented by a matrix of size V×C(n+1) and V(n+2) is represented by a matrix of size V×C(n+2). Thus, V(n+1) and V(n+2) are embedded by passing them through an LSTM neural network, (passing them through hidden layer 506a,1 of FIG. 5d). This produces a rich embedding of the strings V(n+1) and V(n+2) as vectors x(1+1) and x(n+2) in a new dense space of constant dimensionality K.

FIG. 5g illustrates an example of node embedding and merging 555 as the encoding process moves to level 2 of tree graph 540. Referring to FIG. 5e and FIG. 5g, in level 2 of tree graph 540, the strings represented by matrices V1 to Vn is processed by an LSTM neural network in a similar manner as for V(n+1) and V(n+2) during the level 3 processing. Thus, the string matrices V1 though to Vn are embedded as vectors x1 through to xn in a new dense space of constant dimensionality K. For non-terminal nodes of type T(n+2) and T(n+3), their corresponding children (e.g. x(n+1) and x(n+2)) are passed through a Merge_{T} function (e.g. a feedforward neural network) to provide a new representation computed as T(n+2) and T(n+3) vectors of dimensionality K. The Merge_{T} function is type dependent. As each type has a predefined number of children, the corresponding Merge_{T} function has a specific number of arguments.

For example, the Merge_{T} function is specified as: f(W[x1 . . . xm]+b)=[y1 . . . yn], where we have taken xi and yi to be column vectors R^{K}, [x1 . . . xm] stacks the vectors xi vertically, W∈R^{n.k×m.k} and b∈R^{n.k} are the learned weight matrix and bias vector respectively, and f is a nonlinearity or activation function applied elementwise, and n will be specified by the Type.

Referring to FIGS. 5h and 5e, the encoding process moves to level 1 of tree graph 540 for a type vector computation 560 for non-terminal nodes, in which T1 through to Tn vectors are computed. Firstly, the two K dimensional vectors of T(n+2) and T(n+3) are concatenated to form a vector x(n+3) of dimension 2K. Then, for our example, we assume Type1 through to Typen (e.g. T1 . . . Tn) have some significance, thus the Merge_{T} function when performed on vector x1 and defined to output a vector T1 of dimension 2K, similarly, the Merge_{T} function when performed on vector xn and defined to output a vector Tn of dimension 2K. Although each of T1 . . . Tn are illustrated, by way of example only, to have a dimensionality of 2K, it is to be appreciated by the skilled person that each of T1 . . . Tn may have different or the same dimensionality depending on the their importance or what is considered their importance. Equally Type(n+1) (e.g. T(n+1)) is considered to be an important field, so this Merge_{T} function when applied to vector x(n+3) is specified to output a vector T(n+1) of dimension 3K. The person skilled in the art will appreciate that the choice of dimensionality of the outputs may be a hyperparameter that can be fine tuned empirically.

Referring to FIGS. 5i and 5e, the encoding process moves to level 0 of tree graph 540 for root computation 565 in which the vectors T1 . . . Tn and T(n+1) are concatenated to form a vector x0 of dimensionality (2n+3)K where a final Merge_{T} function is performed on vector x0 defining the root vector R that is specified to be of dimension 2(n+2)K that provides a particularly rich embedding of the tree graph 540. This final 2(n+2)K root vector R is the encoding of the tree graph 540.

As in hidden layer 504a, the tree encoding root vector R is then passed through another neural network (e.g. an simple feed forward layer), which calculates a vector of means and logarithmic variances. These are used as variables within a multidimensional normal distribution, from which a sample, z, is taken. This subsequent vector is of the same dimensionality as the root vector R, and is defined to be an N-dimensional vector, which in this case means that N=2(n+2)K. Once VAE 530 is trained, the sample z would be the application message vector.

A first iteration of the decoding process is illustrated in FIG. 5j showing a root split and decomposition computation 570 in which the sample z is input to the decoding process (e.g. hidden layer 506b,1). Given that vector z has a type of root, the Split_{T} function is applied to provide vector u0 of dimensionality (2n+3)K (e.g. Split_{T} (z)=u0). The Split_{T} function may be defined by Split_{T} ([x1 . . . xm]): f(W[x1 . . . xm]+b)=[y1 . . . yn], where we have taken xi and yi to be column vectors R^{k}, [x1 . . . xm] stacks the vectors xi vertically, W∈R^{n.k×m.k} and b∈R^{n.k} are the learned weight matrix and bias vector respectively, and f is nonlinearity or activation function applied elementwise, n will be specified by the Type.

Note: The structure of the Split_{T} and Merge_{T} functions are almost identical, the difference being the weights matrix, W, associated. It is possible to make these matrices square in which they become the Transposition of each other, which significantly reduces the number of training variables. Bias vectors, b, will still need to separate though.

The vector u0 is decomposed using a decomposition map defined by the previous Type of the vector into vectors T1 . . . Tn and T(n+1) of dimensionality 2K and 3K, respectively.

FIG. 5k illustrates a further decomposition 575 of the next layer/level of an estimate for tree graph 540, the vector T1 of Type1 has a single Terminal node child u1 of dimensionality K. Thus, the function Which is called and generates terminal child u1 for this node. The Which function is of a similar structure to the Split_{T} function. The Which function is Which (x1): f(W[x1] +b)=[y1 . . . yd], in which a softmax is placed over the function to create a probability distribution that can be sampled to produce u1. The Which function is also called for vectors T2 . . . Tn to generate terminal children u2 . . . un of dimensionality K. The vector T(n+1) of Type(n+1) is further Split into a vector u(n+3) of dimensionality 2K and then further decomposed into two vectors of type T(n+2) and T(n+3) of dimensionality K.

FIG. 5I illustrates the decoding process for leave node and further terminal computation 580 for the next layer/level in which the newly formed Terminal type vectors u1 . . . un are transformed back into a String matrices W1 . . . Wn by passing each vector u1 . . . un backwards through the LSTM layer. The vectors T(n+2) and T(n+3) of Type(n+2) and Type(n+3), respectively, are passed through the Which function to generate Terminal node childs u(n+1) and u(n+2) of dimensionality K. FIG. 5m illustrates another leave node computation 585 that transforms the vectors u(n+1) and u(n+2) back into strings W(n+1) and W(n+2) by also passing these vectors backwards through the LSTM layer. The final decoded tree graph 590, which is an estimate of original tree graph 540, is illustrated in FIG. 5n. The original tree graph 540 and estimated tree graph 590 may then be used to calculate the cross entropy, and along with the KL parameter, are used to generate a cost function that may be used to optimise the VAE 530 using backpropagation techniques. The encoding and decoding processes along with weight updates for each hidden layer based on back propagation techniques is performed on a training set of application messages in which a corresponding set of tree graphs are required. Once trained, the encoding structure 530a of the VAE 530 is used to generate N-dimensional application message vectors from tree graphs of the corresponding application messages.

FIG. 5o is a schematic illustration of a further example VAE 5000 for embedding application messages as informationally dense application message vectors in an N-dimensional vector space in which the application messages are represented as parse trees or tree graphs. The VAE 5000 is based on the structure of VAE 530 of FIG. 5d, but has been modified to further improve the generation of N-dimensional application message vectors from tree graphs of the corresponding application messages. The VAE 5000 may provide the advantages of providing a lower dimensional application message vector that includes the same information content as VAE 530, improved information content of application messages, and/or an improved vector representation of application messages. Common reference numerals from FIGS. 5a to 5d are used for simplicity to indicate similar or the same features. The VAE 5000 includes an encoding structure 5002a and a decoding structure 5002b.

As described for VAE 530, each application message is input to an input layer 502 as a parse tree or tree graph X. The encoding structure 5002a includes several hidden layers 5002a,1 and 5002a,2 and encoding layer 504, which processes the tree graph X into an application message vector in an N-dimensional latent or vector space based on an estimated intermediate N-dimensional normal distribution. The N-dimensional vector representation of the application message is output from the encoding layer 504. The decoding layer 5002b takes the N-dimensional application message vector from the encoding layer 504 and uses several further hidden layers 5002b,1 and 5002b,2 to estimate a tree graph X′, which is a reconstruction of the original tree graph X. The estimated tree graph X′ is passed through a cross-entropy and cost functions 532 and 534, which are used to determine how well the VAE 5000 reconstructs the input tree graph X and how well the intermediate latent space distribution or N-dimensional normal distribution fits the normal distribution using, by way of example only but is not limited to, KL divergence. These values are used to optimised the weights of the neural networks used in the hidden layers 5002a,1, 5002a,2, 5002b,1, and 5002b,2 and encoding layer 504 using back propagation techniques.

The encoding structure 5002a and decoding structure 5002b are trained by reconstructing the input of the data representing an application message. The data representing the application message may be originally transformed or parsed as described, by way of example only but not limited to, with reference to FIGS. 5a-5n into a tree-graph structure before being fed into the neural networks of the VAE 5000. Once trained, the encoding structure 5002a of the VAE 5000 is used to encode the tree graph representing the application message into a low dimensional application message vector of an N-dimensional vector space or latent space, which is output as an N-dimensional vector from the encoding layer 504.

As described for VAE 530, application messages are converted or transformed into a tree graph X and input to VAE 5000 via the input layer 502 as tree graph X. The VAE 5000 is trained and optimised by using, for each application message in a training set of application messages, multiple passes through the VAE 5000 in which each pass uses backpropagation techniques to update the weights and/or parameters associated with the hidden layers of the VAE 5000. Once the VAE 5000 has been trained, the weights and parameters associated with the hidden layers of the encoding structure 5002a are fixed and application messages represented as tree graphs may be passed through the encoding structure 5002a to output a corresponding N-dimensional application message vector, which may be represented as a low dimensional informationally dense vector of the application message.

FIG. 5p is a schematic illustration of an example tree graph X 5050 associated with the application message. The tree graph X includes a plurality of nodes 5054-5080 and a plurality of edges, where each edge connects one of the parent nodes or non-terminal nodes 5054, 5056 to 5060 and 5074 to one of the child nodes or terminal nodes/leaf nodes 5062-5068, 5070, 5072, and 5076-5080). Each of the terminal and non-terminal nodes 5054-5080 represents a portion of the information content associated with the application message. Encoding the tree graph X 5050 of the application message is performed, as illustrated by the direction of the arrows on the edges of the tree graph X 550, using a bottom-up approach from the bottommost level of the tree graph X 5050, or the Q-th level of nodes for Q>0, where Q is the number of levels below the root node or 0-th level, up to the root node (or 0-th level node) of the tree graph X using one or more hidden layers of a neural network. The neural network structure may include a plurality of cells that are arranged such that, by way of example only but is not limited to, at least one cell of the neural network represents a corresponding node of the tree graph X 5050. For example, each cell of the neural network structure may correspond to a node of the tree graph X 5050. In this example, the tree graph X 5050 has Q+1 levels of nodes (e.g. Level 0, Level 1, Level 2, and Level 3, where Q=3). The tree graph X 5050 may be processed by first and second hidden layers 5002a,1 and 5002a,2 and encoding layer 504 of FIG. 5o using a bottom up approach to generate an N-dimensional application message vector 5052, which is represented in FIG. 5p as an N-dimensional vector h₀.

In this example, the tree graph X includes a plurality of nodes 5054-5080 and a plurality of edges, where each edge connects one of the parent nodes or non-terminal nodes 5054, 5056 to 5060 and 5074 to one of the child nodes or terminal nodes/leaf nodes 5062-5068, 5070, 5072, and 5076-5080). Each of the terminal and non-terminal nodes 5054-5080 represents a portion of the information content associated with the application message. The tree graph X may also contain or encode the application message in a lossless manner.

As an example, an application message may include, by way of example only but is not limited to, a hierarchy of one or more keys, associated keys, one or more strings and/or key values or other data that may be represented in the form of a tree graph X in which each of the parent or child nodes are associated with key or key value information of the application message at that level of the hierarchy. For example, as described with reference to FIG. 5e, application messages may be based on, by way of example only but is not limited to, the HTTP protocol (e.g. HTTP request messages etc.) in which a parent node or non-terminal node may represent each HTTP key in the application message and a child node may represent either another HTTP key in the application message if it is another non-terminal node or an associated HTTP key-value string of the application message if it is a terminal node or a leaf node. Each edge from a parent node to a child node indicates that that child node includes a key or a key-value string that depends from the key of the parent node. The root node 5054 of the tree graph X 5050 may be the first key or the topmost key in the hierarchy associated with the HTTP application message,

Referring to FIGS. 5o and 5p, at Level 0 (q=0) of the tree graph X 5050, the root node 5054 is a parent node with a plurality of child nodes 5056 to 5060 located at Level 1 (q=1) of the tree graph X 5050. In this example, the child nodes 5056 to 5060 are non-terminal nodes, each of which are parent nodes of a plurality of child nodes 5062-5074 located at Level 2 (q=2) of the tree graph X 5050. Node n, 5056 is linked to child nodes 5062-5068 located at Level 2 of the tree graph X 5050. These child nodes 5062-5068 are leaf or terminal nodes. Similarly, node 5058 is linked to child nodes 5070-5072 also located at Level 2 of the tree graph X 5050. These child nodes 5070-5072 are also leaf or terminal nodes. Node 5060 is linked to child node 5074 located at Level 2 of the tree graph 5050 X, which is a non-terminal node or parent node of child nodes 5076-5080 located at Level 3 of tree graph X 5050. Child nodes 5076-5080 are leaf or terminal nodes.

In encoding the tree graph X 5050 with 0<=q<=Q levels, where Q is the total number of levels below level 0 or the bottom-most level of the tree graph, a bottom-up approach is used that starts at the bottom-most level (e.g. level Q) of the tree graph X 5050 and acts on subtrees with “root” nodes at level q=Q−1 using the first and second hidden layers 5002a,1 and 5002a,2. Each subtree includes a non-terminal node of level q=Q−1 acting as a “root node” with child/leaf nodes of the Q-th level. The first hidden layer 5002a,1, operates on the portions of information contained in the child/leaf nodes of the Q-th level of tree graph X 5050 (e.g. nodes without children, also called terminal nodes) associated with a corresponding parent node (e.g. non-terminal nodes) of the (Q−1)-th level of the tree graph X. For each subtree, the portions of information (or the context) of the leaf nodes associated with each parent node are transformed using neural network techniques into a tensor, combined and passed to the corresponding parent node of the (Q−1)-th level of the tree graph X. Thus the portions of information contained in the leaf nodes are embedded into N-dimensional low dimensional informationally dense vectors of a latent or vector space. For each non-terminal node at the (Q−1)-th level with terminal child/leaf nodes, the informationally dense vectors of the child nodes of the Q-th level may be passed through the second hidden layer 5002a,2, which use neural network techniques to transform the informationally dense vectors into a rich embedding of an N-dimensional vector. Thus, the subtrees associated with child nodes of the Q-th level are transformed/encoded into the portions of information of the corresponding nodes of the (Q−1)−th level. Once this is performed, the subtrees of the (Q−2)-th may be processed in which the non-terminal nodes of the (Q−1)-th level become child/leaf nodes or terminal nodes of the non-terminal nodes of the (Q−2)-th level. This process using the first and second hidden layers 5002a,1 and 5002a,2 continues up the tree graph X 5050 operating on each of the nodes at each level of the tree graph X 5050 until the final root node at Level 0 when all the portions of information of all nodes of the tree graph X 5050 have been transformed and encoded into an N-dimensional vector. This encoded representation (a single N-dimensional vector) is then fed through the variational layer or encoding layer 504, producing a latent representation that is the N-dimensional low dimensional informationally dense application message vector h₀ 5052, which may be output as an N-dimensional application message vector xᵢ. During training of the VAE 5000, the application message vector h₀ 5052 representation is subsequently fed through the decoder network structure 5002b which splits the representation back into its constituent parts and attempts to replicate the tree graph X 5050.

In particular, the example VAE 5000 may use recursive systems acting on subtrees of tree graph X 5050 within both the encoder and decoder network structures 5002a and 5002b. Essentially, the encoding neural network structure 5002a may be trained and configured to generate an N-dimensional application message vector by parsing the tree graph associated with the application message in a bottom up approach that merges the nodes of the tree graph X 5050 by accumulating one or more context vectors calculated from the content or portions of information associated with nodes of the tree graph X 5050, where a context vector for a parent node of the tree graph is calculated based on context vectors or values representative of information content of the parent's child node(s).

The encoder structure or network 5002a may be configured to, by way of example only but is not limited to, use a tree-based neural network architecture (e.g. a tree-based Long-Short Term Memory (LSTM) architecture) that uses a neural network cell architecture which acts on subtrees of the tree graph X 5050, working from the bottom level to the top level or root node. The cells of the neural network may correspond to the nodes of the tree graph X, In this example, the tree-based neural network architecture may be, by way of example only but is not limited to, a tree-based LSTM architecture. Although the neural network model architecture of the encoding structure 5002a is described, by way of example only but is not limited to, a tree based LSTM architecture, it is to be appreciated by the skilled person in the art that any other suitable neural network structure may be applied and/or used such as, by way of example only but is not limited to, recurrent neural networks, LSTM, Bi-directional LSTM, gated recurrent neural networks, combinations thereof, modifications thereof, or any other neural network structure as the application demands for encoding a tree graph associated with an application message into an N-dimensional application message vector.

Hidden layers 5002a,1 and 5002a,2 and encoding layer 504 may be configured to implement the tree-based LSTM architecture for operating on any given node j of tree graph X associated with an application message to generate its context vector representation hⱼ, which is constructed from the set of it's child nodes C(j) based on the following neural network structure(s) represented by:

$$\begin{matrix}\tilde{{h}_{j}} = {\sum }_{k ∈ C ( j )} {h}_{k} , & ( 1 ) \\ {i}_{j} = σ ( {W}^{( i )} {x}_{j} + {U}^{( i )} {\tilde{h}}_{j} + {b}^{( i )} ) , & ( 2 ) \\ {f}_{jk} = σ ( {W}^{( f )} {x}_{j} + {U}^{( f )} {h}_{k} + {b}^{( f )} ) , & ( 3 ) \\ {σ}_{j} = σ ( {W}^{( σ )} {x}_{j} + {U}^{( σ )} {\tilde{h}}_{j} + {b}^{( σ )} ) , & ( 4 ) \\ {u}_{j} = tanh σ ( {W}^{( u )} {x}_{j} + {U}^{( u )} {\tilde{h}}_{j} + {b}^{( u )} ) , & ( 5 ) \\ {c}_{j} = {i}_{j} \cdot {u}_{j} + {\sum }_{k ∈ C ( j )} {f}_{j k} \cdot {c}_{k} , & ( 6 ) \\ {h}_{j} = {σ}_{j} \cdot tanh {c}_{j} & ( 7 )\end{matrix}$$

where in equation (3) k∈C(j), W⁽ⁱ⁾, U⁽ⁱ⁾, W^{(f)}, U^{(f)}, W^{(σ)} and U^{(σ)} are weight parameter matrices and b⁽ⁱ⁾, b^{(f)}, b^{(σ)} are bias vector parameters which need to be learned during training of the neural network architecture, xⱼ is an input vector representation of the content or portion of information represented by node j, and σ(·) may be, by way of example only but is not limited to, sigmoid function or hyperbolic tangent function, or any other suitable function for use with the neural network.

For each node j of the tree graph X, the neural network architecture takes a sum of all its children representations as the current “context vector” [symbol] , which is then used to calculate the input gate representation iⱼ (e.g. equation (2)), output gate representation fⱼₖ (e.g. equation (3)) and forget gate representation σⱼ (e.g. equation (4)), The current “context vector” [symbol] is also used to calculate uⱼ (e.g. equation (5)) as a “candidate” hidden state that may be computed based on the current input and the previous hidden state. Note there is only one input and output gate representation, (as the input/output) is the current node j with a forget gate representation for each child of the current node j. The true context vector value hⱼ for node j is calculated by feeding the input and the children states with their respective gates based on equations (2), (3) and (4) into a neural network (e.g. equations (5) and (6)) generating cell state vector cⱼ (or a soft neural network output), which is applied to the final output gate (e.g. equation (7)) to produce an N-dimensional true context vector hⱼ. This process is performed in a bottom-up approach and effectively merges the subtree of node j into a single node with an N-dimensional vector representation, hⱼ, which can now be treated as a child node of the nodes at the next level up in the tree graph X or of a larger network. This process continues until the subtree of the root node of tree graph X has been merged into a single node with an N-dimensional application message vector representation, h₀, which may be output as N-dimensional application message vector xᵢ.

For example, referring to FIG. 5p, the subtree 5082 of node n, 5056 of tree graph X 5050 has four child/leaf nodes, which are node n₀ 5062, node n₁ 5064, node n₂ 5066 and node n₃ 5068. For node nᵢ 5056, the neural network as illustrated in equation (1) takes a sum of all its children representations as the current “context vector” \tilde{h}=h₁+h₂+h₃+h₄ for node nᵢ 5056, where h₁ is the true context vector value of node n₁ 5062, h₂ is the true context vector value of node n₂ 5064, h₃ is the true context vector value of node n₃ 5066, h₄ is the true context vector value of node n₁ 5068. These may be based on a previous processing of each of these nodes using the neural network based on equations (1) to (7).

The current “context vector” \tilde{h} is then used to calculate the input gate representation i=σ(W⁽ⁱ⁾x+U⁽ⁱ⁾\tilde{h}+b) for node ni 5056 based on equation (2), the output gate representation f_{ni,k}=σ(W^{(f)}x+U^{(f)}hₖ+b) is calculated using the true context vectors h₁, h₂, h₃, and h₄ of child nodes n₁, n₂, n₃, and n₄ 5062-5068 (e.g. for 1<=k<=4) based on equation (3). The forget gate representation σⱼ=σ(W^{(σ)}x+U^{(σ)}\tilde{h}+b) is calculated using the current “context” vector \tilde{h} based on equation (4). The true context vector value hᵢ for node ni 5056 is calculated by feeding the input and the children states with their respective gates based on equations (2), (3) and (4) into a neural network (e.g. equations (5) and (6)) generating cell state vector cᵢ, which is applied to the final output gate (e.g. equation (7)) to produce hᵢ. This effectively merges the subtree of node ni 5056 into a single node with an N-dimensional vector representation, hⱼ, and soft neural network output cᵢ which can now be treated as a child node of the nodes at the next level up (e.g. level 0) in the tree graph X or of a larger network.

This process is also performed in a bottom-up approach on the subtrees associated with nodes 5058, 5074, 5060 and finally node 5054, which effectively merges the subtrees of nodes 5056, 5058, 5074, 5060 into a single node 5054 with an N-dimensional application message vector representation, h₀, which may be output as N-dimensional application message vector xᵢ. During training of the VAE 5000, the application message vector representation h₀ 5052 is subsequently fed through the decoder network structure 5002b which splits the representation back into its constituent parts and attempts to replicate the tree graph X 5050.

Referring to FIGS. 5o and 5q, the task of the decoder structure 5002b is to generate a tree graph X′ 5100 with content or portions of information associated with the application message of tree graph X 5050 based on being fed a single N-dimensional application message vector representation, h₀, 5052 generated by the encoding structure 5002a. The decoder structure 5002b must take a single output and produce both topology of the tree graph X associated with the application message and also the content of the application message. The decoder structure 5002b includes a first and second hidden decoding layers 5002b,1 and 5002b,2 which uses a neural network architecture that can be trained to model and extrapolate or predict from the single N-dimensional application message vector representation, h₀, a tree graph X′ corresponding to the topology and content of the tree graph X associated with the application message.

The neural network model to generate an estimated tree graph X′ 5100 using a top-down approach in which the arrows on the edges provide an indication of the order of estimating and processing each node i of the tree graph X′ 5100. The decoding neural network structure 5002b is trained and configured to generate a tree graph X′ 5100 based on an N-dimensional vector representation, h₀, 5052 associated with the application message in a recursive top-down approach, where nodes of the estimated tree graph and context information for each node are generated based on the N-dimensional vector. Each of the nodes of the tree graph are generated based on modelling relationships between parent nodes and child node(s) and relationships between child node(s) of the same parent node of the tree graph.

In the example of FIG. 5q, nodes 5104-5120 are generated based on the N-dimensional application message vector representation, h₀, 5052 received from the encoder structure 5002b. Arrow 5103a indicates the direction for determining ancestral nodes and relationships and Arrow 5103b indicates the direction for determining fraternal nodes and relationships. The numbering of the nodes 5104-5120 indicates a possible order for processing and/or estimating each node from 0<=i<=10 and the content or portion of information of each node associated with the application message or content or portion of information associated with the original tree graph X.

The neural network model architecture may be based on, by way of example only but is not limited to, a doubly recurrent neural network (DRNN) where both the ancestral relationship (e.g. paternal or parent node to child node) and fraternal relationship (sibling to sibling or child nodes of the same parent node) may be modelled. For a node i with parent p(i) and previous sibling s(i), the hidden states representing the ancestral representation hᵢ^{a} and fraternal representations hᵢ^{f} are updated based on:

hᵢ^{a}g^{a}(hₚ₍ᵢ₎^{a},xₚ(i)) (8)

hᵢ^{f}=g^{f}(hₛ₍ᵢ₎^{a},xₛ(i)) (9)

where x_{P}(i) and xₛ(i) are vectors representing the previous parent and sibling states, respectively, and g^{a} and g^{f} are functions that apply one step of two separate recursive neural networks. Once these hidden states have been updated, they are combined to produce a single predictive hidden state vector for each node i:

hᵢ^{pred}=tanh(U^{f}hᵢ^{f}U^{a}hᵢ^{a}) (10)

where U_{f} and U^{a} are learnable matrix parameters of the model.

With the single predictive hidden state of equation (10), the model is explicitly trained for early stopping by calculating the probability of node i having further nodes or not having further nodes (either children or siblings) based on:

pᵢ^{a}=σ(u^{a}·hᵢ^{pred}) (11)

pᵢ^{f}=σ(u^{f}·hᵢ^{pred}) (12)

where pᵢ^{a}∈[0,1] may be interpreted as the probability that node i has children, and pᵢ^{f}∈[0,1] may be interpreted as the probability of stopping fraternal branch growth after node i u^{f} and u^{a} are learnable vector parameters, and σ(·) may be, by way of example only but is not limited to, a sigmoid function or hyperbolic tangent function, or any other suitable function for use with the neural network.

Finally, to produce the content of the node i the final hidden state h₁ is calculated based on:

hᵢ=(Whᵢ^{pred}+αᵢv^{a}+γᵢv^{f}) (13)

where αᵢ and γᵢ are the topological decisions such as, by way of example only but not limited to, binary parameters ∈[0,1] defined by if the node was produced or not and v^{a} and v^{f} are learnable offset parameters. Furthermore, during training—the model is forced trained, which is a method of machine learning training where a network is always told the correct truth independent of its answer. This ensures the next prediction can be correctly trained. Applying this allows the model to predict the correct topological decision is being made (e.g. whether a node is to be added or not) in relation to the predicted tree graph X′.

The final hidden state hᵢ for node i is then fed into a sequence LSTM decoder that is trained and/or configured to predict the content of node i as a portion of information (e.g. as a string or sequence of characters and the like).

Although the neural network model architecture of the decoding structure 5002b is described, by way of example only but is not limited to, a DRNN, it is to be appreciated by the skilled person in the art that other suitable neural network structures may be applied and/or used such as, by way of example only but is not limited to, recurrent neural networks, LSTM, Bi-directional LSTM, gated recurrent neural networks, combinations thereof, modifications thereof, or any other neural network structure as the application demands for generating a tree graph associated with an application message based on an N-dimensional application message vector.

The final decoded tree graph X′, which is an estimate of original tree graph X, and the original tree graph X may then be used to calculate the cross entropy 532, and along with the KL parameter, are used to generate a cost function 534 that may be used to optimise the VAE 5000 using backpropagation techniques. The encoding and decoding processes along with weight updates for each hidden layer based on back propagation techniques is performed on a training set of application messages in which a corresponding set of tree graphs are required. Once trained, the encoding structure 5002a of the VAE 5000 is used to generate N-dimensional application message vectors xᵢ based on the N-dimensional latent vector representation, h₀, from tree graphs of the corresponding application messages.

During an application communication session one or more application messages associated with the application communication session will be communicated one after the other between the user device 104a and server node 106a. Thus, a series of application messages forms an application message sequence that represents the communications flow between the user device 104a and server node 106a. As described above, the i-th application message, which can be denoted Rᵢ, may be converted into a corresponding N-dimensional i-th application message vector xᵢ. This may be achieved using, by way of example only but is not limited to, a suitably trained encoder stage 550a, 506a,1, 506a,2, 5002a,1, 5002a,2 of any of VAEs 500, 530, or 5000, respectively, as described with reference to FIGS. 5a-5q. The i-th application message vector xᵢ represents the informational content of the i-th application message Rᵢ.

The application messages, Rᵢ, being communicated between a user device 104a and server node 106a during an application communication session may form a j-th application message sequence (Rᵢ)ⱼ=(R₁, . . . , Rᵢ, . . . , R_{Lj})ⱼ for time step or index 1<=i<=Lⱼ where Lⱼ is the length of the j-th application message sequence (Rᵢ)ⱼ. The j-th application message sequence, (Rᵢ)ⱼ, is converted into a corresponding j-th application message vector sequence, (xᵢ)ⱼ, for 1<i<=Lⱼ.

Each N-dimensional i-th application message vector xᵢ of the j-th application message vector sequence (xᵢ)ⱼ is passed through a neural network that predicts the next (i+1)-th application message that should follow after xᵢ in the application message vector sequence. For example, the neural network has been trained on a training set of “normal” application message sequences {(Rₖ)ⱼ}ⱼ₌₁^{T} where 1<=k<=Lⱼ and 1<=j<=T in which Lⱼ is the length of the j-th application message sequence and T is the number of training sequences. The weights of the neural network are adapted based on the application message sequence (Rₖ)ⱼ for 1<=k<=i at time step i during training to generate a prediction of the next application message, Rᵢ₊₁, that is expected to be received in the j-th application message sequence (Rₖ)ⱼ for 1<=k<=i<=Lⱼ. So, given the i-th application message vector xᵢ as input, the neural network will process this application message vector xᵢ and output a prediction application message vector pᵢ₊₁ that represents the informational content of the predicted next application message Rᵢ₊₁ that is expected to be received in the application communication session.

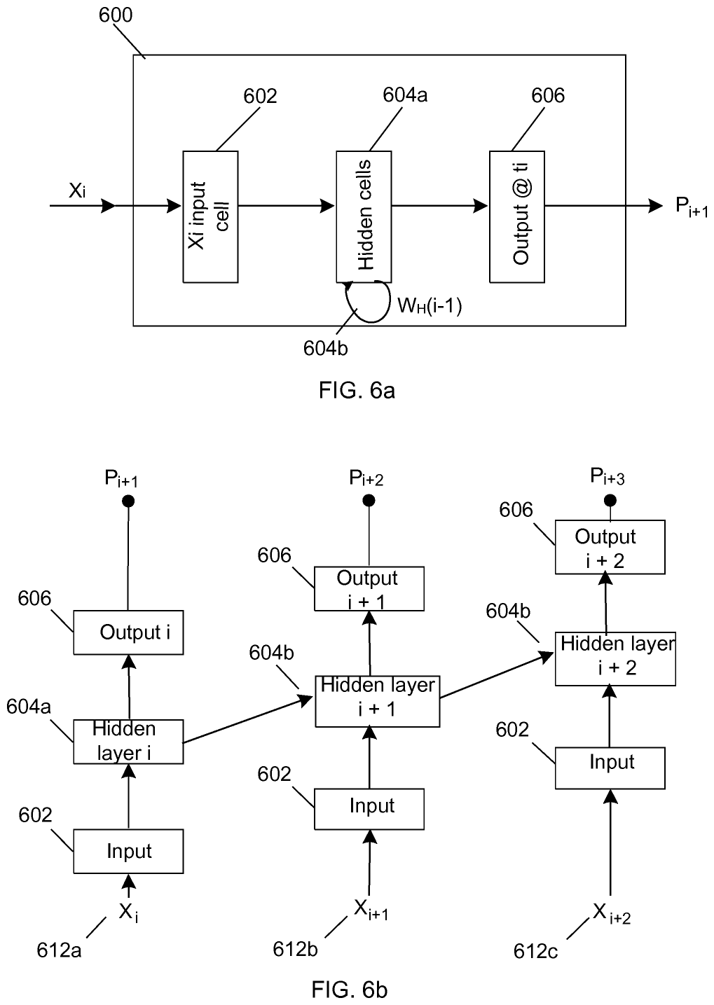

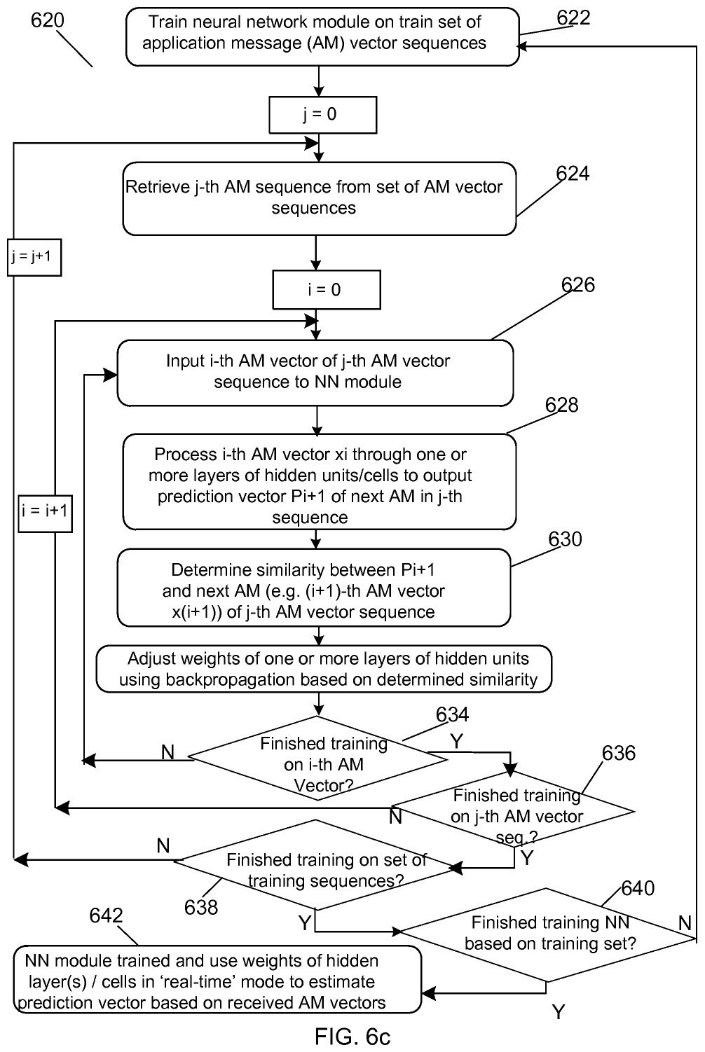

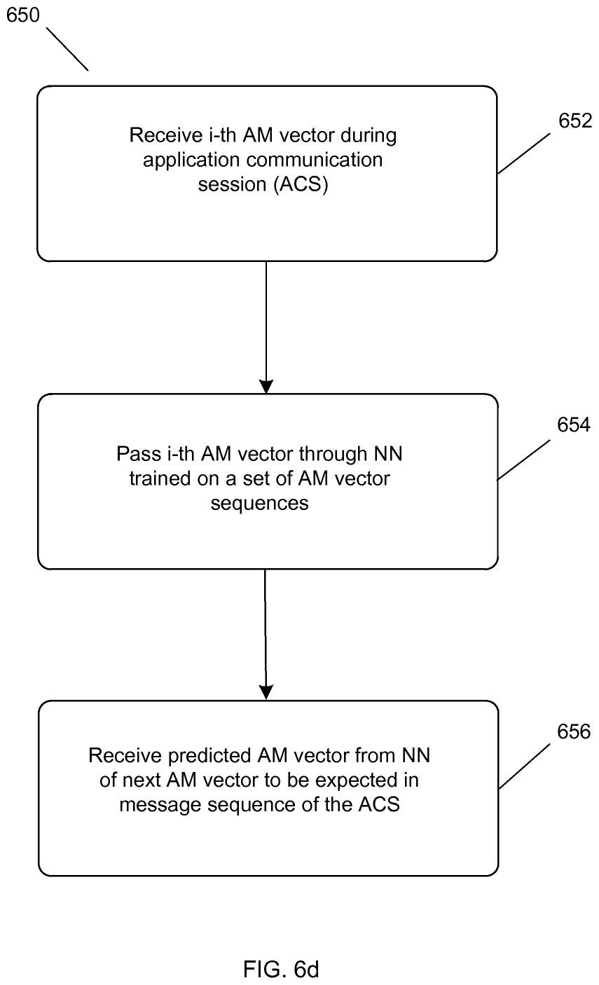

FIG. 6a is a schematic diagram illustrating an example neural network apparatus 600 can be configured to process an application message vector, xᵢ, generated from an application message, Rᵢ, to output a prediction of the next application message Rᵢ in a sequence of application messages (Rₖ) communicated between a user device 404a and a server node 406a during an application communication session. The application message vector(s), xᵢ, may be generated based on a modified skip-gram model 400 and/or process(es) 410 and/or 430 as described with reference to FIGS. 4a-4d and/or based on a VAE 500 and/or VAE process 510 as described with reference to FIGS. 5a-5c, or based on a combination thereof or any other suitable method, apparatus or process for converting application messages into application message vectors for training neural network apparatus 600 and/or subsequent processing by neural network apparatus 600.

The neural network apparatus 600 may be based on the neural network as described in step 206 of method 200 or as described by neural network module 224 with reference to FIGS. 2a and 2b. The neural network apparatus 600 may be configured by training weights of one or more hidden layers using a training set of sequences of application message vectors that corresponding to sequences of application messages that are considered to be normal. The neural network apparatus 600 is trained to predict the next application message in an application message sequence given a current received application message during an application communication session.

Referring to FIG. 6a, the neural network apparatus 600 includes an input layer 602 for receiving an i-th application message vector, xᵢ, associated with a j-th sequence of application message vectors (xᵢ)ⱼ for 1<i<=Lⱼ. The i-th application message vector, xᵢ, is processed by one or more neural network hidden layers or cells 604a. In this example, the one or more hidden layers 604a model a recurrent neural network in which the one or more hidden layers 604a receive feedback weights 602b (e.g. W_{H}(i−1)) based on the previous (i−1)-th application message vector, xᵢ₋₁, associated with the (i−1)-th application message Rᵢ₋₁, in the j-th sequence of application messages (Rᵢ)ⱼ for 1<=i<=Lⱼ, where Lⱼ is the length of the j-th message sequence. Thus, the current application message vector (i.e. the i-th application message vector), which represents the information content of the i-th received application message, Rᵢ₋₁, is processed by the one or more hidden layers 604a and weights of hidden layers 604b associated with the (i−1)-th application message of the j-th message sequence (Rᵢ)ⱼ and outputs a result to output layer 606. Output layer 606 outputs an N-dimensional vector, pᵢ₊₁, that represents a prediction or estimate of the next application message, Rᵢ₊₁, that may be received so far in the j-th sequence of application messages (Rₖ)ⱼ for 1<=k<=i<=Lⱼ.

In order to do this, as briefly described above, the weights of the one or more hidden layers 604a and 604b of the neural network apparatus 600 are trained on a set of known application message sequences {(Rᵢ)ⱼ}ⱼ₌₁^{T}, where 1<=i<=Lⱼ and 1<=j<=T in which Lⱼ is the length of the j-th application message sequence and Tis the number of training sequences, that are associated with the “normal” operation of the application during an application communication session between two entities (e.g. user device 104a and server node 106a). The neural network 600 that is trained on a training set of application message sequences, {(Rᵢ)ⱼ}ⱼ₌₁^{T}, may use, by way of example only but is not limited to, a recurrent neural network (RNN) structure that includes long-short term memory (LSTM) cells or gated recurrent units (GRUs). Although LSTM cells or GRUs have been described by way of example only, it is to be appreciated by the skilled person that other neural network structures may become viable in further, thus the invention is not limited to using only LSTM cells or GRUs, but may also use other suitable neural network structures.

In this example, recurrent neural networks (RNNs) are used, by way of example only, as the structure of the neural network apparatus 600. RNNs are a class of neural network characterised by their ability to perform temporal processing to learn patterns and sequences through time. This can be achieved through feedback connections, in which one or more outputs from an output layer 606 are piped back into the neural network structure. Compared with feedforward neural networks, where an error is only piped in a single direction from the input layer 602 to the output layer 606, RNNs can maintain the error within the neural network structure over time, which results in a form of memory. This useful property allows a neural network to capture complex dynamics from a training signal or set of training vectors etc.

RNNs may also be discretised with respect to time to leverage the structures and theory of feedforward neural networks. For example, FIG. 6b is a schematic diagram illustrating the RNN of neural network apparatus 600 being unfolded over time (e.g. time steps i, i+1, i+2, . . . ), which may allow the hidden layers 602a making up the RNN structure to be trained using, by way of example only but not limited to, backpropagation through time. Unfolding over time allows the conversion of a RNN structure into a feedforward neural network structure that can dynamically retain error for a certain number of time steps I. This is achieved by duplicating the neural network/times for A<=i<=8, where I=(B−A)+1 and A and B are integers, in which the weights of the hidden layer 602b at time step i−1 are connected to the hidden layer 602b at time step i and so on.

For example, FIG. 6b illustrates the unfolding of the RNN structure of neural network 600 over 3 time steps, namely, at time steps i, i+1, and i+2. At time step i 612a, the i-th application message vector, xᵢ, is applied to the input layer 602 and processed by the hidden layer 602a to output prediction vector, pᵢ₊₁, from the output layer 606. By performing this unfolding, the resultant neural network may be trained with a variant of the backpropagation algorithm known as backpropagation through time.

At time step i+1 612b, the (i+1)-th application message vector, xᵢ₊₁, is applied to the input layer 602 and processed by the combination of the hidden layer 602a and also the weights of the hidden layer 602b of time step i to output prediction vector, pᵢ₊₂, from the output layer 606. At time step i+2 612b, the (i+2)-th application message vector, xᵢ₊₂, is applied to the input layer 602 and processed by the combination of the hidden layer 602a and also the weights of the hidden layer 602b of time step i+1 to output prediction vector, pᵢ₊₃, from the output layer 606. This goes on for the (i+3)-rd application message vector, xᵢ₊₂, and so on. Thus, a sequence of prediction vectors ( . . . , pᵢ₊₁, pᵢ₊₂, pᵢ₊₃, . . . ) is formed which are predictions of the sequence of application vectors ( . . . , xᵢ₊₁, xᵢ₊₂, xᵢ₊₃, . . . ).

The RNN structure may be further modified to reduces the potential of having an error gradient that decreases exponentially with the network depth, which can cause the front layer of the network to train slowly, and the potential of having an error gradient that increases exponentially when unbounded activation functions are used. The RNN structure may be further modified based on Long-Short Term Memory Networks (LSTM). The LSTM differs architecturally from the conventional RNN structure in that it contains memory cells or blocks, which are cells or blocks that can retain their internal state over time, and gating units which control the flow of information in and out of each cell or block. In short, LSTM blocks can be interpreted as differentiable memory, allowing for training through backpropagation.

There are many variants of LSTM networks and the architecture that is used herein is, by way of example but is not limited to, the architecture of Graves et. al., “Framewise phoneme classification with bidirectional LSTM and other neural network architectures”, Neural Networks, 18 (5-6): 602-610, 2005). A formulation of this variant is outlined for a block at time step t as:

iₜ=σ(Wₓᵢxₜ+Wₕᵢhₜ₋₁+W_{ci}cₜ₋₁+bᵢ)

fₜ=σ(W_{xf}xₜ+W_{hf}hₜ₋₁+W_{cf}cₜ₋₁+b_{f})

cₜ=fₜcₜ₋₁+iₜ tanh(W_{xc}xₜ+W_{hc}hₜ₋₁+b_{c})

oₜ=σ(Wₓₒxₜ+Wₕₒhₜ₋₁+W_{co}cₜ+bₒ)

hₜ=oₜ tanh(cₜ)

where iₜ is the input gate vector that controls the acquiring of new information, fₜ is the forget gate vector that controls the remembering of old information, cₜ is a cell state vector, o_{f} is the output gate vector that controls the extent to which the value in memory is used to compute the output activation of the block, representing the output candidate, xₜ is the input vector (e.g. the i-th application message vector), hₜ is the output vector, wₓᵢ, Wₕᵢ, and W_{ci} are weight parameter matrices associated with the input gate vector, bᵢ is a parameter vector associated with the input gate vector, W_{xf}, W_{hf}, and W_{cf} are weight parameter matrices associated with the forget gate vector, b_{f} is a parameter vector associated with the forget gate vector, Wₓₒ, Wₕₒ, and W_{co} are weight parameter matrices associated with the forget gate vector, bₒ is a parameter vector associated with the output gate vector, W_{xc} and W_{hc} are weight parameter matrices associated with the cell state vector, b_{c} is a parameter vector associated with the cell state vector, and a is an activation function (e.g. a sigmoid function, arctan, or any other bounded differentiable, non-linear, monotonic function may be suitable).

Effectively, each hidden layer 602a has a plurality of LSTM cells or blocks, which comprise several gates such as an input gate, a forget gate and an output gate. The LSTM cells of blocks also have an block input for receiving input signals (e.g. components of application message vectors), an output activation function; and peephole connections. The output of an LSTM block is recurrently connected to each of the aforementioned inputs. The forget gate allows each block to reset its own internal state.

The RNN with LSTM structure of neural network apparatus 600 may be trained by applying, by way of example only but is not limited to, backpropagation-through-time via stochastic gradient descent or congugate gradients method. The network 600 may be trained to minimise a log-loss function between a predicted application message vector, pᵢ, (e.g. a predicted embedding) and the actual or received application message vector, xᵢ, (e.g. the actual embedding). This may be performed using a similarity kernel function, such as, by way of example only but is not limited to, the n-dimensional Log-Euclidean distance s(x,y)=−log(∥x−y∥²) or a cosine similarity function such as, by way of example only but not limited to, s(x,y)=log(x·y/∥x∥ ∥y∥) where x and y are n-dimensional vectors. In other words, the neural network apparatus 600 will learn to predict a request embedding (e.g. the received application message vectorxᵢ) given a context that maximises the similarity between the predicted embedding (e.g. the predicted application message vector, pᵢ), and the actual embedding (e.g. the received application message vector xᵢ).

FIG. 6c is a flow diagram illustrating an example process 620 for training the neural network apparatus 600, which is based, by way of example only but is not limited to, a RNN neural network and LSTM structure. A training set of known application message sequences {(Rᵢ)ⱼ}ⱼ₌₁^{T}, where 1<=i<=Lⱼ and 1<=j<=T in which Lⱼ is the length of the j-th application message sequence and Tis the number of training sequences, that are associated with the “normal” operation of the application during an application communication session between two entities (e.g. user device 104a and server node 106a) may be used. The training set of application message sequences {(Rᵢ)ⱼ}ⱼ₌₁^{T} may be converted or embedded as a corresponding training set of application message vectors {xᵢ}ⱼ₌₁^{T} as previously described with reference to FIGS. 2b and 4a-5c. The neural network 600 takes as input application message vectors, xᵢ, rather than the corresponding original application messages Rᵢ. The neural network 600 is thus trained on a training set of application message vectors {xᵢ}ⱼ₌₁^{T}. The process 620 may be as outlined, by way of example only but is not limited to, the following steps of:

In step 622, the neural network apparatus 600 is trained on a training set of application message vector sequences {(xᵢ)ⱼ}ⱼ₌₁^{T}, where 1<=i<=Lⱼ and 1<=j<=T in which Lⱼ is the length of the j-th application message sequence and T is the number of training sequences, and which may be retrieved from storage. A sequence counter may be initialised (e.g. j=0) and used to indicate each application message vector sequence for retrieval during training. In step 624, the j-th application message sequence (xᵢ)ⱼ for 1<i<=L is retrieved and a message counter may be initialised (e.g. i=0). In step 626, the i-th application message vector xᵢ of the j-th application message vector sequence (xᵢ)ⱼ is applied to the input layer 602 of the neural network apparatus 600. In step 628, the i-th application message vector xᵢ is processed by the hidden layers 604a, where applicable (e.g. for i>0) the feedback output and/or weights of the hidden layers 604a of the (i−1)-th, and the input, forget and output gates associated with the LSTM block, and outputs from the output layer 606 a prediction application message vector, pᵢ₊₁, representing a prediction of the next application message Rᵢ₊₁ in the j-th sequence of application messages (Rᵢ)ⱼ.

In step 630, the similarity between the prediction vector pᵢ₊₁ and the next actual application message vector xᵢ₊₁ in the j-th sequence of application message vectors (xᵢ)ⱼ is determined. The similarity may be based on a similarity function such as, by way of example only but not limited to, the N-dimensional Euclidean distance or squared Euclidean distance function, and/or Cosine similarity functions and the like. In step 632, the weights of the one or more hidden units/cells 604a are adjusted using backpropagation techniques based on the determined similarity between the prediction vector pᵢ₊₁ and the next actual application message vector xᵢ₊₁. The backpropagation techniques may include, by way of example only but is not limited to, backpropagation-through-time via stochastic gradient descent and the like. The weights are adjusted to as to minimise the similarity or error between the output prediction vector pᵢ₊₁ of the next application message vector and the next actual application message vector, xᵢ₊₁.

In step 634, a check is made to determine whether to finish training on the i-th application message vector xᵢ. If training is finished on the i-th application vector xᵢ (e.g. ‘Y’), then the process proceeds to step 636, otherwise (e.g. ‘N’) the process proceeds to step 626. In step 636, it is determined whether to finish training on the j-th application message vector sequence (xᵢ)ⱼ. If training is finished on the j-th application message vector sequence (xᵢ)ⱼ (e.g. ‘Y’) then the process 620 proceeds to step 638, otherwise (e.g. ‘N’, i.e. i<=Lⱼ) the process proceeds to increment the message counter (e.g. i=i+1) and proceed to step 626.

In step 638, it is determined whether training on the training set of application message vector sequences {(x₁)ⱼ}ⱼ₌₁^{T} is finished. If training is finished on the training set of application message vector sequences, then the process 620 proceeds to step 640, otherwise the next application message vector sequence is retrieved (e.g. ‘N’, i.e. j<=T) the sequence counter is incremented (e.g. j=j+1) and the process proceeds to step 624 to retrieve the j-th application message sequence (xᵢ)ⱼ. In step 640, it is determined whether to finish training the neural network apparatus 600 based on the current training set of application message vector sequences {(x₁)ⱼ}ⱼ₌₁^{T}.

If it is determined that training of the neural network apparatus 600 is finished (e.g. ‘Y’), then the process proceeds to step 642, otherwise the process proceeds to step 622 where, by way of example only but not limited to, the current training set may be reused to perform further training, or the current training set of sequences may be randomised the sequences used in a different order for further training of the neural network apparatus 600, or even another training set of sequences may be selected for training the neural network apparatus 600.

In step 642, the neural network apparatus 600 is considered to be trained so that the trained weights of the one or more hidden layers/cells are used in a “real-time” mode of operation (also known as evaluation mode of operation). In “real-time” operation, application messages may be received during a communication session between, for example, a user device and a server node. These may be converted to corresponding application message vectors as previously described and input to the neural network apparatus 600 to predict the next application message vector that is expected to be received.

FIG. 6d is a flow diagram illustrating a process 650 for “real-time” operation of the neural network apparatus. In “real-time” operation, application messages may be received during a communication session between, for example, a user device and a server node. These may be converted to corresponding application message vectors as previously described and input to the neural network apparatus 600 as application message vectors, which are processed by the hidden layers and weights 604a and 604b of the neural network apparatus 600 to predict the next application message vector that is expected to be received. The process 650 is given as follows:

In step 652, the i-th application message vector is received from the conversion unit or module. The i-th application message vector represents the information content of the i-th received application message that is communicated between a user device and a server node during an application communication session. In step 654, the i-th application message vector is passed through the hidden layers 604a and 604b of the neural network apparatus 600, which has been trained on a training set of application message vector sequences representing known “normal” sequences of application messages that may be transmitted between user device and server node during an application communication session. In step 656, a predicted application message vector of the next application message that is expected to be received or appear in the sequence of received application messages is output from the output layer 606 of the neural network apparatus 600. The predicted application message vector(s) and the corresponding actual application message vector(s) are used to determine whether the application message sequence is “normal” or “abnormal”.

The j-th sequence of application message vectors (xᵢ)ⱼ for 1<=i<=Lⱼ, where Lⱼ is the length of the j-th message sequence, and the corresponding j-th sequence of prediction application message vectors (pᵢ)ⱼ for 1<=i<=Lⱼ may be used to determine whether the j-th application message sequence is “normal” or “abnormal”. This may be achieved by taking into account the error or similarity between the j-th sequence of application message vectors (xᵢ)ⱼ and the corresponding j-th sequence of prediction application message vectors (pᵢ)ⱼ. For example, a j-th error vector eⱼ may be generated between the j-th sequence of application message vectors (xᵢ)ⱼ and the corresponding j-th sequence of prediction application message vectors (pᵢ)ⱼ by calculating the similarity between them. The similarity may be determined based on the euclidean distance between the sequences, or calculating the cosine similarity between the sequences, or using any other method or function that expresses the difference or similarity between these sequences. The set of error vectors that results may be used to train a classifier to

The training set of “normal” application message vector sequences {(xᵢ)ⱼ}ⱼ₌₁^{T}, where 1<=i<=Lⱼ and 1<=j<=T in which Lⱼ is the length of the j-th application message sequence and T is the number of training sequences, are used to train the neural network apparatus 600 to output a corresponding set of prediction application message vectors sequences {(pᵢ)ᵢ}ⱼ₌₁^{T} for 1<=i<=Lⱼ and 1<=j<=T. The set of application message vector sequences {(xᵢ)ⱼ}ⱼ₌₁^{T} and the corresponding set of prediction application message vectors sequences {(pᵢ)ⱼ}ⱼ₌₁^{T} can be used to generate a training set of error vectors {eⱼ}ⱼ₌₁^{T} where T is the number of training error vectors with each error vector corresponding to an application message vector sequence in the training set of application message vector sequences {(xᵢ)ⱼ}ⱼ₌₁^{T}.

The j-th error vector eⱼ represents the error or similarity between the j-th application message vector sequence (xᵢ)ⱼ and the j-th prediction application message vector sequence (pᵢ)ⱼ. A training set of error vectors E={eⱼ}ⱼ₌₁^{T} represents a set of error vectors that have a “normal” label, because the set of application message vector sequences are derived from the “normal” operations and communications of an application during an application communication session between a user device and server node.

The set of error vectors E={eⱼ}ⱼ₌₁^{T} can be used to train a classifier to determine a threshold surface that either separates or contains the training set of “normal” error vectors. The threshold surface may be, by way of example only but is not limited to, a hyperplane, a manifold, a region or any other surface that separates error vectors that may be labelled as “normal” from error vectors that may be labelled as “abnormal”. Thus, once this threshold surface has been determined from training the classifier, it can then be used to classify whether incoming or received application message sequences are “normal” or “abnormal” based on the error vector between a received application message vector sequence and the predicted application message vector sequence that has been received so far during an application communication session.

There are several ways to construct an error vector from an application message vector sequence and the corresponding prediction message vector sequence. For example, a first way may be to construct an error vector in the same vector space as the application message vector and corresponding prediction message vector, which are vectors in an N-dimensional vector space. The j-th error vector in the N-dimensional vector space that corresponds with the j-th application message vector sequence and corresponding j-th prediction message vector sequence may be defined as:

$${e}_{j} = {\sum }_{k = 1}^{{L}_{j}} {p}_{k} - {x}_{k} ,$$

where pₖ is the k-th prediction vector corresponding to the j-th prediction vector sequence, and xₖ is the k-th application message vector corresponding to the j-th application message vector sequence and Lⱼ is the length of the j-th application message vector sequence.

Although an error vector eⱼ may be defined for each j-th application message vector sequence and corresponding prediction vector sequence, multiple error vectors may be defined to be associated with each j-th application message vector sequence. For example, one error vector may be associated with the entire j-th application message sequence and the remaining error vectors being associated with ordered subsequences of the j-th application message vector sequence. For example, sequence {a,b,c,d} is made up of the following set of 10 sequences {a,b,c,d; a,b,c; a,b; a; b,c,d; b,c; b; c,d; c; d} in which each element is consecutive. A sequence of length Lⱼ has a number of Lⱼ(Lⱼ+1)/2 subsequences including the full sequence in which each element is consecutive.

The training set of error vectors E={eⱼ} may be increased to include further error vectors associated with one or more subsequences of each j-th application message vector sequence. This may allow early detection of anomalous application message traffic because the classifier may be able to determine whether an application message sequence is “abnormal” before the whole application message sequence associated with an application communication session has been received.

The increased training set of error vectors may be defined as E={e_{j,k}} for 1<=j<=T and 1<=k<=Lⱼ(Lⱼ+1)/2. Thus, the j-th error vector in the N-dimensional vector space that corresponds with the k-th sequence or subsequence of the j-th application message vector sequence and corresponding j-th prediction message vector sequence may be defined as:

$${e}_{j , k} = {\sum }_{i = A ( k )}^{B ( k )} {p}_{i} - {x}_{i} , for 0 \leq A ( k ) \leq i \leq B ( k ) \leq {L}_{j}$$

where pᵢ is the i-th prediction vector corresponding to the j-th prediction vector sequence, and xᵢ is the i-th application message vector corresponding to the j-th application message vector sequence and Lⱼ is the length of the j-th application message vector sequence, and A(k) and B(k) may define different value limits for different k (e.g. they are functional parameters) that may be adjusted and act as a sliding window over the j-th application message vector sequence to select a particular k-th subsequence of the j-th application message sequence/prediction message vector sequence that can be used to generate the k-th error vector associated with the j-th application message vector sequence. For example, when A(k)=0 and B(k)=Lⱼ then the error vector is associated with the entire j-th application message vector sequence. However, further error vectors may be generated for one or more subsequences or sliding windows of the j-th application message vector sequence by adjusting the values of A(k) and/or B(k).

Another way to construct an error vector from an application message vector sequence and the corresponding prediction message vector sequence may be to construct an error vector in a different vector space as the application message vector and corresponding prediction message vector, which are vectors in an N-dimensional vector space. Rather than an N-dimensional space, a D-dimensional space where D<=Lⱼ<N may be used. For example, a context window (e.g. a sliding window) of length Don the j-th application message vector sequence may be used to generate error vector eⱼ and may be defined as:

eⱼ={eₖ=similarity(pₖ,xₖ)}ₖ₌₁^{D}

where eₖ is the k-th element of error vector eⱼ, pₖ is the k-th prediction vector corresponding to the j-th prediction vector sequence, and xₖ is the k-th application message vector corresponding to the j-th application message vector sequence and the function similarity(x,y) is a similarity function that operates on vectors x and y. Various different similarity functions may be used including, by way of example only but not limited to, the n-dimensional Log-Euclidean distance s(x,y)=−log(∥x−y∥²), or a cosine similarity function

$$s ( x , y ) = log ( \frac{x \cdot y}{‖ x ‖ ‖ y ‖} ) ,$$

where x and y are vectors of the same dimension.

Although the D-dimensional error vector eⱼ has been defined over a context window of size D, this may be extended to apply to a sliding window associated with the i-th application message vector/prediction vector in the j-th application message vector sequence, so the j-th error vector between the i-th application message vector and i-th prediction message vector of the j-th application message vector sequence may be defined as:

eⱼⁱ={eₖ=similarity(pᵢ₋ₖ₋₁,xᵢ₋ₖ₋₁)}ₖ₌₁^{D}

where 1<=(i−D)<i<=Lⱼ and 1<=D<=i, in which D is the number of the most recent application message vectors. For example, during a communication session application messages are received sequentially forming a j-th application message sequence, so for the i-th received application message, where 1<(i−D)<i<=Lⱼ, then eⱼⁱ is the error vector that is associated with the most recent D received application messages and corresponds the D most recently generated application message vectors and prediction message vectors. As before, various different similarity functions may be used including, by way of example only but not limited to, the Log−Euclidean distance s(x,y)=−log(∥x−y∥²), or a cosine similarity function

$$s ( x , y ) = log ( \frac{x \cdot y}{‖ x ‖ ‖ y ‖} ) ,$$

where x and y are vectors of the same dimension. Thus the set of error vectors E={eⱼ} may include error vectors eⱼⁱ for 1<=j<=T and 1<=(i−D)<i<=Lⱼ.

Although several example methods of generating error vectors and sets of error vectors have been described, these have been described by way of example only and that the invention is not only limited to those error vectors as described. It is to be appreciated by the skilled person that any other suitable error vectors or sets of error vectors may be derived, generated and used in place of or combined with the error vectors or sets of error vectors as described herein.

In order to classify an application message sequence as either “normal” or “anomalous” (i.e. two labels) a classifier based on, by way of example only but is not limited to, a Support Vector Machine (SVM) may be trained on a set of error vectors in which each of the error vectors may have a label associated with it depending on whether the corresponding application message vector sequence is “normal” or “anomalous”. If each of the error vectors in the set of error vectors only correspond to a “normal” application message vector sequence, then a one-class SVM classifier may be trained and used for classifying whether application message sequences are “normal” or “anomalous”. However, the set of error vectors contains a first subset of error vectors that corresponds with “normal” application message vector sequences and a second subset of error vectors that correspond with “anomalous” application message vector sequences then a two-class SVM classifier may be trained and used for classifying whether application message sequences are “normal” or “anomalous”.

The goal is to classify incoming or received application message sequences (e.g. HTTP request and/or response messages) as either anomalous or normal. For each application message sequence an error vector may be constructed as previously described, by way of example only. The error vector associated with each application message sequence is a proxy for the likelihood that a sequence of application messages is created by the application. Should the set of error vectors be derived from a set of application message vector sequences that are labelled as “normal”, then to get a classification that an application message sequence is either normal or anomalous a classifier based on, by way of example only but is not limited to, a one-class Support Vector Machine (SVM) may be trained and/or adapted to determine a threshold surface that separates the normal error vectors from the anomalous error vectors.

For the one-class SVM, a set of unlabelled training data or training data that is known to be “normal” from the set of error vectors E may be defined as:

e₁,e₂, . . . ,eₙ∈E

where the error vectors, e₁, e₂, . . . , eₙ, may be either N-dimensional error vectors or D-dimensional error vectors.

A linear classifier is required in an infinite dimensional kernel space, where ϕ is a feature map, K(·) is a simple kernel, b is a bias and g is a decision function that may be defined as g(e)=sign(ϕ(eᵢ)·ϕ(eⱼ)+b), where ϕ(eᵢ)·ϕ(eⱼ)=K (eᵢ,eⱼ) and eᵢ and eⱼ are two sample error vectors. Several different kernels may be used such as, by way of example only but is not limited to a Polynomial Kernel, which is defined as K(eᵢ,eⱼ)=(1+Σₖe_{i,k}e_{j,k})^{d}, where d>=2, e_{i,k} is the k-th element of vector eᵢ and e_{j,k} is the k-th element of vector eⱼ, and/or a Radial Basis Function Kernel, which is defined as K(eᵢ,eⱼ)=exp(−∥eᵢ−eⱼ∥^{b}/2σ²), where b>=2 and σ is a free parameter.

This can be represented as a dual quadratic programming problem of a traditional two-class SVM, where Langrange multipliers are included to prevent trivial optima being returned, and may be defined as:

$${φ}^{*} ( e ) = arg {min}_{α} \frac{1}{2} {\sum }_{i j} {α}_{i} {α}_{j} K ( {e}_{i} , {e}_{j} ) ,$$

where

$$0 \leq {α}_{i} \leq \frac{1}{v ( l + p )} and 0 \leq {α}_{j} \leq \frac{1}{v ( l + p )}$$

in which v is the size of the error vector set, l is the regularisation factor, Σᵢαᵢ=1 and Σⱼαⱼ=1.

The weights αᵢ and αⱼ are adjusted during training. Once this classifier has been trained, the classifier can operate in “real-time” mode where incoming or received application messages (e.g. HTTP requests) associated with a communication session are converted error vectors and classified according to the above decision function. The conversion of the received application messages into error vectors includes converting the application messages into application message vector sequences in which a neural network processes the application message vectors and outputs prediction application message vectors, which are then converted into error vectors in the set E and classified according to the trained classifier.

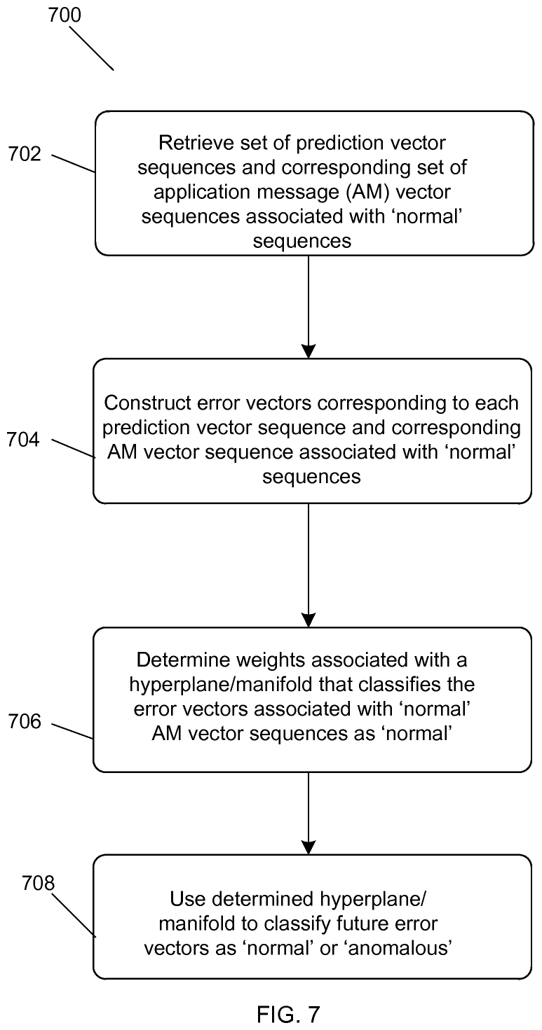

FIG. 7 is a flow diagram illustrating an example process 700 for determining a classifier for classifying application message sequences as normal or abnormal based on the converted application message vector sequences and corresponding prediction message vector sequences. The process is as follows:

In step 702, a set of application message vector sequences and a corresponding set of prediction message vector sequences are retrieved. The set of application message vector sequences includes “normal” application message sequences, or application message sequences that are known to be associated with “normal” communications/operation of an application during an application communication session. The application message vector sequences may further include “abnormal” application message sequences, or application message sequences that are known to be associated with “abnormal” communications/operation of an application during an application communication session.

In step 704, a set of error vectors are constructed based on the set of application message vector sequences and corresponding set of prediction message vector sequences. Each error vector may represent the deviation or similarity between the associated application message vector sequence and the corresponding prediction message vector sequence.

In step 706, the weights of a classifier are adapted to determine a threshold surface (e.g. hyperplane or manifold) that can be used to classify error vectors associated with “normal” application message vector sequences as “normal”. For example, if the error vectors are associated with only “normal” application message vector sequences, then a one-class SVM may be used to determine the weights for a classifier that is capable of determining a threshold surface containing the error vectors or separating the error vectors from “abnormal” error vectors. In another example, if the error vectors are associated with both a “normal” set of application message vector sequences and an “abnormal” set of application message vector sequences, then a two-class SVM may be used to determine the weights for a classifier that is capable of determining a threshold surface containing the “normal” or “abnormal” error vectors or separating the “normal” error vectors from “abnormal” error vectors.

In step 708, the determined weights and/or the determined threshold surface (e.g. hyperplane or manifold) may be used by the classifier to classify incoming application messages and hence corresponding error vectors as “normal” or “abnormal”.

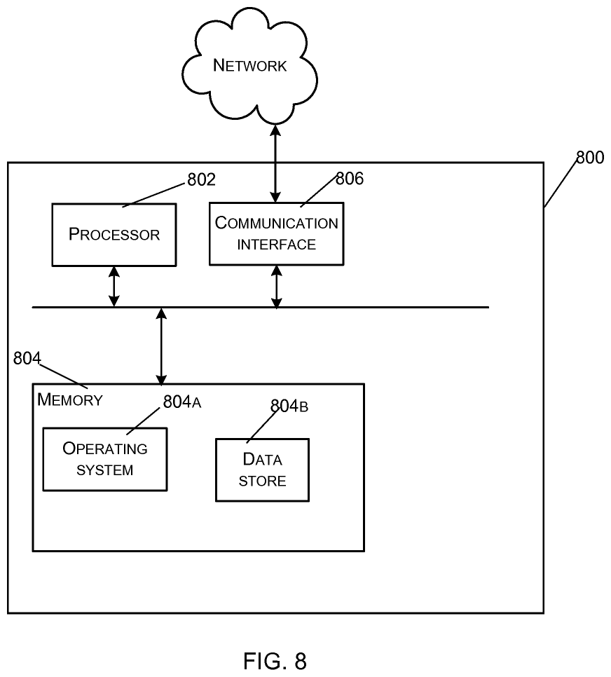

FIG. 8 illustrates various components of an exemplary computing-based device 800 which may be implemented to include the functionality of the intrusion detection mechanism, apparatus, method(s) and/or process(es) for detecting an anomalous application message sequence in an application communication session described, way of example only, between a user device 104a and a network node 102a-102d or 106a-106n of a telecommunications network 100. The computing device 800 may include a memory unit 804, a one or more processors and/or a processor unit 802, a communication interface 806, in which the processor unit 802 is coupled to the memory unit 804, and the communication interface 806. The memory unit 804 includes instructions stored thereon, which when executed on the processor unit 802, causes the computing device 800 to perform the method(s) or process(es) according to the invention as described herein.

The computing-based device 800 may include one or more processor(s) 802 which may be microprocessors, controllers or any other suitable type of processors for processing computer executable instructions to control the operation of the device in order to perform measurements, receive measurement reports, schedule and/or allocate communication resources as described in the process(es) and method(s) as described herein. In some examples, for example where a system on a chip architecture is used, the processor(s) 802 may include one or more fixed function blocks (also referred to as accelerators) which implement the methods and/or processes as described herein in hardware (rather than software or firmware).

The memory unit 804 may include platform software and/or computer executable instructions comprising an operating system 804a or any other suitable platform software may be provided at the computing-based device to enable application software to be executed on the device. Depending on the functionality and capabilities of the computing device 800 and application of the computing device, software and/or computer executable instructions may include the functionality of the method(s) and/or process(es) as described herein, by way of example only but not limited to, detecting anomalous application message sequences using one or more of performing reception of application messages associated with application message sequences, generating corresponding application message vectors and estimates of subsequent application message vectors based on the application messages received so far, classifying the application message sequences as normal or anomalous (or abnormal) and sending an indication of anomalous sequences for actioning according to the invention as described with reference to FIGS. 1a to 7.

For example, computing device 800 may be used to implement one or more of network nodes 102a-102d and/or server nodes 106a-106n and may include software and/or computer executable instructions that may include functionality of the apparatus, method(s) and process(es) as described herein for detecting anomalous application message sequences during one or more application communication sessions between one or more user devices and one or more server nodes 106a-106n according to the invention as described with reference to FIGS. 1a to 7.

The software and/or computer executable instructions may be provided using any computer-readable media that is accessible by computing based device 800. Computer-readable media may include, for example, computer storage media such as memory 804 and communications media. Computer storage media, such as memory 804, includes volatile and non-volatile, removable and non-removable media implemented in any method or technology for storage of information such as computer readable instructions, data structures, program modules or other data.

In the embodiments described above and herein the server node may comprise a single server or network of servers. In some examples the functionality of the server node may be provided by a network of servers distributed across a geographical area, such as a worldwide distributed network of servers or server nodes, and a user may be connected to an appropriate one of the network of servers or server nodes based upon a user location.

The above description discusses embodiments of the invention with reference to a single user for clarity. It will be understood that in practice the intrusion detection mechanism, apparatus or system and/or method(s)/process(es) described herein may be shared or used by a plurality of users, and possibly by a very large number of users simultaneously. The intrusion detection mechanism, apparatus or system and/or method(s)/process(es) described herein may operate on multiple application communication sessions corresponding to a plurality of user devices and server nodes and the like for detecting anomalous application message sequences associated with one or more of the multiple application communication sessions.

The embodiments described above are fully automatic. In some examples a user or operator of the system may manually instruct some steps of the method to be carried out.

In the described embodiments of the invention the intrusion mechanism, apparatus or system may be implemented as any form of a computing and/or electronic device. Such a device may comprise one or more processors which may be microprocessors, controllers or any other suitable type of processors for processing computer executable instructions to control the operation of the device in order to gather and record routing information. In some examples, for example where a system on a chip architecture is used, the processors may include one or more fixed function blocks (also referred to as accelerators) which implement a part of the method in hardware (rather than software or firmware). Platform software comprising an operating system or any other suitable platform software may be provided at the computing-based device to enable application software to be executed on the device.

Various functions described herein can be implemented in hardware, software, or any combination thereof. If implemented in software, the functions can be stored on or transmitted over as one or more instructions or code on a computer-readable medium. Computer-readable media may include, for example, computer-readable storage media. Computer-readable storage media may include volatile or non-volatile, removable or non-removable media implemented in any method or technology for storage of information such as computer readable instructions, data structures, program modules or other data. A computer-readable storage media can be any available storage media that may be accessed by a computer. By way of example, and not limitation, such computer-readable storage media may comprise RAM, ROM, EEPROM, flash memory or other memory devices, CD-ROM or other optical disc storage, magnetic disc storage or other magnetic storage devices, or any other medium that can be used to carry or store desired program code in the form of instructions or data structures and that can be accessed by a computer. Disc and disk, as used herein, include compact disc (CD), laser disc, optical disc, digital versatile disc (DVD), floppy disk, and blu-ray disc (BD). Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, DSL, or wireless technologies such as infrared, radio, and microwave are included in the definition of communication medium. Combinations of the above should also be included within the scope of computer-readable media.

Alternatively, or in addition, the functionality described herein can be performed, at least in part, by one or more hardware logic components. For example, and without limitation, hardware logic components that can be used may include Field-programmable Gate Arrays (FPGAs), Program-specific Integrated Circuits (ASICs), Program-specific Standard Products (ASSPs), System-on-a-chip systems (SOCs). Complex Programmable Logic Devices (CPLDs), etc.

Although illustrated as a single intrusion detection mechanism, apparatus or system, it is to be understood that the computing device may be a distributed system. Thus, for instance, several devices may be in communication by way of a network connection and may collectively perform tasks described as being performed by the computing device.

Although illustrated as a local device it will be appreciated that the computing device may be located remotely and accessed via a network or other communication link (for example using a communication interface).

The term ‘computer’ is used herein to refer to any device with processing capability such that it can execute instructions. Those skilled in the art will realise that such processing capabilities are incorporated into many different devices and therefore the term ‘computer’ includes PCs, servers, mobile telephones, personal digital assistants and many other devices.

Those skilled in the art will realise that storage devices utilised to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realise that by utilising conventional techniques known to those skilled in the art that all, or a portion of the software instructions may be carried out by a dedicated circuit, such as a DSP, programmable logic array, or the like.

It will be understood that the benefits and advantages described above may relate to one embodiment or may relate to several embodiments. The embodiments are not limited to those that solve any or all of the stated problems or those that have any or all of the stated benefits and advantages.

Any reference to ‘an’ item refers to one or more of those items. The term ‘comprising’ is used herein to mean including the method steps or elements identified, but that such steps or elements do not comprise an exclusive list and a method or apparatus may contain additional steps or elements.

As used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices.

Further, as used herein, the term “exemplary” is intended to mean “serving as an illustration or example of something”.

Further, to the extent that the term “includes” is used in either the detailed description or the claims, such term is intended to be inclusive in a manner similar to the term “comprising” as “comprising” is interpreted when employed as a transitional word in a claim.

The figures illustrate exemplary methods. While the methods are shown and described as being a series of acts that are performed in a particular sequence, it is to be understood and appreciated that the methods are not limited by the order of the sequence. For example, some acts can occur in a different order than what is described herein. In addition, an act can occur concurrently with another act. Further, in some instances, not all acts may be required to implement a method described herein.

Moreover, the acts described herein may comprise computer-executable instructions that can be implemented by one or more processors and/or stored on a computer-readable medium or media. The computer-executable instructions can include routines, sub-routines, programs, threads of execution, and/or the like. Still further, results of acts of the methods can be stored in a computer-readable medium, displayed on a display device, and/or the like.

The order of the steps of the methods described herein is exemplary, but the steps may be carried out in any suitable order, or simultaneously where appropriate. Additionally, steps may be added or substituted in, or individual steps may be deleted from any of the methods without departing from the scope of the subject matter described herein. Aspects of any of the examples described above may be combined with aspects of any of the other examples described to form further examples without losing the effect sought.

It will be understood that the above description of a preferred embodiment is given by way of example only and that various modifications may be made by those skilled in the art. What has been described above includes examples of one or more embodiments. It is, of course, not possible to describe every conceivable modification and alteration of the above devices or methods for purposes of describing the aforementioned aspects, but one of ordinary skill in the art can recognize that many further modifications and permutations of various aspects are possible. Accordingly, the described aspects are intended to embrace all such alterations, modifications, and variations that fall within or are equivalent to the scope of the appended claims.

1.-44. (canceled)

45. A computer implemented method for detecting an anomalous application message sequence in an application communication session between a user device and a network node, the application communication session associated with an application executing on the user device, the method comprising:
receiving an application message sent between the user device and the network node, wherein the received application message is associated with a received application message sequence comprising application messages that have been received so far;
generating an estimate of the next application message to be received using traffic analysis based on techniques in the field of deep learning on the received application message sequence, wherein the estimated next application message forms part of a predicted application message sequence;
classifying the received application message sequence as normal or anomalous based the received application message sequence and a corresponding predicted application message sequence; and
sending an indication of an anomalous received application message sequence in response to classifying the received application message sequence as anomalous.

46. The computer implemented method of claim 45, wherein generating the estimate of the next application message expected to be received further comprises:
converting the received application message to a received application message vector, wherein the received application message vector represents the information content of the received application message; and
processing the received application message vector to estimate the next application message expected to be received during the application communication session using a neural network for estimating the next application message and trained on a set of application message sequences associated with normal operation of the application, wherein the estimated next application message expected to be received is represented as a prediction application message vector.

47. The computer implemented method as claimed in claim 46, wherein converting the received application message to a received application message vector further comprises generating the received application message vector as a lower dimensional representation or an informationally dense representation of the received application message based on using neural network techniques and a tree graph representation of the received application message.

48. The computer implemented method as claimed in claim 45, wherein each application message comprises a textual representation, the method further comprising:
encoding and compressing the textual representation into a plurality of symbols; and
embedding the plurality of symbols of the application message as an application message vector in a vector space of real values.

49. The computer implemented method as claimed in claim 48, wherein each application message comprises a textual representation of one or more reserved words and data fields, each reserved word associated with one of the data fields in the application message, the converting further comprising:
encoding and compressing the reserved words and associated data fields of the application message into symbols corresponding to key value pairs; and
embedding the application message as a message vector based on the key value pairs associated with the application message,
wherein, the reserved words are associated with a set of globally unique labels, each unique label corresponding to a reserved word, the encoding and compressing further comprising: (a) forming symbols corresponding to key value pairs by mapping each reserved word to a corresponding unique label to form a key for a key value pair, and (b) compressing each of the data fields associated with each reserved word to form a key value associated with the key for the key value pair.

50. The computer implemented method as claimed claim 46, the converting or embedding further comprising generating an application message vector associated with the application message by passing symbol data representative of the encoded and compressed application message through a neural network for embedding an application message as a message vector, the neural network for embedding having been trained to embed a set of application messages into corresponding application message vectors, wherein the neural network outputs an application message vector representing the informational content of the received application message.

51. The computer implemented method as claimed in claim 50, wherein the neural network for embedding an application message as an application message vector is based on a skip gram model, wherein the neural network maintains a message matrix and a field matrix, wherein each column of the message matrix represents an application message vector associated with an application message and each column of the field matrix represents a field vector associated with the plurality of symbols associated application messages.

52. The computer implemented method as claimed in claim 50, wherein the embedding further comprises generating a message vector associated with the application message by passing the symbol data representative of the application message through a neural network comprising an encoding and decoding neural network structure with corresponding weights trained to embed a set of application messages as application message vectors, and wherein the encoding neural network structure processes the symbol data associated with the application message to output an application message vector representing the informational content of the received application message.

53. The computer implemented method as claimed in claim 46, wherein converting the received application message to a received application message vector further comprises:
generating a tree graph associated with the application message;
encoding and embedding the tree graph as a message vector associated with the application message by passing data representative of the tree graph through a neural network comprising an encoding and decoding neural network structure with corresponding weights trained to embed a set of application messages as application message vectors, and wherein the encoding neural network structure processes the tree graph associated with the application message to output an application message vector representing the informational content of the received application message.

54. The computer implemented method as claimed in claim 50, wherein the neural network for embedding an application message as an application message vector comprises a variational autoencoder neural network structure, wherein the variational autoencoder neural network structure comprises an encoding neural network structure and a decoding neural network structure, wherein:
the encoding neural network structure is trained and configured to generate an N-dimensional vector by parsing the tree graph associated with the application message by accumulating one or more context vectors associated with nodes of the tree graph, wherein a context vector for a parent node of the tree graph is based on values representative of information content of the parent's child node(s); and
the decoding neural network structure is trained and configured to generate a tree graph based on an N-dimensional vector associated with the application message in a recursive approach based on generating nodes of the tree graph and context information from the N-dimensional vector for each of the generated nodes of the tree graph based on modelling relationships between parent nodes and child node(s) and relationships between child node(s) of the same parent node of the tree graph.

55. The computer-implemented method as claimed in claim 54, wherein the generated tree graph is input to a sequence LSTM decoder configured for predicting the content of each node of the generated tree graph as a portion of information or sequence of characters associated with the application message.

56. The computer implemented method as claimed in any of claim 46, wherein the neural network for estimating the next application message expected to be received further comprises a recurrent neural network structure, the method step of processing the received application message vector based on the neural network for estimating the next application message expected to be received further comprising:
inputting the received application message vector associated with the received application message to the recurrent neural network, wherein the application message vector represents an embedding of the received application message; and
outputting from the recurrent neural network an estimate of the next application comprising a prediction vector representing an embedding of the estimated next application message expected to be received.

57. The computer implemented method as claimed in claim 45, wherein classifying the received application message sequence as normal or anomalous based on the received application message sequence and corresponding application messages of the predicted application message sequence further comprising:
calculating an error vector associated with the similarity between the received application message sequence and corresponding predicted application message sequence; and
determining the error vector to be either normal or anomalous based on a classifier trained and adapted on a training set of error vectors for labelling an error vector as normal or abnormal,
wherein, determining whether the received application message sequence is anomalous further comprising determining whether the error vector corresponding to the received application message sequence is within an error region, the error region having being defined based on a set of error vectors determined from training the neural network for estimating the next application message with a training set of application message sequences, the error region defines an error threshold surface in the vector space associated with the error vectors, the threshold surface for separating error vectors determined to be normal error vectors and error vectors determined to be abnormal error vectors.

58. The computer implemented method as claimed in claim 57, wherein the training set of error vectors is based on a training set of application message vectors associated with a set of application message sequences and corresponding prediction application message vectors, wherein the training set of application messages vector sequences includes a first set of application message vector sequences that are labelled as normal and a second set of application message vector sequences that are labelled as anomalous, and the classifier is based on a two-class support vector machine that defines the error region to separate error vectors labelled as normal and error vectors labelled a anomalous.

59. The computer implemented method as claimed in claim 57, wherein classifying the received application message sequence as normal or anomalous further comprises:
generating an error vector representing the similarity between a first and a second sequence of application message vectors associated with a received application message sequence and a corresponding sequence of prediction vectors associated with the predicted application message sequence, wherein each application message vector is an embedding of the corresponding application message and each prediction application message vector is an embedding of the corresponding predicted application message; and
determining whether the received application message sequence is an anomalous application message sequence based on the error vector.

60. The computer implemented method as claimed in claim 59, further comprising:
storing each prediction vector as part of a sequence of prediction application message vectors associated with the application message sequence received so far in the application communications session;
storing each application message vector as part of a sequence of application message vectors associated with the application message sequence received so far in the application communications session; and
generating the error vector further comprises calculating the error vector based on a similarity function between a sequence of stored application message vectors and a corresponding sequence of stored prediction application message vectors.

61. The computer implemented method as claimed in claim 59, wherein the application message vector is the i-th application message vector xᵢ in a sequence of application message vectors denoted (xₖ) for 1<k<=i, the prediction application message vector is the (i+1)-th prediction application message vector pₜ₊₁ in a sequence of prediction application message vectors (pₖ₊₁) for 1<=k<=i and the error vector associated with the j-th sequence of application message vectors and corresponding prediction application message vectors is denoted eᵢ, wherein the step of generating the error vector further comprises calculating the error vector based on eᵢ={eₖ=similarity(pᵢ₋ₖ₋₁,xᵢ₋ₖ₋₁)}ₖ₌₁^{D}, 1<=D<=i where similarity(pᵢ, xᵢ), is a similarity function representing the similarity between vector pᵢ and xᵢ and 1<=D<=i representing the D most recent message vectors of a D sized sliding window on the application message vector sequence.

62. The computer implemented method as claimed in any claim 45, wherein the application messages received during the application communication session between the user device and the network node are application messages based on an application layer protocol, wherein the application layer protocol is based on at least one protocol from the group consisting of:
Hypertext Transfer Protocol;
Simple Mail Transfer Protocol;
File Transfer Protocol;
Domain Name System Protocol;
any application-layer protocol and/or messaging structure that can be described by a domain specific language that convey application message semantics through a specific syntax; and
any other suitable application level communication protocol used by, the application and reciprocal application for communicating between user device and network node.

63. An apparatus for detection of anomalous application message sequences associated with a user device communicating with a network node in an application communication session, the apparatus comprising a processor, a communication interface, and a storage unit, the processor coupled to the communication interface and the storage unit, wherein:
the communication interface is configured to receive an application message sent between the user device and the network node, wherein the received application message forms part of a received application message sequence comprising application messages that have been received so far;
the processor and storage unit are configured to: (a) generate an estimate of the next application message to be received using traffic analysis based on techniques in the field of deep learning on the received application message sequence, wherein the estimated next application message forms part of a predicted application message sequence, and (h) classify the received application message sequence as normal or anomalous based the received application message sequence and corresponding application messages of the predicted application message sequence; and
the communication interface is further configured to send an indication of an anomalous received application message sequence in response to classifying the received application message sequence as anomalous.

64. An apparatus for detection of anomalous application message sequences associated with a user device communicating with a network node in an application communication session, the apparatus comprising a processor, a communication interface, and a storage unit, the processor coupled to the communication interface and the storage unit, wherein:
the communication interface is configured to receive an application message sent from the user device during the application communication session, wherein the received application message is associated with a sequence of received application messages sent during the application communication session;
the processor and storage unit are configured to:
(a) convert the received application message to a current message vector, wherein the current message vector represents the information content of the received application message,
(b) predict the next application message expected to be received in the application message sequence based on the current message vector and a neural network trained on a set of application message sequences associated with the application, wherein the predicted next application message expected to be received is represented as a prediction vector,
(c) generate an error vector representing the similarity between a sequence of message vectors associated with the received application message sequence and a corresponding sequence of prediction vectors, and
(d) determine whether the received application message sequence is an anomalous application message sequence based on the error vector; and
the communication interface further configured to send an indication of an anomalous received application message sequence in response to determining the received application message sequence is anomalous.
